(19) United States
(12) Patent Application Publication
(10) Pub. No.: US 2009/0299907 A1
(43) Pub. Date: Dec. 3, 2009

(54) Universal Platform for Automated Creation and Operation of Referral Networks

(75) Inventors: John Cofano, Redmond, WA (US); Bart Dellinger, Bothell, WA (US); David Boliek, Carnation, WA (US)

Correspondence Address: LEE & HAYES, PLLC, 601 W. RIVERSIDE AVENUE, SUITE 1400, SPOKANE, WA, 99201, US

(73) Assignee: Goodwell Technologies, Inc., Redmond, WA (US)

(21) Appl. No.: 12/129,873

(22) Filed: May 30, 2008

(51) Int. Cl. H04L 9/00

(52) U.S. Cl. 705/80

(57) ABSTRACT

Utilizing an extensible referral management system platform, an organization may recognize a business opportunity in which the organization may benefit by receiving customer referrals from another organization and build a program under which the organization is a supplier of products and/or services to the referred customers. Thus, the referral management system platform may be used to create intersecting workflows with a core infrastructure in the form of a multi-directional referral network.

### BRIEF DESCRIPTIONS OF THE DRAWINGS

Referral networks, including the automated building and maintenance thereof, are described in connection with the following drawings. The same numbers are used throughout the disclosure and drawings to reference like components and features.

FIG. 1 is a flow diagram of processes implemented for building and operating referral programs.

FIG. 2 is a block diagram of an overall system that provides tools for building referral programs.

FIG. 3 is a block diagram of additional details, of components that may be included within a supplier system.

FIG. 4 is a block diagram of additional details of components that may be included within a source system.

FIG. 5 is a flow diagram of processes implemented for building communities based on referral opportunities.

FIG. 6 is a flow diagram of processes implemented for creating offers in connection with negotiating and establishing agreements between source systems and supplier systems.

FIG. 7 is a flow diagram of processes implemented for creating offers and illustrates a composition of an example offer template.

FIG. 8 is a flow diagram of processes implemented for creating agreements between sources and/or suppliers who may participate in the referral networks.

FIG. 9 is a flow diagram of processes implemented for negotiating agreements between the sources and/or suppliers, and for facilitating acceptance of the terms of such agreements.

FIGS. 10 and 11 are related flow diagrams of processes implemented for building referral networks, as initiated by a source entity.

FIGS. 12 and 13 are related flow diagrams of processes implemented for building referral networks, as initiated by a supplier system.

FIG. 14 is a flow diagram of processes implemented for creating referrals for particular customers.

FIG. 15 is a block diagram of systems for operating or running referral programs, by which one or more source systems may refer customers to one or more supplier systems.

FIG. 16 illustrates systems for operating or running referral programs, by which one or more source systems may refer customers to one or more supplier system.

FIG. 17 is a block diagram showing an example of interactions of components in a referral system from a customer perspective.

FIG. 18 is a block diagram showing an example of interactions of components in a referral system from a source perspective.

FIG. 19 is a block diagram showing an example of components in a referral system from a supplier perspective.

FIG. 20 is a flow diagram of processes implemented for operating or running referral programs.

FIG. 21 is a block diagram of a sample summary page that may be presented to, for example, source personnel via a computing system associated with the source.

FIG. 22 is a block diagram of a sample GUI that presents a list of referrals related to the source entity discussed in FIG. 21.

FIG. 23 is a block diagram of a sample GUI that provides further information relating to a selected referral.

FIG. 24 is a block diagram of a sample GUI that enables a user to contact a given customer.

FIG. 25 is a block diagram of a sample GUI that presents details relating to a given referral.

FIG. 26 is a block diagram of a sample GUI that presents information relating to one or more agreements established for a given participant in the referral networks described herein.

FIG. 27 is a block diagram of a sample GUI that presents additional details relating to a given referral agreement.

FIG. 28 is a block diagram showing various examples of secondary referrals.

FIG. 29 is a block diagram showing various examples of chain referrals.

FIG. 30 is a block diagram showing an example mechanism for regulating access to objects.

FIG. 31 is a block diagram showing relationships between network objects, status objects, and group objects.

FIG. 32 is a block diagram showing further aspects of an object representation of a group construct within the referral networks described herein.

FIG. 33 is a block diagram showing further aspects of relationships between entities objects and other objects.

FIG. 34 is a block diagram showing examples of possible relationships between and among Network, Group, and Entity objects.

FIG. 35 is a block diagram showing object models for implementing Offer Templates as described herein.

FIG. 36 is a block diagram showing object arrangements for implementing action definitions.

FIG. 37 is a block diagram showing object definitions for an offer.

FIG. 38 is a block diagram showing sample aspects for an agreement static object.

FIG. 39 is a block diagram showing an object model of an instance of an agreement.

FIG. 40 is a block diagram showing an object model of a referral static, which may provide a class definition for instantiating referral objects.

FIG. 41 is a block diagram showing an object model of an instance of a referral.

FIG. 42 is a block diagram showing object models related to a Relationship Template.

FIG. 43 is a block diagram showing object models for an instance of a relationship established between two or more parties, as supported by the referral management system described herein.

FIG. 44 is a block diagram showing a static for report definition objects.

FIG. 45 is a block diagram showing object implementations of a report instance.

### DETAILED DESCRIPTION

A “referral agreement” may refer to a “Master Referral agreement”, which may include three sub-agreements, though referral agreements are in not necessarily limited thereto.

In electronic commerce, alternatively and hereafter referred to as “e-commerce,” an agreement between a source and a supplier may specify the terms under which the source may refer at least some of its customers to the supplier, or under which the supplier may accept referrals from the source. These source-supplier agreements may specify the terms and conditions applicable to referrals, and may specify compensation or remuneration due to the source or the supplier resulting from referrals performed under the agreement. This compensation or remuneration may be pecuniary or non-pecuniary, and may or may not be based on whether the referrals ultimately result in consummated or completed transactions with the customers.

An agreement between a customer and the source may enable the customer to give express or explicit consent to being referred from the source to the supplier. In some instances, the customer may have agreed implicitly to the referrals. These referrals may involve customer information being transferred from the source to the supplier, and the supplier interacting with the customer in some manner. For example, the supplier may contact the customer, or the customer may contact the supplier.

An agreement between the customer and the supplier may define the terms under which the supplier is to perform the service subject to the referral. In some cases, the customer-supplier agreement may be defined explicitly, through a mechanism for negotiating offers and acceptances, based on offers or agreements that contain standard elements. In other cases, the customer-supplier agreement may be implied when the supplier accepts customer information from the source. Typically, the customer-supplier agreement, whether defined explicitly or implicitly, defines a baseline or floor for performance by the supplier. However, the source, the supplier, and/or the customer may negotiate for performance above this baseline. In some cases, the obligations defined in the customer-supplier agreement may be defined implicitly by law or regulation (e.g., HIPAA, regulated utilities, or the like).

These sub-agreements may be inherited from one or more predefined templates, further customizable when the agreements are created. These sub-agreements may address issues such as, but not limited to, security matters governing how data is transferred or transmitted, data access permissions, workflow definitions, custom data elements, training materials and/or procedures, remuneration, marketing collateral or materials applicable to particular referrals, legal/compliance matters, and other aspects of the referral process.

The overall Master referral agreement may become active when the source-supplier agreement is accepted by both the source and supplier. The terms of the sub-agreements may initially inherit at least some terms from the master agreement, and these terms may be modified as each role defines in the master agreement participates or interacts with another role. The customer-source and customer-supplier agreements may be implicit when the master referral agreement is created, and then are instanced when particular customers participate in the referral process. Thus, although the three sub-agreements all derive from the master referral agreement, these three sub-agreements may be instanced at different times.

### System-Level Overviews

The following document describes tools and systems, as well as corresponding techniques and processes, for building and maintaining automated referral networks and related referrals.

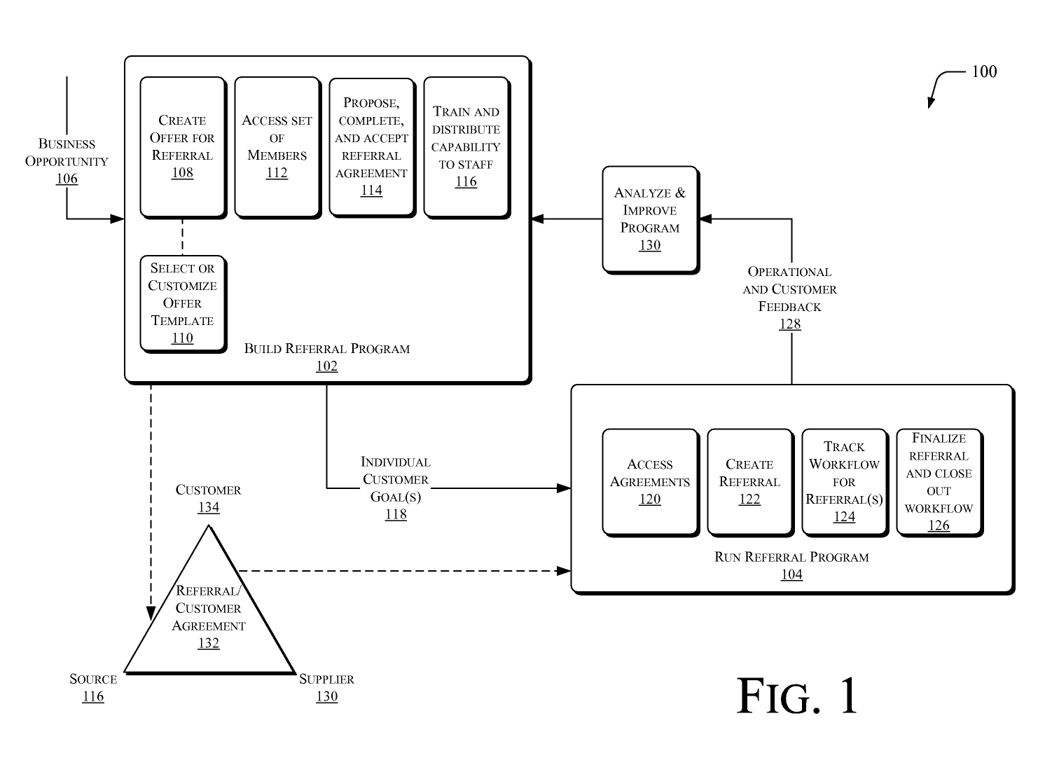

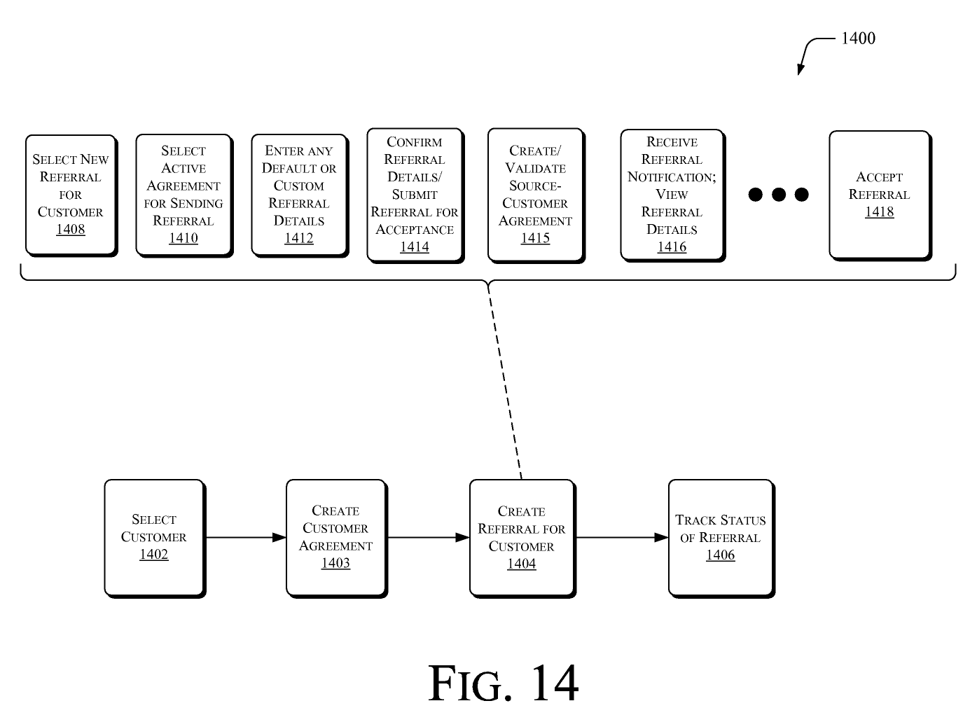

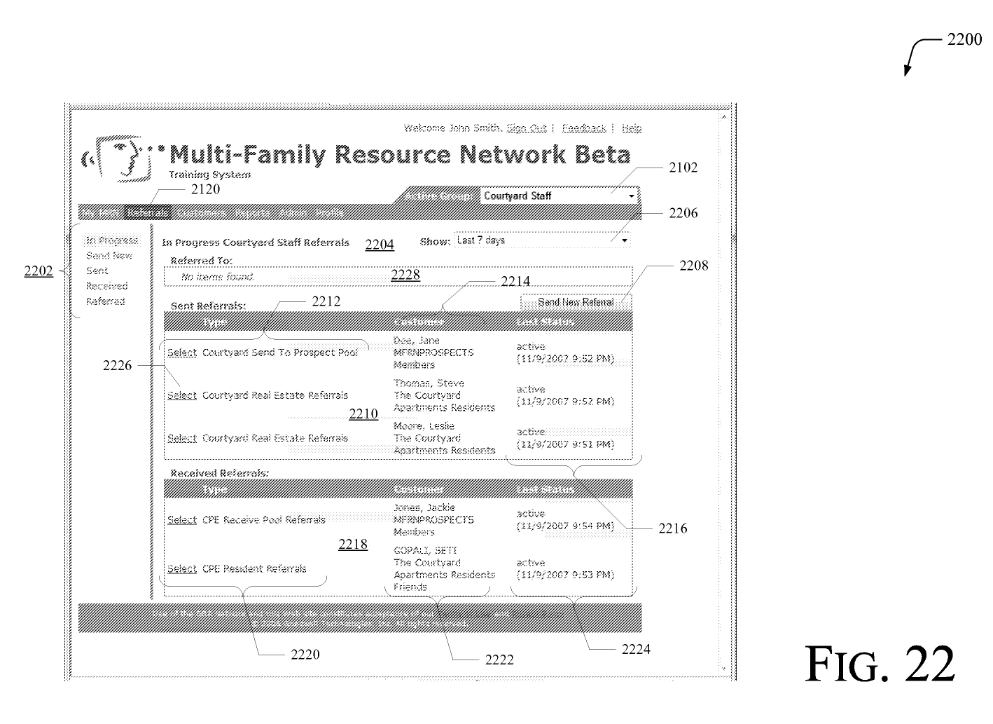

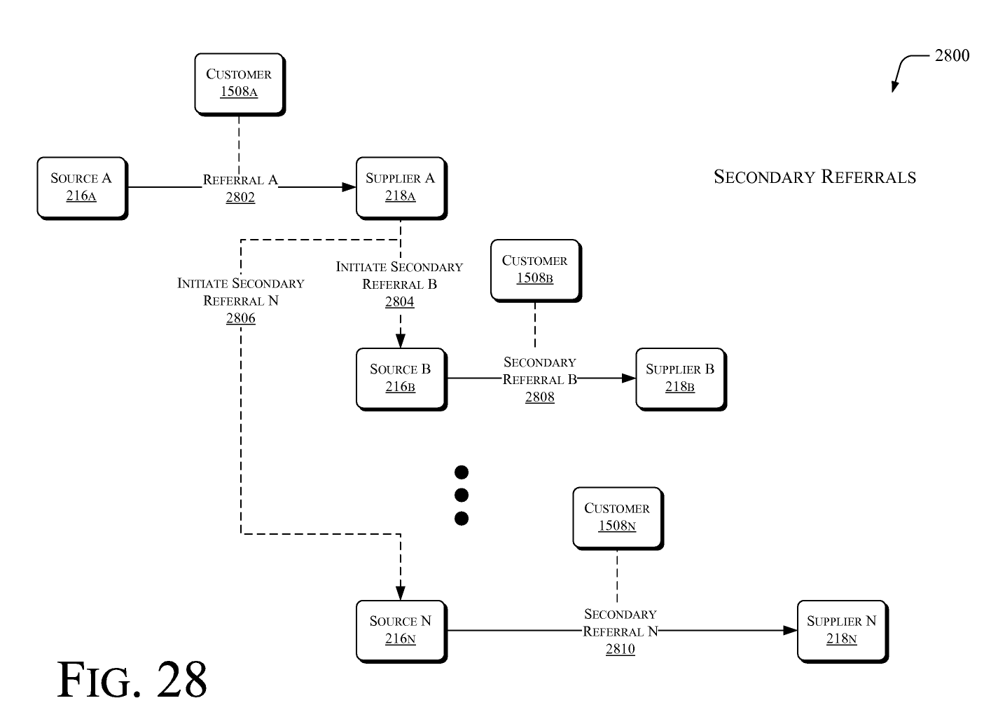

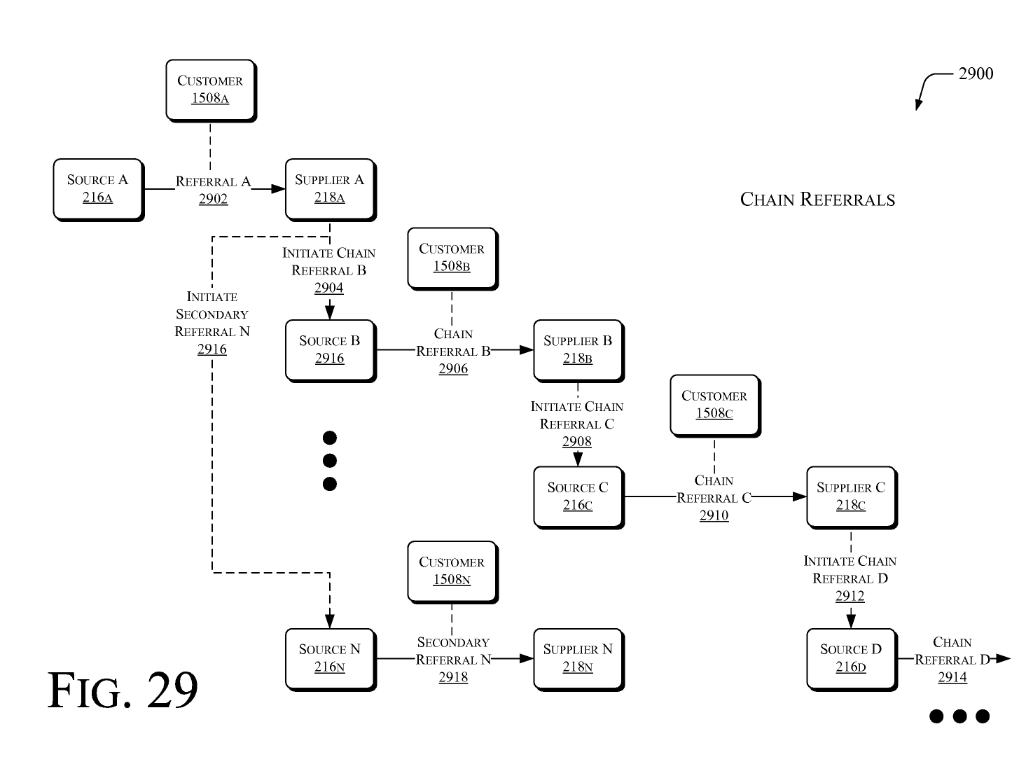

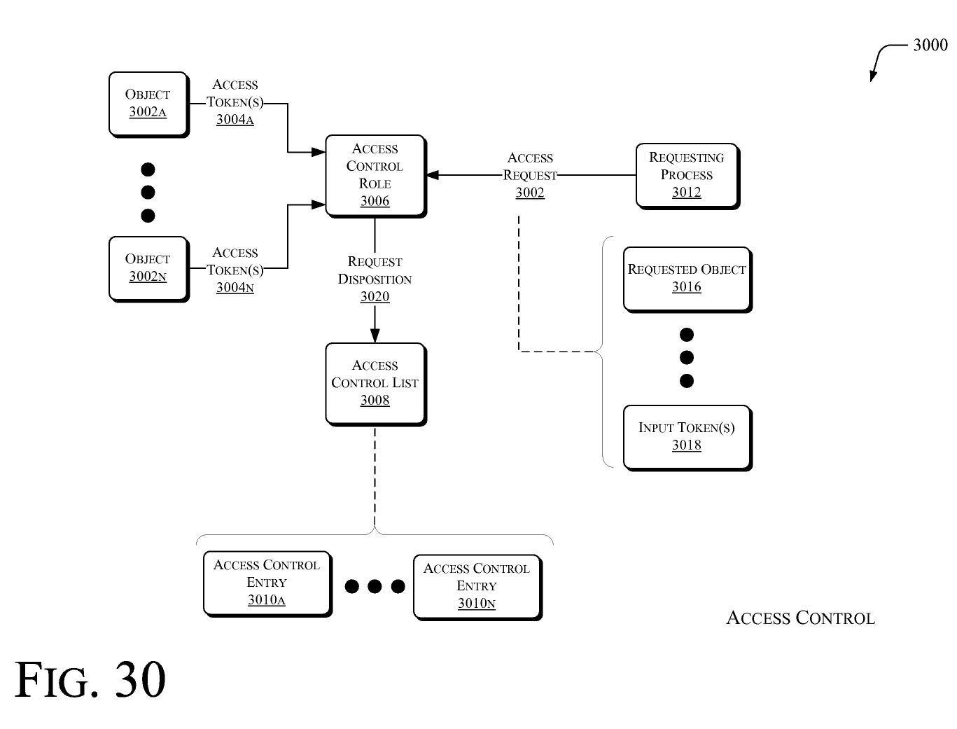

The drawings illustrate various aspects of the description, organized generally at follows. FIGS. 1-13 pertain to the building the referral networks, FIGS. 14-21 pertain to running referrals within the referral networks, FIGS. 22-27 pertain to various examples of graphical user interfaces (GUIs) associated with at least one embodiment of the referral networks described herein, FIGS. 28-29 pertain to process flows related to performing secondary or chain referrals, and FIGS. 30-45 pertain to of object model examples associated with at least one embodiment of the referral networks described herein.

FIG. 1 shows an example architectural overview of a system for building and maintaining automated referral networks and related referrals. An example referral/customer agreement, represented by triangle 132, may enable a source 116 to refer one or more of its customers 134 to a supplier 130. A set of processes grouped in the block 102 may build one or more referral networks or programs, which are based on one or more corresponding referral/customer agreements 132, as shown by the dashed arrow that connects block 102 to triangle 132. In addition, a set of processes grouped in the block 104 may run one or more of the referral programs according to the terms and conditions specified in the governing referral/customer agreement 132, as shown by the dashed arrow that connects triangle 132 to block 104.

As described further below, different participants may take different roles in different referral networks. Thus, one person or enterprise may be a customer in one referral network, a source in another referral network, and a supplier in yet another referral network. Further still, different persons or enterprises may take on different roles in different agreements in the same referral network or in different referral networks. That is, a person or enterprise may have more than one role in the same referral network.

Building Referral Networks

More particularly, FIG. 1 illustrates an example process flows for building and operating referral programs. The flow diagrams 100 represent the workflows that organizations participating in referral networks may perform to set-up and run their referral programs. Block 102 represents processes for building referral programs, and block 104 represents processing for running the referral programs.

At block 102, an organization may recognize a business opportunity in which the organization may benefit by receiving customer referrals from another organization. In this case, the organization may build a program under which the organization is a supplier of products and/or services to the referred customers. In another example, the organization may recognize a business opportunity to refer at least some of their customers to another organization. In this latter example, the organization may build a program under which the organization is a source of customers to be referred to a supplier organization.

FIG. 1 shows this business opportunity at 106, as an input to the build referral program process 102.

Block 108 represents creating offers for referring products and/or services (collectively, “items”). Block 108 may represent the organization creating an offer or offer template that will be the basis for any agreements to be formed between a source and a supplier. These agreements may link the source and the supplier together, allowing them to send referrals. This offer may be based on an offer template that defines parameters related to the agreement and referral workflows, custom fields, and rules.

Database 136 may refer to a repository of offer and agreement templates upon which the creating of offers 108 is implemented. That is, at least one embodiment of database 136 may be a public repository of generic and industry specific referral types, to which organizations subscribing to a referral management system have electronic access. Thus, in the context of block 108, an organization may create an offer template that is generally appropriate for the type of business opportunity that is business opportunity 106 and store the template in database 136.

More generally, with regard to database 136, when creating an offer, an offer template may be selected from database 136 based on network, product category, desired workflows/custom fields, and legal/framework. This offer template may be used “as is” or can be modified for a truly custom offer. The resulting offers can then be used to invite other source or suppliers to join in an agreement to send/receive referrals. Database 136 may be searched based on public/private offers and invitations to form a referral agreement can originate from either the offer creator or a source/supplier wanting to participate in the offer. Once created, agreements are then added to the repository which form the basis for all referrals sent between source and suppliers. In order to send or receive a referral, accepted and active agreements are to be in place with the other party in database 136.

Database 136 may be deemed “public” to the extent that it is accessible to subscribers to a referral management system, which hosts the repository on one or more proprietary servers.

Block 110 represents selecting or customizing the offer template. Depending on the vertical and network, a set of default offer templates may be available for the offer creator to choose. In some cases, the offer creator may work with the referral management system (or administrative personnel associated therewith) to create a custom offer template with custom referral and agreement workflows.

More particularly, block 110 may refer to the offer creator accessing the database 136 to access an offer template that is appropriate for the business opportunity 106. Alternatively, block 110 may refer to the offer creator accessing the repository to retrieve an offer template that is appropriate for the business opportunity by accessing a link from a previous agreement between the parties to the business opportunity 106 to an appropriate offer template in database 136. In this latter scenario, the previous agreement is likely, though not exclusively, to be stored privately by the organizations involved in the agreement.

Block 112 represents accessing a set of members or partners. Before sending an agreement (based on an offer) to a source or supplier, the offer creator may select a recipient for the agreement (e.g., a company, corporate enterprise, or other suitable recipient). In different scenarios, this recipient may potentially be a source or a supplier. The party sending the agreement may view a list of potential recipients who are already participating in the network, by, for example, a search mechanism provided by the referral management system. In other instances, the party sending the agreement may send an invitation for an entity that is not yet part of the network to sign up and join the network.

Block 114 represents proposing, completing, and accepting the agreement. The offer creator may select an offer as well as a recipient entity to receive and process the offer. Block 114 may include customizing the agreement terms before sending the agreement to the recipient for approval.

More particularly, block 114 may refer to the agreement creator accessing an offer that is appropriate for the business opportunity 106 from the database 136, and customizing the accessed offer accordingly. At this point, the instanced offer becomes an agreement, which may then be stored privately by the organization; in the alternative, or along with, the offer may also be stored in the database 136 associated with the referral management system.

The recipient may modify the proposed terms and send it back for re-approval, or reject the proposed terms outright, and thus block 114 may further represent the revising of the offer based upon feedback received. Once both parties have approved the customized offer, the referral management system (or staff associated therewith) also may consider and approve the agreement before the agreement becomes active and can be used to send referrals.

More particularly, when both parties have approved the customized agreement, the pending agreement becomes an active agreement. The agreement may be stored in both privately by the organization and in database 136 for future reference for further business opportunities between the two parties. Even more particularly, the agreement may be linked, in database 136, to the original offer template upon which the agreement is ultimately based. The link between the original offer template and the agreement may be based on business type, subject matter, parties (i.e., organizations) to the agreement, etc. Thus, at least one of the parties to the agreement may refer to the agreement when accessing the offer template from database 136 in the context of future business opportunities.

Block 116 represents training staff to handle the referrals conducted under the agreement finalized at block 114. The particular training may vary in different instances, depending on particular vertical industries, particular referral programs, or other considerations. Block 116 may also include distributing capabilities to perform these referrals to staff associated with one or both parties to the referrals. Block 116 may include performing or facilitating any sales/marketing or staff training specific to a particular referral program. Once the referral agreement is approved and active, the source entity may view a representation of the referral agreement in their list of candidate referrals that the source can send.

With regard to running the referral programs, run referral program block 104 represents, and may include, the referral source organization analyzing customer goals and/or needs, and determining which (if any) of a list of referral agreements may be a desirable candidate for referring customers in a given situation. Block 104 may include matching or locating an active referral agreement to send referrals, and may include prompting the customer to ask if they wish to be referred (via verbal or written means). If the customer is interested in the referral, then block 104 may include initiating one or more of the referral processes, which are now described in more detail.

Block 120 represents accessing a set of agreements from database 136, and may include the source of the referral viewing a list of agreements available for sending a referral. Block 120 may also include reviewing with sales and product information for various products and/or services that may be candidate referral items. If one or more items appear to be good candidates for referring the customer, then block 120 may include requesting or selecting to send the referral.

Block 122 represents creating the referral, and may include the referral source filling out particular details pertaining to the referral in the offer template accessed or otherwise retrieved from database 136. Examples of such filling out such details may include creating a new customer or select an existing one, analyzing and forwarding customer demographics, completing any custom referral fields, as well as fields indicating the person or organization that is sending and/or receiving the referral. Block 122 may include sending the referral to the supplier when creating the referral. In turn, the supplier may receive the referral, and accept or reject it.

Block 124 represents tracking the workflow of a given referral, for example the referral created in block 122. Block 124 may include updating the status of the referral as the referral is processed, and closing the referral once the referral process is completed. As discussed elsewhere herein, a given referral may or may not result in a sale being closed. In some implementations, the referral supplier may assume responsibility for tracking and updating the status of the referral, and the referral source may view the status of the referral at any time.

Block 126 represents finalizing and billing the referral, and closing out the workflow related to the referral. Once the workflow is closed successfully, the referral management system may enter information related to the workflow in a billing/payout system for remuneration by and to the parties involved in a given workflow.

Operational and customer feedback 128 regarding program and product performance may be implemented to modify the referral process.

Block 130 shows that referral programs may be analyzed and improved over time. In some instances, these improvements may include different vendors in the referral process.

Again, example referral agreement at 132 shows relationships between a customer 134, a source entity or system 116, and a supplier entity or system 130. As indicated by the dashed arrows connecting the referral agreement 132 to the blocks 102 and 104, block 102 may create the referral agreement to be executed by block 104.

As described herein, a given offer may result in a referral agreement between a source and one or more suppliers. However, this offer may also result in a customer agreement, which is established between the customer(s) who will be referred from sources to suppliers and the sources with which the customers conduct business.

Triangle 132 represents referral agreements and/or customer agreements, stored in database 136. These customer agreements may be associated with their own sets of negotiations and workflows, in similar manner to the referral agreements. In some instances, the referral management system may customize these workflows and related negotiations for particular industries.

As an example, such customer-source agreements may enable the source 116 to obtain consent from the customer 134 to refer the customer 134 (and information related to the customer) to one or more suppliers 130. Within some industry sectors (e.g., the healthcare industry, the public utility industry, and others), access and transfer of private patient or customer information may be heavily regulated. In some cases, customer information may not be referred without the customer's consent. However, the tools and techniques described herein may enable enterprises operating in these sectors to refer customers while complying with these regulations. Further, these tools and techniques may document the history behind referrals, thereby creating a documentary record that memorializes compliance with any applicable privacy regulations.

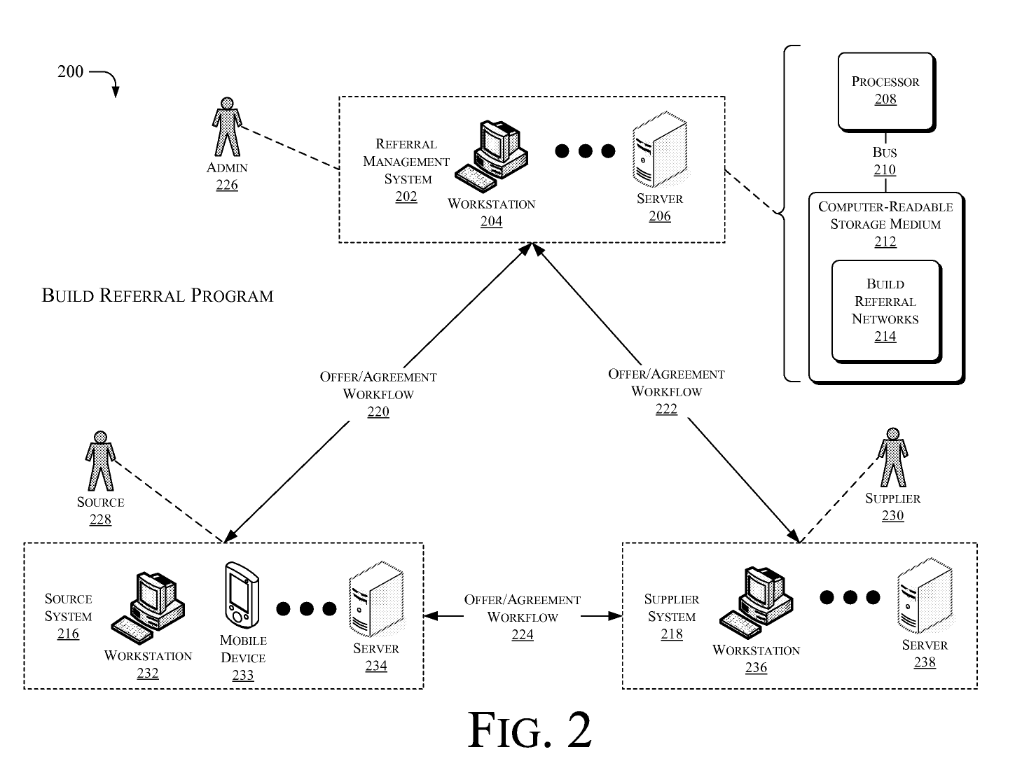

FIG. 2 illustrates an overall system 200 that provides tools for building referral programs. The system 200 may include a referral management system 202. The referral management system 202 may include one or more workstations 204 and/or one or more servers 206. The graphical elements shown in FIG. 2 for the workstations and servers are chosen only to provide examples and to facilitate discussion of such examples, but these examples do not limit possible implementations of the referral management system 202. More specifically, implementations of the referral management system 202 may include devices or systems other than those described and illustrated herein.

Workstations 204 and/or one or more servers 206 may be computer-based systems that include one or more processors, shown at 208. These processors may also be categorized or characterized as having a given type or architecture, which may be reflected in the composition of one or more bus elements 210.

Workstations 204 and/or servers 206 of the referral management system 202 may also include one or more instances of machine-readable or computer-readable storage media, represented by 212. The processor may communicate with the computer-readable media via the bus 210. The computer-readable media 212 may contain instructions that, when read into and executed by the processor 208, perform any of the tools or related functions that are described herein as being performed by the referral management system 202. The processor 208 may access and/or execute the instructions embedded or encoded onto the computer-readable media 212, and/or may access data stored in the computer-readable media 212. Additionally, it is noted that the computer-readable storage media 212, and any software stored thereon, may reside on hardware other than the referral management system without departing from the scope and spirit of the description herein. The examples shown in FIG. 2 are provided to describe an example embodiment, and are not intended to limit further embodiments.

The computer-readable media 212 may include at least a module of software instructions for building and maintaining referral networks, with FIG. 2 denoting an example module at 214. Module 214 represents the instructions that, when executed by the referral management system 202, enable the referral management system 202 to participate in one or more workflows involving at least one source system 216 and at least one supplier system 218. A referral network may include at least one source system that has agreed to send referrals to at least one supplier system. FIG. 2 shows offer/agreement workflow 220 between the referral management system 202 and the source system, offer/agreement workflow 222 between the referral management system 202 and the supplier system, and offer/agreement workflow 224 between the source system 216 and the supplier system 218.

In accordance with the example embodiment of FIG. 2, “source” refers to an individual, company, or other organization or enterprise that has a relationship with an existing or potential customer. “Source system” refers to any computer-based processing system associated with the source.

“Supplier” refers to an individual, company, or other organization or enterprise that provides products and/or services (collectively, “items”) to existing or potential customers. “Supplier system” refers to any computer-based processing system associated with the supplier.

In this manner, the sources and/or source systems are “sources” of potential customers for suppliers and/or supplier systems. Typically, the source has developed a relationship with one or more customers and one or more suppliers. Thus, the source may stand in a position to recommend that at least one given customer and at least one given supplier attempt to complete a business transaction.

Generally, this discussion assumes that suppliers are interested in acquiring relationships with additional customers, at least to offer items of possible interest to these additional customers. In part, this description provides tools and techniques by which sources and sources may establish referral relationships with one another.

In the example shown in FIG. 2, the offer/agreement workflows 220, 222, and 224 may represent data flows related to establishing agreements between the source system 216 and the supplier system 218, as facilitated by the referral management system 202. The referral management system 202 may enable an administrator 226 to become involved with establishing these agreements. Under the terms of these agreements, the source system 216 may refer customers (illustrated and described below) to the supplier system 218, in exchange for compensation paid by the supplier system 218 to the source system 216, the customer, and/or the referral management system 202. The workflows as represented by the arrows 220, 222, and 224 represent these agreements and the data flows and payment flows performed pursuant to these agreements. Additionally, the workflows may include the source system 216 and the supplier system 218 exchanging any number of offers, counteroffers, and acceptances in negotiating and establishing these agreements. Subsequent drawings and description provide examples of templates for facilitating these exchanges.

FIG. 2 further illustrates human actors associated with the source system 216 and the supplier system 218, respectively shown as source 228 and supplier 230. The source system and the supplier system may enable the human actors to participate in, for example only, administering the source system 216 and the supplier system 218, as well as participating in the offer/agreement workflows 220, 222, and/or 224.

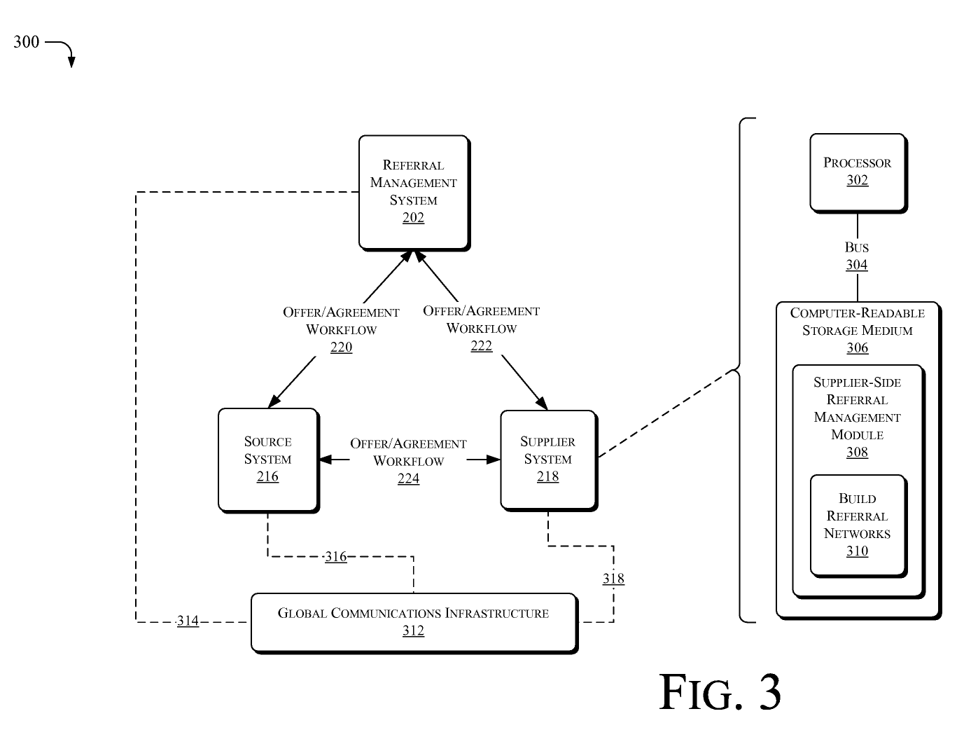

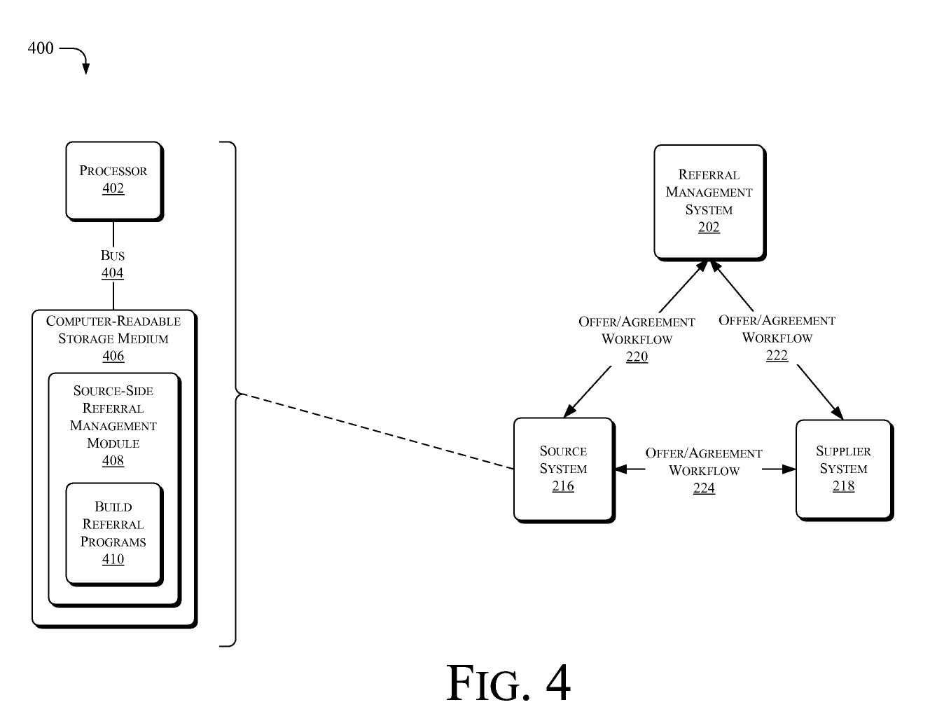

Source system 216 may include one or more workstations 232 and/or one or more servers 234. Supplier system 218 may include one or more workstations 236 and/or one or more servers 238. In addition, FIG. 2 illustrates an example wireless device at 233, with cellular telephones, smartphones, wireless PDAS, and the like providing examples of the wireless devices. The source system, the referral management system, and/or the supplier system may operate with suitably configured wireless devices. Components of these workstations, devices, and/or servers are described in more detail in FIGS. 3 and 4.

FIG. 3 illustrates additional details, shown at 300, of components that may be included within the supplier system (e.g., 218). As an example, but in no way limiting of further embodiments, some items described previously may be carried forward into FIG. 3 and shown by similar reference signs.

Supplier system 218 may include one or more processors, shown at 302. The above description of the processor 208 in FIG. 2 applies to the processor 302, although the processor 302 may or may not be the same type or architecture as the processor 208.

One or more bus elements 404 may enable the processor 302 to communicate with one or more instances of computer-readable storage media 306. The above description of the computer-readable storage media 212 in FIG. 2 applies to the computer-readable storage media 306, although the computer-readable storage media 306 may or may not be the same type as the computer-readable storage media 212. Additionally, bus elements 304 may or may not be the same type or architecture as the bus elements 210.

The computer-readable media 306 may include at least a supplier-side referral management module 308. The supplier-side module 308 may include software instructions that, when loaded into the processor 302 and executed, cause the supplier system to perform any of the functions described herein in connection with automated building and maintenance of referral networks and performing related referrals. More specifically, the supplier-side module 308 may include a module 310 that contains instructions that enable the supplier system to participate in building referral networks.

FIG. 3 also shows a communications infrastructure 312. Communications infrastructure 312 may be of local, regional, and/or global scope, as appropriate in different embodiments. Generally, the communications infrastructure may enable the referral management systems, the source systems, and the supplier systems to communicate with one another, and with customers, as represented generally by the dashed lines 314, 316, and 318. The global communications infrastructure 312 may include any suitable circuit-based or packet-based communications technologies, and may incorporate one or more interactive voice response (IVR) systems, messaging systems, or other communications sub-systems. Some example implementations may include components that apply the Session Initiation Protocol (SIP).

FIG. 4 illustrates additional details, shown at 400, of components that may be included within the source system (e.g., 216). For convenience of description, but not to limit possible implementations, some items described previously may be carried forward into FIG. 4 and shown by similar reference signs.

Source system 216 may include one or more processors, represented by block 402. The above description of the processor 208 in FIG. 2 applies generally to the processor 402, although the processor 402 may or may not be the same type or architecture as the processor 208.

One or more bus elements 404 may enable the processor 402 to communicate with one or more instances of computer-readable storage media 406. The above description of the computer-readable storage media 212 in FIG. 2 applies generally to the computer-readable storage media 406, although the computer-readable storage media 406 may or may not be the same type as the computer-readable storage media 212. Additionally, these bus elements 404 may or may not be the same type or architecture as the bus elements 210.

The computer-readable media 406 may include at least a source-side referral management module, represented by block 408. The source-side referral management module 408 may include software instructions that, when executed by the processor 402, cause the source system 216 to perform any of the functions described herein in connection with automated building and maintenance of referral networks and performing related referrals. More specifically, the source-side referral management module 408 may include a module 310 that contains instructions that enable the source system to participate in building referral networks.

### Building Communities of Referral Opportunities

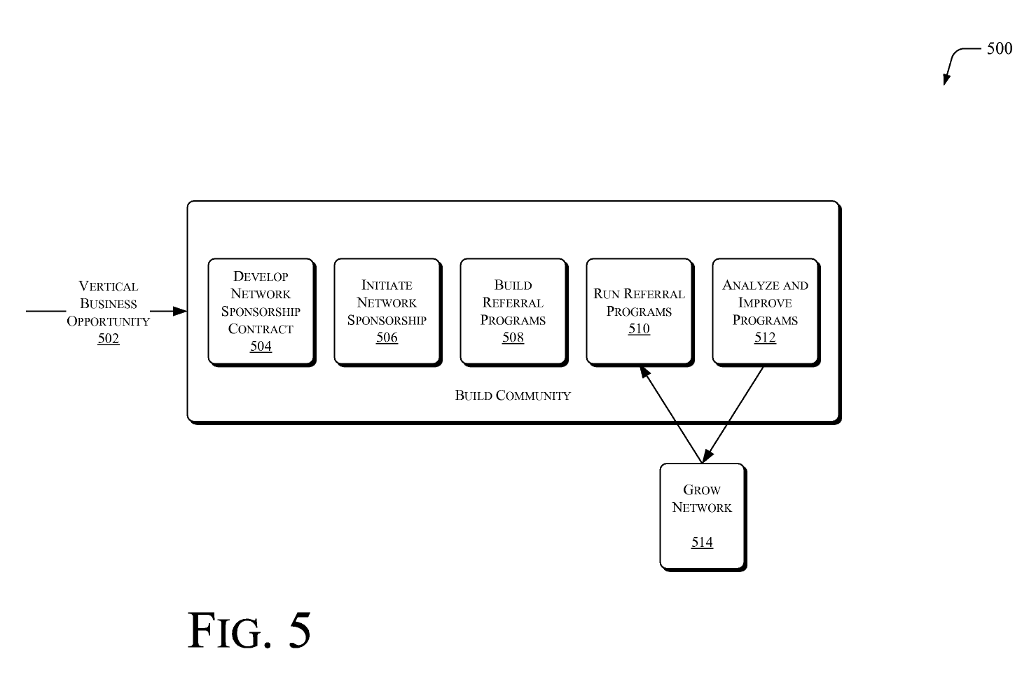

FIG. 5 illustrates process flows 500 for building communities that are involved with referral opportunities as described herein. More specifically, FIG. 5 illustrates workflows that a network sponsor (e.g., an investor, group participant, or internal sponsorship by the referral management system) may perform to set up a collection of source and supplier groups in a particular vertical industry (“vertical”) or regional market.

Block 502 represents a vertical business opportunity as recognized by, for example, an investor with knowledge of the vertical. Block 502 may also represent a business that will be a group participant, or an internal sponsor who originates a plan and the capital to create a collection of groups, with these including sources and suppliers that could successfully send referrals among themselves.

Block 504 represents developing a network sponsorship contract. For example, the entity represented in block 502 may negotiate with the referral management system (e.g., 202) to create a network sponsorship contract. This network sponsorship contract may, at least, define the scope of the network to be created, along with specifying ownership percentages and capital investment (up front and ongoing) to start the referral network.

Block 506 represents initiating network sponsorships. More specifically, block 506 may include the network sponsor from block 504 signing a network sponsorship contract, and beginning commitment and/or payment of capital to begin building the referral network.

Block 508 represents building referral programs, for example, in accordance with the network sponsorship arranged in block 506. Block 508 may include contacting one or more source and/or supplier entities, and bringing them into the program as part of the referral network. As detailed further in the following drawings, these sources and suppliers may create offers, and in some instances, may customize the offer templates to support the workflows related to these referrals. In turn, block 508 may also include the sources and suppliers creating and approving referral agreements amongst themselves.

Block 510 represents running one or more referral programs. After the offer and agreements are in place from blocks 504-508, the sources and suppliers may send referrals to each other.

Block 512 represents analyzing and improving programs. More specifically, block 512 may include the referral management system (and/or staff associated therewith) analyzing the output and progress of the overall network, and/or groups within the network. Based on this ongoing analysis, block 512 may include scaling the referral network, better marketing products/services being referred through the network. Block 512 may also include checking that the various entities are complying with the terms of the referral agreements, and that the sources and suppliers are marketing their referral items consistently with the referral agreements.

Block 514 represents growing the referral network over time. For example, block 514 may include the referral management system assisting the sources and/or suppliers to identify other parties that can send and/or receive referrals. In another example, the source and supplier may proactively identify these other parties. In yet another example, the referral management system may, as at least part its offered services, seek out other parties that would be a good fit for the referral network, and may add these other parties to the referral network.

### Creating Offers and Offer Templates

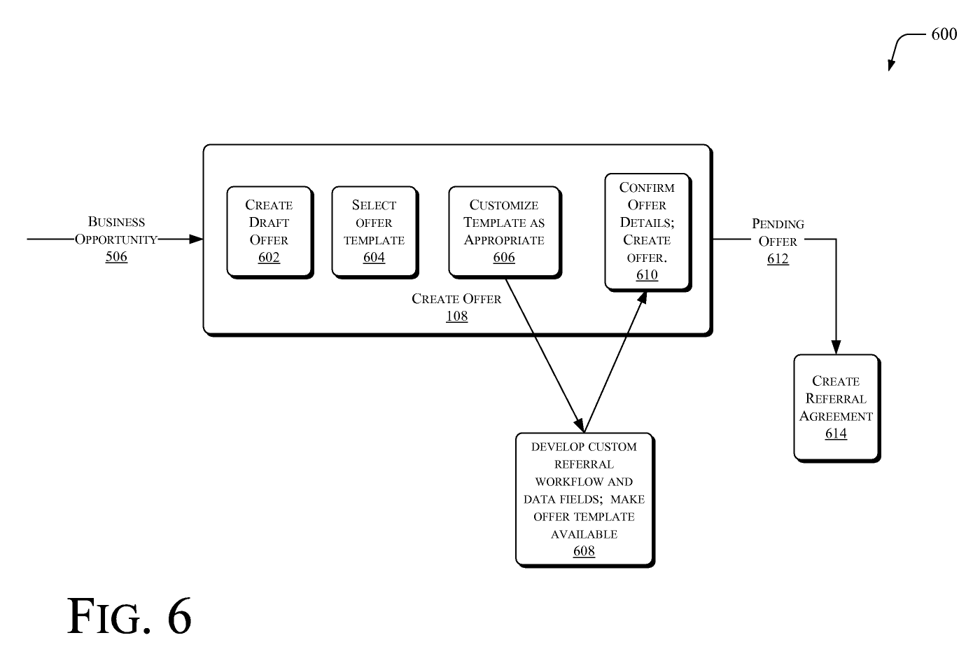

FIG. 6 illustrates process flows 600 creating offers in connection with negotiating and establishing agreements between source systems and supplier systems. In this sense, FIG. 6 elaborates further on block 108 of FIG. 1. Thus, FIG. 6 carries forward reference number 108 for conciseness of description, but not to limit possible implementations of this description.

The process flow 600 represents workflows by which organizations that participate in the referral networks may create offers. In turn, these organizations may use these offers as the basis for agreements between these organizations. More particularly, these organizations may assume the roles of sources, customers, and suppliers in different referral scenarios. Using the techniques described herein, these organizations may establish appropriate referral agreements to specify the terms under which the organizations may become sources, customers, and suppliers. Under these referral agreements, these organizations may refer customers, may have customers referred to them, or may themselves be referred as customers. As part of establishing these referral agreements, the offers may, at least in part, define the workflows for any referrals that are based on these agreements.

Block 602 represents creating a draft offer. In different implementation scenarios, a sponsor of an offer may create the draft offer, with the sponsor organization selecting a new offer template for a source or a supplier, depending on whether the sponsor organization wishes to send referrals or to receive referrals, based on this offer. The organization sponsoring the offer may then enter the information pertaining to the offer. As an example only, this information may include one or more of a name of the sponsoring organization, an offer type, the information that is to be publicly available and/or kept private, description of items to be offered, terms applicable to the offers, and the like

Block 604 represents selecting an existing offer template specific to a given referral network and/or community, and referral or offer type (e.g., source or supplier of referral). The sponsor or originator of the offer from block 602 may populate the offer type field. Block 604 may include providing a list of available offer templates that are specific to the referral network of which the sponsor organization is a member.

Block 606 represents determining whether an existing offer template is appropriate for the referrals to be sent or received under the referral to be based on the offer template. In instances in which modifying an existing offer template would better match an anticipated referral scenario, block 606 may include creating a custom offer template that supports a particular referral workflow or network scenario. For example, if an existing offer template does not contain all of the agreement workflow, agreement custom fields, referral workflow, and referral custom fields for a given organization, then that organization may work with the referral management system to create a new custom offer template to be added to the list of available offer templates. This new offer template may be modified as appropriate to meet particular specifications of the organization. The customized offer template can then be made available to one or more organizations in the referral network/community.

Block 608 represents developing custom referral workflows and data fields in the new and/or customized offer template. Block 608 may include making the offer template available to the offer process. For example, the referral management system (or staff associated therewith) may gather the specifications of the offer sponsor, and may work with the offer sponsor to develop a custom offer template that meets any custom specifications. This offer template may then be made available for testing by the offer sponsor on a training system before final approval and deployment to all groups in the network.

Block 610 represents confirming details relating to a give offer, and may include creating an offer. Block 610 may include the offer sponsor or creator reviewing the information contained in the offer, and then creating the offer once the offer terms or information is in order. In some possible scenarios, a given offer may be characterized as a public offer or a private offer. Private offers may be viewable only by the offer sponsor, and agreements may originate only from the offer sponsor. Public offers may be seen by others in the network, and agreements can be originated from an offer participant.

Once the offer template is finalized and created, it may be output from block 108 as indicted at 612, in the form of a pending offer. In turn, block 614 represents creating a referral agreement between two or more parties, with one of the parties typically being a referral source and another of the parties being a supplier. As such, block 614 may represent negotiations between the parties to finalize the terms of the referral agreement.

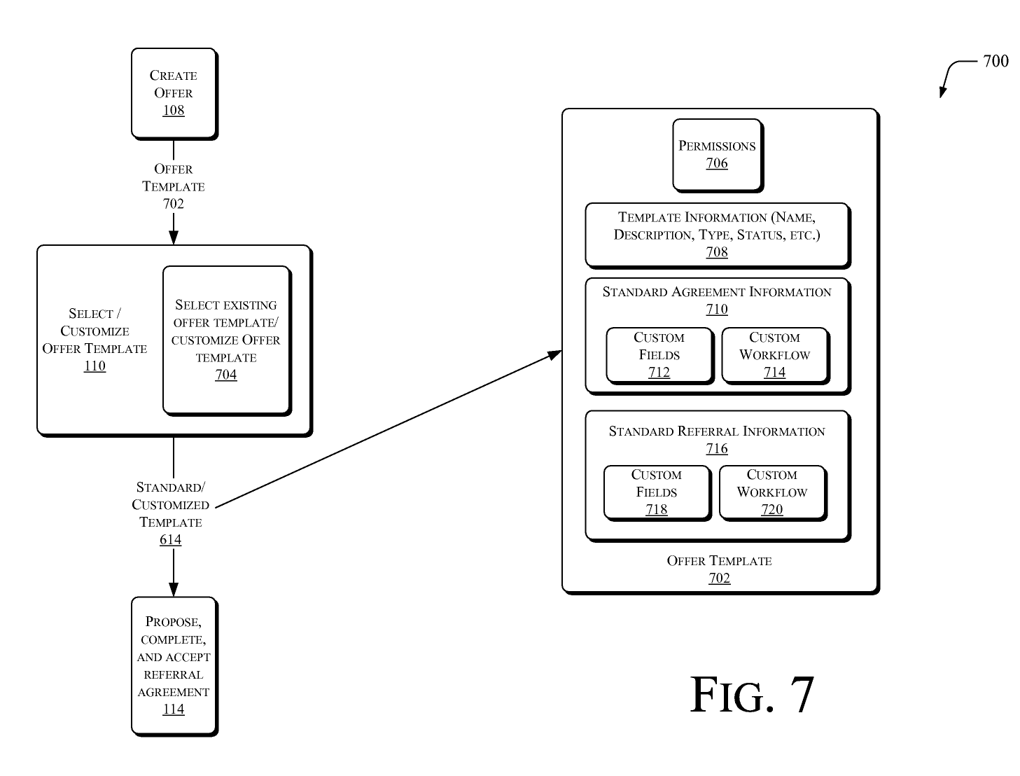

FIG. 7 illustrates process flows for creating offers and illustrates a composition of an example offer template 700. For conciseness of description, but not to limit possible implementations, FIG. 7 may carry forward some items previously described, with these items being shown by the same reference numbers.

FIG. 7 represents a workflow that organizations participating in referral networks may perform to select or create a custom offer template. FIG. 7 also provides, at 702, an illustrative data composition or data structure for the offer template.

Turning to FIG. 7 in more detail, FIG. 7 carries forward block 110 from FIG. 1, with block 110 representing selecting an existing offer template, or customizing an offer template. Recall also that FIG. 6 elaborates further on customized offer templates, in connection with block 608. To provide context for the customized offer templates, FIG. 7 carries forward block 108 (create offer) as a predecessor process for the customized offer templates, and carries forward block 614 (create agreement based on the offer) as a successor process for the customized offer templates.

Block 110 may include one or more sub-processes. For example, block 704 represents selecting an existing offer template for the type and workflow anticipated for a given referral scenario. However, block 704 may include develop a custom offer template if an existing offer template does not meet the specifications of a given offer sponsor. Block 704 may include the offer sponsor enlisting the services of the referral management system to create a new and/or customized offer template. In some cases, the offer sponsor may use such new customized offer templates for future offers. In still other cases, the offer sponsor may make these customized offer templates available for use by others in the referral network, whether compensated or not.

Block 704 may include gathering specifications of the offer sponsor, and developing a custom offer template that meets these specifications. In some scenarios, the referral management system may perform block 704. Illustrative areas for customizing offer templates may include: agreement workflow, agreement custom fields, referral workflow, and referral custom fields. This offer template may be tested by the offer sponsor on a training or testing system before final approval and deployment to all groups in the referral network.

In addition, block 704 may include customizing customer preferences for an organization, and creating public and private customer demographic fields and relationship action sets that can be used outside of a referral to manage customers. In some scenarios, the referral management system may perform these aspects of block 704.

Offer template 702 may serve as the basis of offers and referral agreements, as well as the referrals performed according to those agreements. The offer template 702 may be implemented as an XML document that includes sections defining workflows for creating referral agreements and performing referrals. The offer template may also provide or define customizations for the above processes. In some instances, the referral management system may use a private backend system to modify these templates and to deploy them to training and production systems provided by the referral management system, or by a source or supplier.

FIG. 7 provides the following non-limiting examples of offer template sections:
Permissions information field 706: defines or specifies who has the ability to see and use this offer template. This permissions information field may specify whether a given offer template is available for use within the referral network by parties other than the sponsor who originally created the template (or had it created).
Template Identification Information field 708: contains data elements for identifying the offer template (e.g., name of the offer template, type of the offer template, description, and the like).
Standard Agreement Information field 710: contains information (e.g., format, rules, and/or other factors) that agreements created based on the given offer template may inherit.
Agreement Information Custom Fields 712: contains custom data fields for agreements that are based on a given offer template. These custom data fields may include customizable attributes, including, e.g., field name, data type, picker type, required, field length, and the like.
Agreement Information Custom Workflow 714: contains custom workflow status, workflow-related actions, and action data fields that make up the agreement step by step workflow, as a given referral goes through the approval, active, and deactivation process.
Inheritable Referral Information 716: contains information (e.g., format, rules, and/or other factors) that may be inherited by referrals that are based on offers created from the given offer template.
Referral Information Custom Fields 718: contains custom data fields associated with any referrals that are based on this offer template. The custom data fields may have customizable attributes, including (but not limited to) field name, data type, picker type, required/optional status, field length, and the like.
Referral Information Custom Workflow 720: contains custom status, actions, and action data fields that define the step by step referral workflow, as it goes through the creation, sending, acceptance, sales process, and closing process.
   Negotiating and Creating Agreements for Sources and/or Suppliers

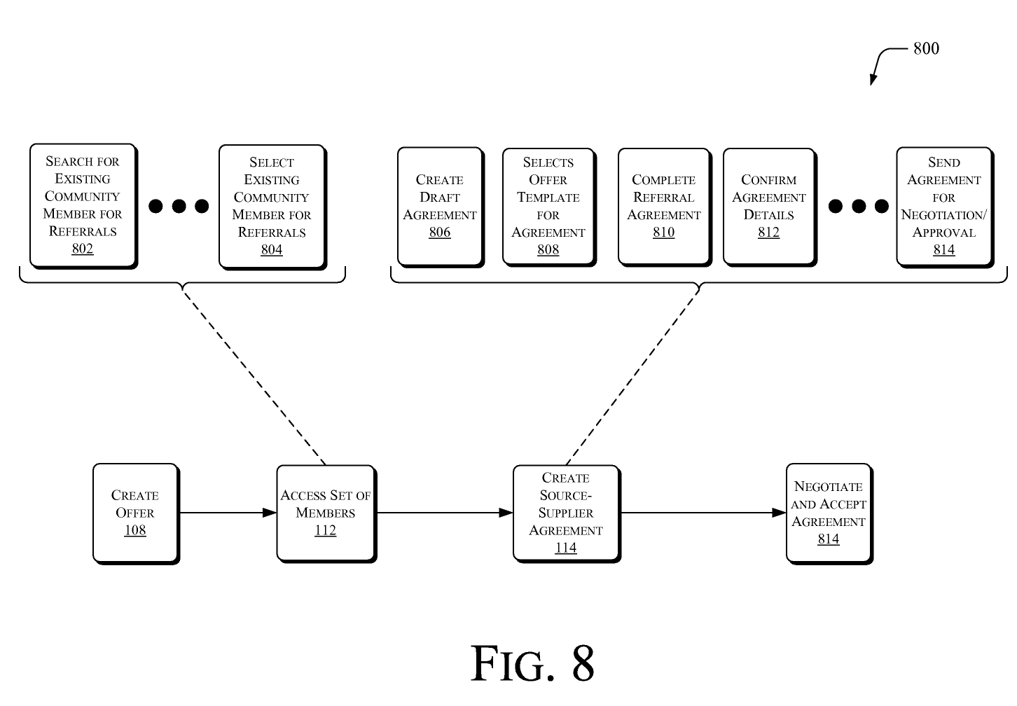

FIG. 8 illustrates process flows 800 for creating agreements between sources and/or suppliers who may participate in the referral networks as described herein. FIG. 8 represents workflows for creating referral agreements between two or more parties, whereby the agreements allow and/or facilitate conducting referrals between and among these parties. To provide an illustrative context for the description of creating referral agreements, FIG. 8 carries forward block 108 (create offers) as an example predecessor process, block 112 (access set of members), and block 114 (propose, complete, and accept referral agreements). FIG. 8 elaborates further on these blocks.

Block 112 may include searching for one or more members of a community of referral participants with whom to cooperate in a referral scenario, as represented by block 802. Block 802 may include looking for a potential source or a potential supplier, depending on whether this member is to send or receive referrals under the new scenario. Block 802 may include searching the referral network for participant organizations that are looking for new referrals. Block 802 may also include sending invitations to an entity that is not yet in the referral system, inviting this entity to join the referral network and start receiving agreements and referrals as a participant in the system.

Block 112 may also include selecting one or more of these community members to receive an offer to create a new referral agreement, as shown at block 804.

Block 114 may include creating a draft agreement, as shown at block 806. Block 806 may include selecting an existing agreement template, on which to base a new agreement for sending or receiving referrals. Block 806 may also include filling in details of the referral agreement, including selecting an agreement participant or an invitation for a potential participant to join the referral network.

Block 808 represents selecting an existing offer or offer template that is specific to the referrals to be sent or received. Block 808 may include selecting a previously-created offer or offer template for a product/service relating to the referrals. This offer template may provide the basis for the agreement to be created in block 114, using the illustrative intermediate processing shown in FIG. 8.

Block 810 represents completing terms and product/service details for the agreement pertaining to the item being referred. Block 810 may include the agreement sponsor entering the remaining agreement details including (for examples only) one or more names for the agreement and/or for the products, services, or other items featured in the referrals. Block 810 may also include providing or entering information describing the product/service/item in the referrals, as well as the terms and conditions applicable to the referrals. These terms and conditions may be inherited from the offer, and edited afterwards. Block 810 may include providing or specifying a referral script, note, default customer, and referral notifications, e.g., phone or IM notifications.

Block 812 represents confirming the details of the new referral agreement, and block 814 represents sending the referral agreement for approval by one or more other parties. For example, block 812 may include an agreement sponsor reviewing the agreement, altering any terms as appropriate, and approving it. In turn, block 814 may include the agreement sponsor, the referral management system, or another entity submitting the referral agreement for negotiation and approval by another party. For example, a given sponsor may be seeking to assume the role of a source in a referral scenario, and may seek to refer its customers to a supplier. In this example, the sponsor (or another entity operating on its behalf) may submit the agreement to one or more potential suppliers for consideration and approval.

Block 814, which represents negotiating and accepting the referral agreement. The negotiation processes represented in block 814 are described in further detail below.

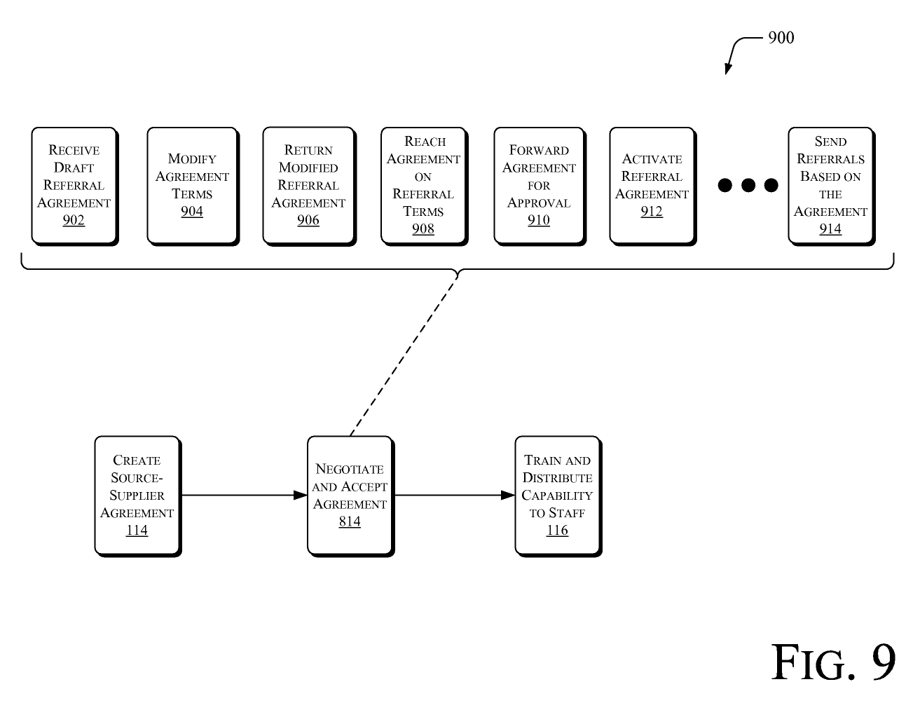

FIG. 9 illustrates process flows 900 for negotiating agreements between the sources and/or suppliers, and for facilitating acceptance of the terms of these agreements. Without limiting possible implementations, at least part of the process flows 900 elaborate further on block 814 in FIG. 8, which represent negotiating and accepting the referral agreements. To provide an illustrative context for the process flows 900, FIG. 9 carries forward block 114 (create source-supplier agreement) and block 116 (train staff). In example implementations, organizations participating in the referral networks described herein may perform at least part of the process flows 900 to negotiate, accept, and activate a referral agreement to send/receive referrals between a source and supplier.

Block 902 represents receiving a given draft agreement to send or receive referrals. For example, block 902 may include a network participant receiving an email or other notification, indicating that the participant has received a new proposed agreement pending acceptance. In another example, the network participant may receive a suitable notification in an application (provided by, for example, the referral management system) that an agreement has been proposed to them. In turn, the network participant may consider whether to accept the referral agreement as proposed, reject the agreement, or make a counter-offer.

If the network participant decides to modify and/or propose new terms in the referral agreement, block 904 represents modifying one or more of the terms, and block 906 represents sending the modified agreement back to the sponsor for consideration of the modified terms. In turn, as described further below, the sponsor may respond to the modified terms. This negotiation process may repeat indefinitely, until the parties reach agreement, as shown at block 908. In some cases, the parties may not reach agreement, but FIG. 9 does not expressly illustrate this scenario.

Block 908 represents approving the terms in the referral agreement. In different scenarios, if a network participant determines that the terms initially specified in the pending referral agreement are acceptable as is, then the participant can accept the agreement. In other instances, the process flows may arrive at block 908 after a negotiation process involving two or more parties to the referral agreement.

Once agreement is reached on the terms, the agreement may be forwarded to an approval process, as shown at block 910. For example, the referral management system may operate such an approval process. In turn, the approval process may evaluate the proposed referral agreement, and determine whether to approve the agreement. If the agreement meets applicable standards, then the agreement may be approved and activated, as shown at block 912. Otherwise, block 912 may include rejecting the agreement, and/or returning it to the parties for renegotiation consistent with applicable standards. More specifically, block 910 may include notifying the approval process that an agreement is pending final approval. The approval process may accept, reject, or modify the agreement. After final acceptance, block 910 may include sending a notification to the agreement sponsor and the participants working with the sponsor that the agreement is now active, and that referrals can be sent based upon this agreement.

Block 912 represents activating the referral agreement, once it has been approved in block 910. Once the referral agreement has been approved, it becomes “live”, and may serve as the basis for referring customers between sources and suppliers.

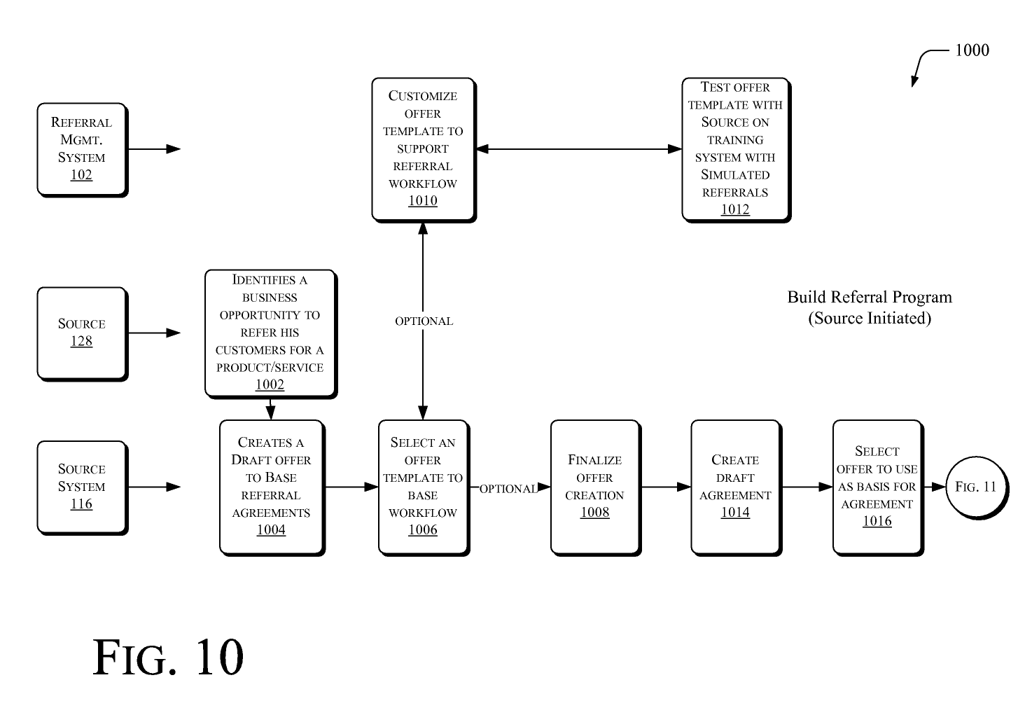

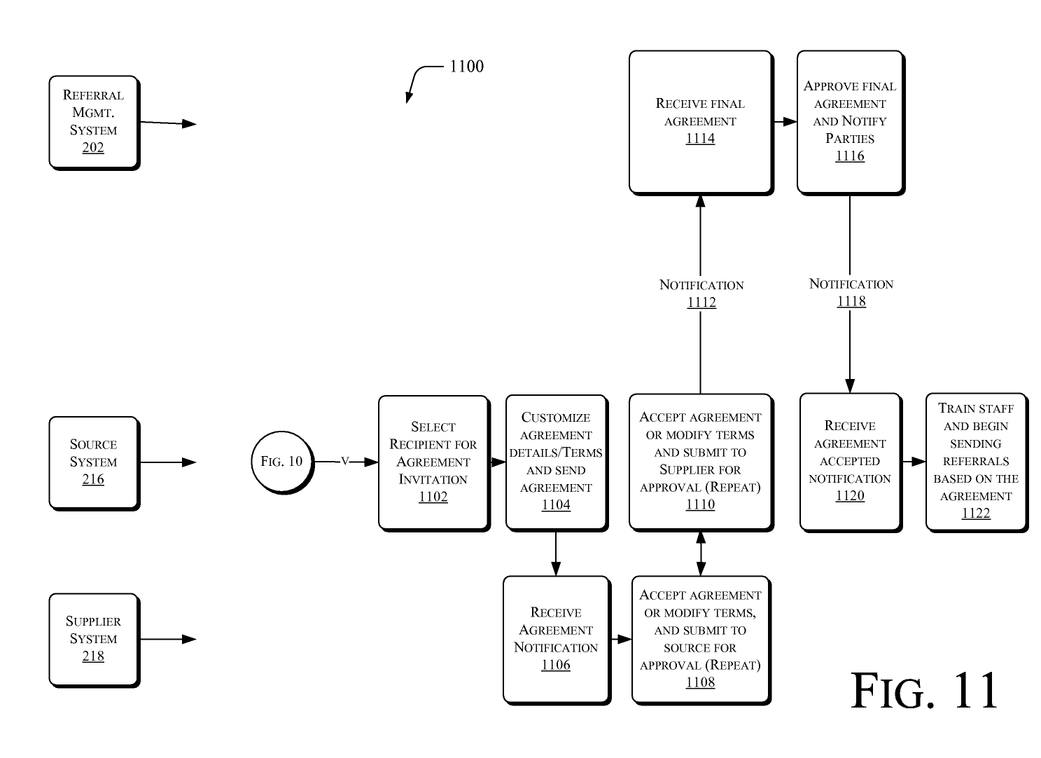

FIGS. 10 and 11 illustrate process flows for building referral networks, as initiated by a source entity. For ease of illustration, but not to limit alternative embodiments, these process flows are shown in two drawings, with the portion shown in FIG. 10 shown at 1000 and the portion shown in FIG. 11 shown at 1100. For convenience of description, but not to limit alternative embodiments, FIGS. 10 and 11 may carry forward some items described previously, with these items shown by similar reference signs. Additionally, FIGS. 10 and 11 illustrate certain processing as relating to certain components and actors described above. However, it is noted that this illustration and description is illustrative only, and other components or actors may perform this processing without departing from the scope and spirit of the description herein.

FIG. 10 carries forward an example of a referral management system at 202, an example source actor at 228, and an example source system at 216. FIG. 10 carries forward these items for conciseness of description, but this description does not limit possible implementations.

The referral management system and the source system may include one or more respective modules of software instructions that, when executed, enable the referral management system and the source system to perform the functions shown in FIGS. 10 and 11 for establishing a referral network or referral program between a source and a supplier. FIG. 1 shows an example of a referral management module 214 for building referral networks, and FIG. 3 shows an example of a supplier system module 310 for building referral networks.

Block 1002 represents enabling the source actor to identify a business opportunity in which the source may refer his or her customers to one or more third parties for some good and/or service. The description herein refers to this third party as a “supplier” (e.g., 218 and/or 230 in FIG. 2).

Block 1004 represents enabling a source system to create a draft offer to serve as a basis a referral workflow between the source system and the supplier system. This referral workflow may occur at any point after the source and the supplier reach agreement on terms applicable to the referrals.

Block 1006 represents selecting an offer template on which to base a workflow for negotiating and establishing the agreement.

If the offer template is appropriate for supporting the referral workflow, the process flows 1000 may proceed to block 1008, which represents finalizing an offer for transmission from the source system to the supplier system.

Returning to block 1006, if an existing offer template may be customized to support the referral workflow, then the process flows 1000 may proceed to block 1010, which represents customizing the offer template. Block 1012 represents testing the customized offer template, on the referral management system or elsewhere. Block 1012 may include utilizing a training system with simulated referrals, and may be repeated any number of times for different iterations of customized offer templates and simulated referral scenarios.

From block 1012, once the offer templates have been tested, the process flows 1000 may proceed to block 1008, which represents finalizing the offer creation template as described above. In turn, block 1014 represents creating a draft agreement for transmission between the source system and the supplier system.

Block 1016 represents selecting an offer template to use as the basis for the agreement being created in block 1014. The offer template selected in block 1016 may be a pre-existing offer template as selected in block 1006, or a customized offer template from block 1012.

In FIG. 11, the process flows from FIG. 10 may enter as shown, with the process flows in FIG. 11 shown at 1100. Block 1102 represents selecting a recipient to receive the agreement invitation created as shown in FIG. 10. In the example shown, a given source system (e.g., 116) may select one or more supplier systems (e.g., 218) to receive the agreement invitation. In some instances, the source system and the supplier system may have a pre-existing relationship, having previously exchanged agreement invitations and/or negotiated complete agreements. In other instances, the relationship between the source system and the supplier system may be relatively newer, with at least some understanding in place to exchange agreement invitations under some circumstances.

Block 1104 represents customizing the terms and/or details contained in the agreement offer for a particular recipient. For example, if the source system and the supplier system have a history of dealing with one another, this history or course of dealings may indicate which terms are most attractive or interesting to one or more of the parties. In another example, one or more source systems may store data representing their history of dealings with particular supplier systems, such that other source systems may access this stored history data to ascertain which terms are most important to the particular supplier systems. In this manner, block 1104 may include using previous history information to customize the offer, with the goal of enhancing the chances that the recipient will accept the offer. In the examples described herein, this offer pertains to an agreement between the source system and the supplier system, under which the source system would refer its customers to the supplier system for some good and/or service.

FIG. 11 shows examples in which the source system directs offers to one or more supplier systems. However, as described below, the supplier systems may also initiate the process of building referral networks. In such supplier-initiated scenarios, the supplier system may formulate the offers, and transmit them to one or more source systems.

Block 1104 may include sending the agreement offer, whether the offer is generic or is customized for one or more particular supplier systems. In the example shown, the source system sends the offer to one or more supplier systems.

At the supplier system, block 1106 represents receiving a notification that a source system has sent an offer to the supplier system.

In response to this offer, block 1108 represents enabling the supplier system to consider whether to accept the terms of the referral offer as they stand, whether to make a counter-offer to the source system, or whether to ignore or reject the offer. Assuming that the supplier system determines to respond to the offer, block 1108 may include submitting one or more counter-offers to the source system.

At the source system, block 1110 may include receiving this acceptance or counter-offer from the supplier system. The source system may forward an acceptance to the referral management system (e.g., 102), as represented by the line 1112. However, the source system and the supplier system may also continue negotiations as long as desired, with these negotiations repeating blocks 1108 and 1110 until the terms of a referral agreement are finalized, or until one of the parties terminates negotiations.

Assuming that the source system and the supplier system agree on the terms of a referral agreement, block 1114 represents receiving an indication of the final referral agreement as reached between the source system and the supplier system. In the example shown in FIG. 11, block 1114 represents a referral management system (e.g., 102) receiving this indication.

In addition, FIG. 11 illustrates examples in which the source system 216 and the supplier system 218 may negotiate directly with one another. However, the referral management system may also serve as an intermediary between the source system and the supplier system. In this capacity, the referral management system 202 may passively transmit data between the source system and the supplier systems, or may more actively participate in facilitating negotiations between the source and the supplier. For example, the referral management system may suggest terms that would be more agreeable to one or more of the parties.

Block 1116 represents approving the final referral agreement as reached between the source system and the supplier system. For example, block 1116 may include enabling the referral management system to review the proposed final referral agreement. More specifically, an admin or an automated approval process (i.e., an “approval entity”) associated with the referral management system may review the proposed referral agreement. For example, the approval entity may review and consider various factors relating to the proposed referral agreement, such as whether the proposed referral agreement meets ethical standards (i.e., is the subject matter of the referral legal, do the source/supplier have a conflict of interest, or the like).

Another example of the review process may include considering whether the terms of the referral are fair or reasonable for all parties. Various industries may be divided into “verticals”, as that term is used in the art. For example, the supplier and/or the source may operate in a given vertical industry, with a set of prevailing standards or practices in the vertical. The approval entity may flag or reject any proposed referral agreement that includes terms that deviate substantially from the norms prevailing in the vertical. For example, block 1116 may include rejecting or flagging a referral agreement that specifies one party receiving 90% of gross profit, when typically other groups in the network receive 5%-20%.

As another example of the review process, block 1116 may include determining whether the terms of the agreement exclude the referral management system from earning its appropriate fee for facilitating the relationship between the source and the supplier. The fee charged by the referral management system may be flexible, depending on the items involved in the referrals. In some cases, the source/supplier may not be aware of the appropriate fees charged by the referral management system. In other cases, the source/supplier may attempt to influence the fees charged by the referral management system.

As another example of the review process, block 1116 may include evaluating whether the terms of the agreement are sufficiently clear. In this manner, block 1116 may include mitigating or reducing the risk of discrepancies or disputes arising between the parties when referrals begin. If the referral agreement is unclear in at least one pertinent area, block 1116 may include flagging the referral agreement for further action, or rejecting or canceling the agreement.

Any of the above issues, or other similar issues, could cause the referral management system to cancel the agreement outright, in some cases. In other cases, the referral management system may work with the source and/or suppliers to rectify minor issues with terms.

As shown, block 1116 may include the referral management system approving the referral agreement, and may include the referral management system storing the agreement for future reference in tracking and facilitating referrals between the source system and the supplier system. Block 1116 may also include notifying the parties (i.e., the source system and/or the supplier system) that the referral management system has received and catalogued the finalized referral agreement, as represented at line 1118.

Block 1120 represents receiving the notification 1118. In the example shown in FIG. 11, the source system may receive the notification 1118 because the source system initiated the process of establishing the referral agreement. However, one or both of the source system and the supplier system may receive this notification.

With the referral agreement in place between the source system 216 and the supplier system 218, block 1122 represents referring one or more of its customers to the supplier system, pursuant to this referral agreement. Block 1122 also represents the source system training its personnel as appropriate to send these referrals to the supplier systems.

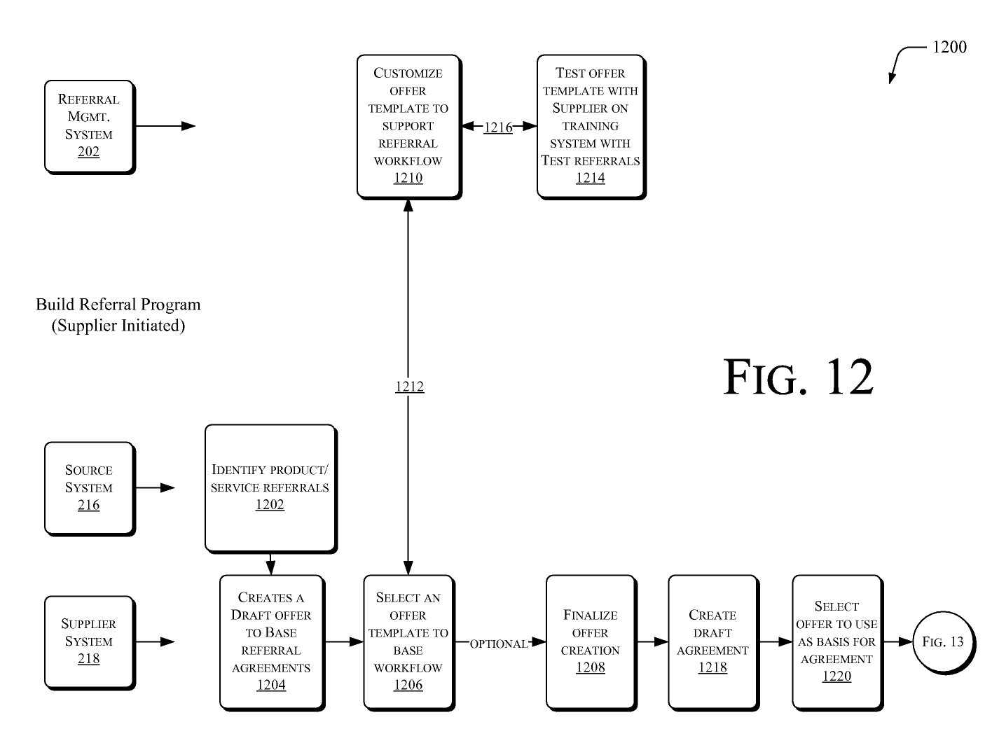

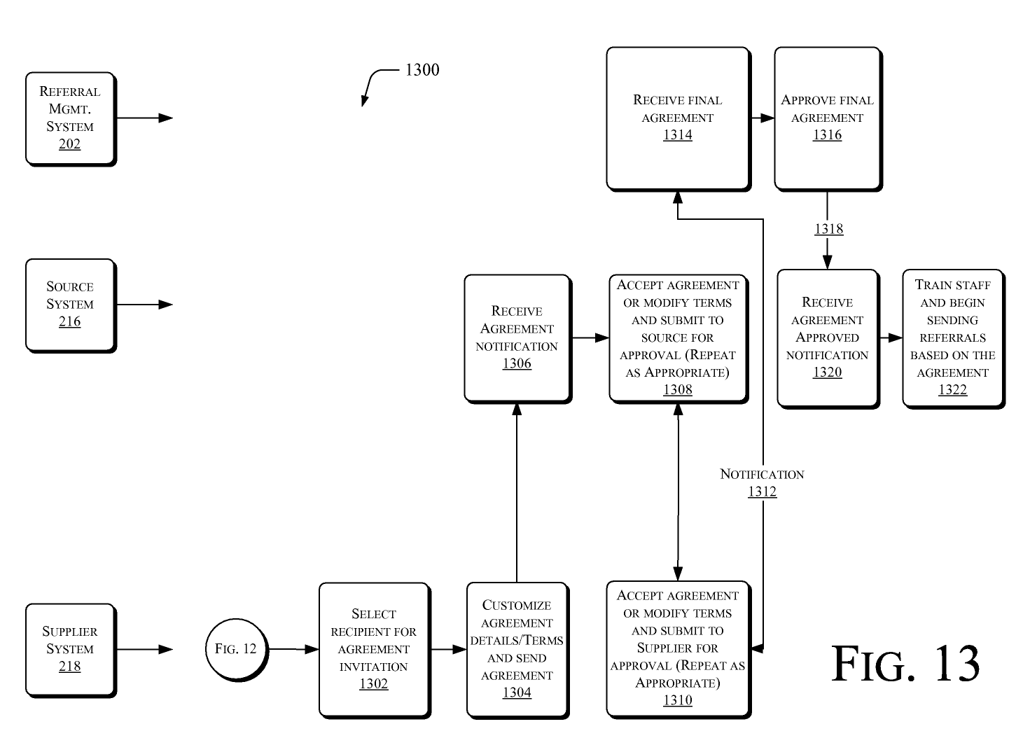

Having described the process flows 1000 and 1100 for building referral programs, as initiated by the source system, the discussion now turns to a description of process flows for building referral programs, as initiated by the supplier system. FIGS. 12 and 13 illustrate these process flows.

FIGS. 12 and 13 illustrate process flows for building referral networks, as initiated by a supplier system. For ease of illustration, but not to limit possible implementations, these process flows are shown in two drawings, with the portion shown in FIG. 12 shown at 1200 and the portion shown in FIG. 13 shown at 1300. For convenience of description, but not to limit possible implementations, FIGS. 12 and 13 may carry forward some items described previously, with these items shown by similar reference signs. Additionally, FIGS. 12 and 13 illustrate certain processing as relating to certain components and actors described above. However, it is noted that this illustration and description is illustrative only, and other components or actors may perform this processing without departing from the scope and spirit of the description herein.

In FIG. 12, block 1202 represents identifying or targeting one or more supplier-provided products and/or services (collectively, “items”) that may interest customers, more specifically, customers of the sources. If a supplier system (e.g., 218) is able to establish referral relationships with the sources, then the supplier may generate additional revenue, transaction volume, or other business activity by offering supplier-provided items to customers referred by the sources. For example, a supplier system may determine that the customers of one or more given source systems may be good potential customers for items offered by the supplier system. In this case, the supplier system may initiate the processes shown in FIGS. 12 and 13 to build a referral network between the supplier system and the targeted source systems.

Block 1204 represents creating a draft offer to serve as a basis for negotiating and establishing one or more referral agreements between the supplier system and one or more source systems.

Block 1206 represents selecting an offer template for use with the draft offer created in block 1204.

Block 1208 represents finalizing the created offer for transmission to one or more of the source systems. The process flows 1200 may include creating a draft offer that incorporates a preexisting template, or that incorporates a customized template.

In implementations using the preexisting template, the process flows may proceed directly from block 1206 to block 1208, so that the selected offer template appears substantially unchanged in the finalized offer. However, in implementations using the customized template, the process flows 1200 may proceed to block 1210, as represented by the arrow 1212. Block 1210 represents customizing the offer template to support future referral workflows. As shown in FIG. 12, the referral management system 202 may perform at least block 1210 as a service to the supplier system 218 and/or the source system 216.

In example implementations, a typical or basic referral workflow template may include sending a referral, accepting the referral, closing a successful sale resulting from the referral, closing an unsuccessful sale resulting from the referral, or being unable to contact the referral. However, block 1210 may include customizing this typical template for particular vertical industries. For example, in a residential leasing vertical, a customized referral workflow may include sending a referral, receiving the referral, contacting the person referred, providing this person with a tour, sending a contract to the person, closing the referral with the person signing the contract and moving in, closing the referral with the person not signing the contract, or closing the referral being unable to contact the referral.

Block 1214 represents testing one or more offer templates with the supplier to refine the customized offer templates for use in the supplier's referral network. Block 1214 may include testing the templates on a training system with simulated or test referrals. Actions associated with blocks 1210 and 1214 may be performed as part of an ongoing customization and testing process, with multiple iterations of these two blocks as appropriate, as represented by the arrow 1216. When the offer template is complete, the referral management system may send the customized offer template to the supplier system, as represented by the bidirectional arrow 1212. In turn, block 1208 may include finalizing the customized offer template for sending to the source system(s) 216.

Block 1218 represents creating a draft agreement based at least one the offer template finalized in block 1208. The draft agreement may serve as a starting point for negotiations between the supplier system 218 and the source system 216. Because the draft agreement originates with the supplier, rather than the source, the agreement may authorize the source to extend the terms of the agreement to the source's customers. In this manner, agreements initiated by sources may differ slightly from agreements initiated by suppliers

In turn, block 1220 represents selecting an offer to use with the draft agreement. This offer or offer template may be a predefined template, or a customized template, as described above. The offer or offer template selected in block 1220 may provide the basis for a referral agreement established between the source and the supplier. As above, with FIGS. 10 and 11, FIG. 12 continues to FIG. 13 without limiting possible implementations.

With regard to process flow 1300 in FIG. 13, block 1302 represents selecting a recipient for an agreement invitation, which may include the offer selected in block 1220. Generally, the processing represented in block 1302 may be similar to that described above with block 1102 in FIG. 11. Thus, the above description of block 1102 applies equally to block 1302, except that block 1302 represents processing performed by the supplier system 218 while block 1102 represents processing performed by the source system 216.

Block 1304 represents customizing terms and/or details of the agreement to be sent to the recipient identified in block 1302. Generally, the processing represented in block 1304 may be similar to that described above with block 1104 in FIG. 11. Thus, the above description of block 1104 applies equally to block 1304, except that block 1304 represents processing performed by the supplier system 218 while block 1104 represents processing performed by the source system 216.

Block 1306 represents receiving notification that a supplier system 218 has sent a proposed agreement to a source system 216. Generally, the processing represented in block 1306 may be similar to that described above with block 1106 in FIG. 11. Thus, the above description of block 1106 applies equally to block 1306, except that block 1306 represents processing performed by the supplier system while block 1106 represents processing performed by the source system.

Block 1308 represents accepting the agreement as proposed by the supplier system 218. However, block 1308 may also represent modifying one or more terms proposed in the agreement, and sending the modified terms back to the supplier system 218 as a counter-offer. Generally, the processing represented in block 1308 may be similar to that described above with block 1108 in FIG. 11. Thus, the above description of block 1108 applies equally to block 1308, except that block 1308 represents processing performed by the source system 216 while block 1108 represents processing performed by the supplier system 218.

Block 1310 represents accepting a counter-offer containing additional or modified terms, as proposed by the source system 216. However, block 1310 may also represent modifying one or more terms proposed in the agreement, and sending the modified terms back to the supplier system 218 as a counter-offer. Generally, the processing represented in block 1310 may be similar to that described above with block 1110 in FIG. 11. Thus, the above description of block 1110 applies equally to block 1310, except that block 1310 represents processing performed by the source system 216 while block 1110 represents processing performed by the supplier system 218.

Additionally, block 1310 may include the supplier system 218 countering the counter-offer received from the source system 216. The source system and the supplier system may repeat this negotiation process any number of times, until the systems and/or parties reach agreement, or until one of the systems and/or parties terminate negotiations.

Assuming that the systems and/or parties reach terms on a referral agreement, the supplier system and/or the source system may send a notification 1312 to a referral management system (e.g., 202). For ease of illustration, FIG. 13 shows the supplier system 218 sending the notification 1312, but the source system 216 could also send this notification.

Block 1314 represents receiving a notification of a final agreement reached between the supplier system and the source system. Generally, the processing represented in block 1314 may be similar to that described above with block 1114 in FIG. 11. Thus, the above description of block 1114 applies equally to block 1314, except that block 1314 represents processing performed in the context of a supplier-initiated referral network, while block 1114 represents processing performed in the context of a source-initiated referral network.

Block 1316 represents approving or acknowledging the final agreement, as reached between the source system 216 and the supplier system 218. Generally, the processing represented in block 1316 may be similar to that described above with block 1116 in FIG. 11. Thus, the above description of block 1116 applies equally to block 1316, except that block 1316 represents processing performed in the context of a supplier-initiated referral network, while block 1116 represents processing performed in the context of a source-initiated referral network.

Block 1316 may include sending an acknowledgement or approval notification 1318 to the supplier system 218 and/or the source system 216. For ease of illustration, FIG. 13 shows an example of the source system 202 receiving the notification 1318, but the supplier system 218 could also receive the notification.

Block 1320 represents receiving a notification that the referral agreement has been received and acknowledged by the referral management system 202. Generally, the processing represented in block 1320 may be similar to that described above with block 1120 in FIG. 11. Thus, the above description of block 1120 applies equally to block 1320, except that block 1320 represents processing performed in the context of a supplier-initiated referral network, while block 1120 represents processing performed in the context of a source-initiated referral network.

Block 1322 represents training staff associated with the source system 216, and may include sending referrals from the source system 216 to the supplier system 218 pursuant to the terms of the referral agreement finalized between the systems and/or parties. Generally, the processing represented in block 1322 may be similar to that described above with block 1122 in FIG. 11. Thus, the above description of block 1122 applies equally to block 1322, except that block 1322 represents processing performed in the context of a supplier-initiated referral network, while block 1122 represents processing performed in the context of a source-initiated referral network.

### Creating Referrals for Customers

FIG. 14 illustrates process flows 1400 for creating referrals for particular customers. Once referral agreements are in place and active between two or more parties, referrals may occur based on these referral agreements. The process flows 1400 may include processes 1402 for selecting customers to be referred, processes 1403 for creating customer agreements, processes 1404 for creating different instances of referrals for different customers, and processes 1406 for tracking status of active referrals. FIG. 14 elaborates further on block 1404, and describes creating referrals based on such active agreements between sources and suppliers.

At block 1403, customer agreements may be established between sources and customers to specify the terms and conditions under which the sources may refer customer information to one or more suppliers. The customer agreement may authorize the source to send the customer as a referral to a supplier, and may enable the customer to consent to being referred to one or more suppliers, thereby enabling the source to comply with any applicable privacy regulations. These customer agreements may be defined using workflows similar to those described herein for referral (i.e., source-supplier) agreements, and may be customized as appropriate for different industry sectors or verticals. The customer agreements may be created automatically when a referral is sent, if a suitable agreement does not already exist.

Block 1408 represents selecting a new referral for a given active customer. For example, block 1408 may include a source entity reviewing a list of active customers and referrals involving these customers, and beginning a referral creation process to create a new referral for one or more of these customers. In another example, block 1408 may include a source selecting a new referral from a list of available referrals, and then selecting an existing customer or entering a new customer. In yet another example, block 1408 may include a source selecting a new referral from a list of referrals in progress, and then selecting an existing customer or entering a new one.

Block 1410 represents selecting an active referral agreement on which the new referral is to be based. That is, block 1410 may include selecting an active referral agreement for sending the new referral. For example, the source within a group of participants may select the active agreement from a list of their group's active agreements that are available to send referrals. In some cases, this agreement may be pre-selected if the referral was created from a list of available referral agreements.

Block 1412 represents entering any default or custom details pertaining to the referral. For example, block 1412 may include entering customer demographic information relating to the new referral. This customer demographics information may include, e.g., names, phone numbers, emails, addresses, custom relationship fields based on parent groups. This demographic information may also include referral demographics, e.g., the supplier to whom the referral is assigned, the source that sent the referral, the time that the referral was sent (back dated as appropriate), any applicable comments, any custom referral fields defined in the offer template, and the like.

Block 1414 represents confirming details related to the referral, and may include submitting the referral to one or more prospective cooperating parties for acceptance. For example, a source member creating the referral may review the referral and customer information before submitting the referral for acceptance by one or more suppliers. In turn, the source member may submit the referral to one or more recipients for consideration and acceptance.

Block 1415 represents creating and validating the source-customer agreement applicable to the referral. As described herein, the referral management system may establish source-customer agreements and source-supplier agreements to send referrals. In different implementations, the source-customer agreement can be manually entered and negotiated, or automatically created and accepted if one does not exist at the time of a referral.

Block 1416 represents receiving a notification of a new referral, and may include viewing details related to the referral. If the terms of the referral are acceptable to the recipient, then block 1418 represents accepting the new referral, making it an active referral. For example, recipients, e.g., members of a dedicated group of suppliers, may receive an email notification, or a notification provided by a referral application, that a new referral has arrived and is pending acceptance. These recipients may then review the newly-arrived referral. If the recipient accepts the new referral, the referral becomes active and is tracked and updated as the referral progresses. If the recipient rejects the referral, the originator of the referral, e.g., a source member, may be notified that the referral was rejected. Rejections may occur due to any number of factors, e.g., incomplete data in the proposed referral, the referred customer is already a customer of the recipient, or the like.

Returning to block 1406, this block may include tracking the referral and updating its status as the referral proceeds. Block 1406 may include the source and/or the supplier tracking and updating the referral. As the referral proceeds, the supplier may perform one or more actions on the referral that, in turn, trigger updates to the status of the referral. Recalling the previous discussion of offer templates, the offer templates for a particular agreement/offer may specify one or more of a list of allowable actions, an order in which the actions are permitted, and the reportable status that result from various stages of processing the referral.

### Systems for Operating Referral Programs

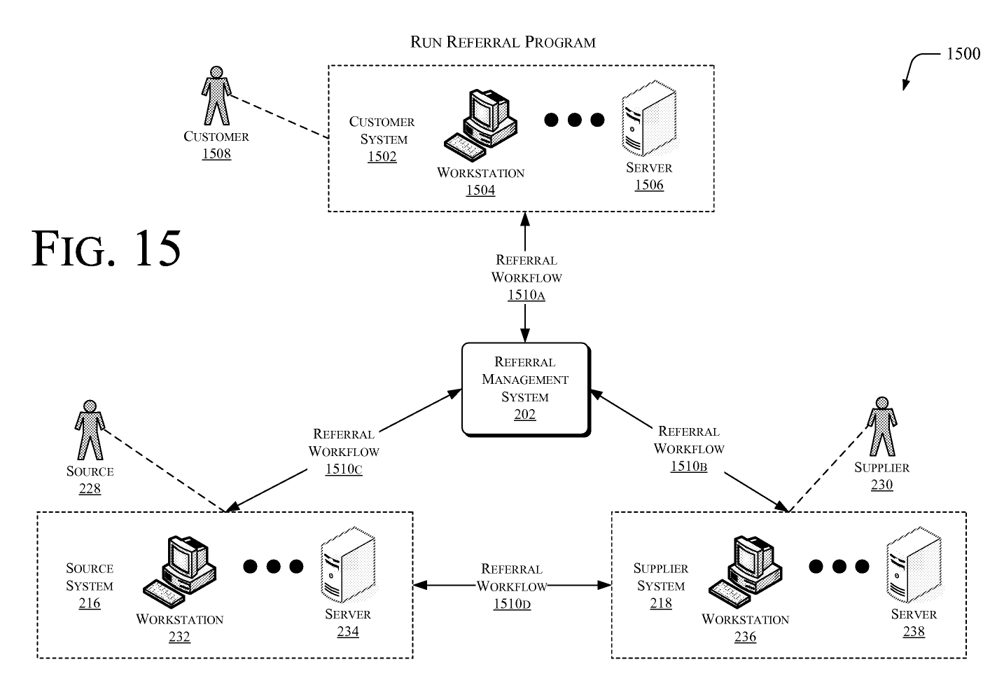

FIG. 15 illustrates systems 1500 for operating or running referral programs, by which one or more source systems may refer customers to one or more supplier system. For convenience of description, but not to limit possible implementations, some items described previously may be carried forward into FIG. 15 and shown by similar reference signs. For example, FIG. 15 carries forward an example referral management system at 202, an example source system at 216, and an example supplier system at 218. FIG. 15 also carries forward examples of source system components, including workstation 232 and server 234, as well as supplier system components, including workstation 236 and server 238. FIG. 15 also illustrates human actors 228 and 230, associated respectively with the source system and the supplier system.

Systems 1500 of FIG. 15 include a customer system 1502, which may include, e.g., one or more workstations 1504 and/or one or more servers 1506. Components of the workstations and/or servers are provided below. However, in overview, the customer system 1502 enables one or more customer actors 1508 to interact with the source system 216 and/or the supplier system 218 via the referral management system 202. For example, the referral management system 202 may enable the customer 1508 to exchange messages and/or data related to one or more referral workflows involving the source system 216 and/or the supplier system 218. 1510A represents data/message flows passing between the customer system 1502 and the referral management system 202; 1510B represents data/message flows passing between the referral management system 202 and the supplier system 218; and 1510C represents data/message flows passing between the referral management system 202 and the source system 216. This discussion references the data/message referral flows collectively at 1510.

Flows 1510A may represent the customer accessing the referral management system, and performing various actions on the referral workflow. For example, the customer may check status of a referral, may terminate the referral, communicate with sources and/or suppliers, or perform any other suitable action. In addition, the flows 1510A may represent feedback provided by the customer on various aspects of the referral process. For example, the referral management system may enable the customer to provide feedback regarding suppliers 230, sources 228, the referral management system 202, customer service, quality of goods/services received, or any other aspect of the referral process.

Some aspects of the data/message referral flows 1510 may not pass through the referral management system. FIG. 15 shows an example of a referral workflow 1510B that passes directly between the source system and the supplier system, but these flows may also pass directly between these systems and the customer system.

It is noted that FIG. 15 illustrates a centralized, separate referral management system 202 only as an example. However, it is noted that the referral management system 202 may be implemented as a centralized service that serves as an intermediary between the supplier system 218, the source system 216, and/or the customer system 1502 to facilitate the data/message referral flows 1510. In other implementations, the referral management system 202 may be implemented as a distributed service, with respective components installed on the supplier system 218, the source system 216, and/or the customer system 1502. These distributed components of the referral management system may communicate with one another to facilitate the data/message referral flows 1510.

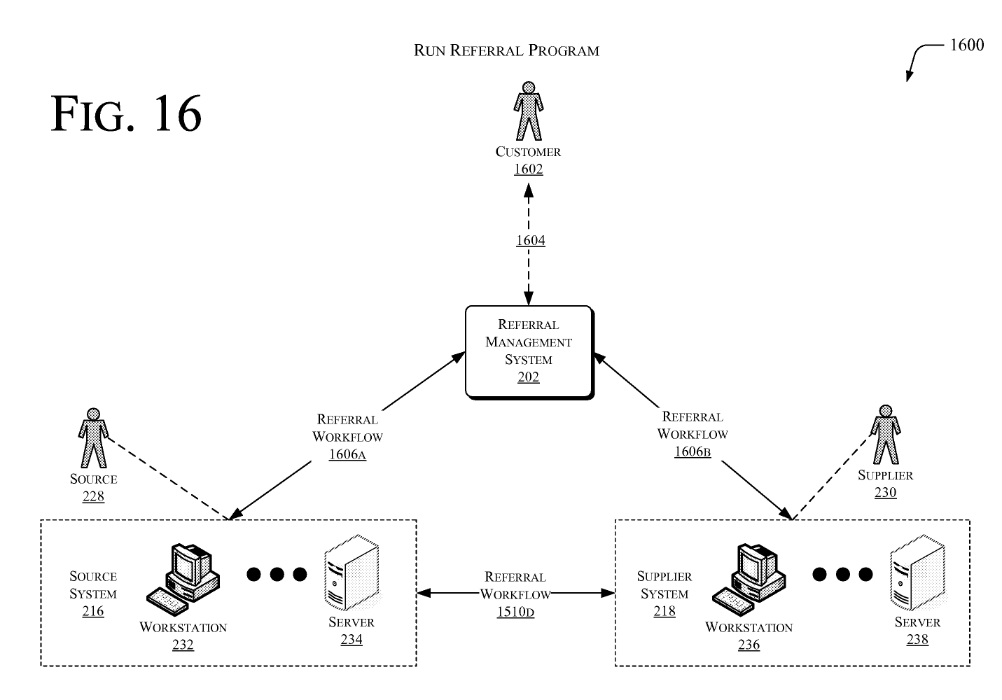

FIG. 16 illustrates systems 1600 for operating or running referral programs, by which one or more source systems may refer customers to one or more supplier system. The systems 1600 are similar to the systems 1500 shown in FIG. 15. However, a customer 1602 as shown in FIG. 16 may not interact directly with the referral management system 202, and the customer 1602 may not be associated with a customer system (e.g., 1502 in FIG. 15). In the systems 1600, the referral management system 202 may act on behalf of the customer 1602, without the customer 1602 being aware of this action. FIG. 16 shows such actions generally by the dashed line 1604.

As an example, the referral management system 202 may enable the source system 216 to send referral workflows 1510d to the supplier system 217, where the referral workflows 1510d may include records pertaining to the customer 1602. In turn, the supplier system 218 may contact the customer 1602, or may send contact information for the supplier system 218 to the customer 1602. The contacts may flow through the referral management system 202, or may pass directly from the supplier system 218 and/or the source system 216 directly to the customer 1602. FIG. 16 provides an example including referral workflows 1606a and 1606b, which pass between the referral management system 202 and the source system 216 and the supplier system 218, respectively. However, it is noted that these referral workflows 1606a and 1606b may also pass directly to the customer.

### Description of Components for Running the Referral Programs

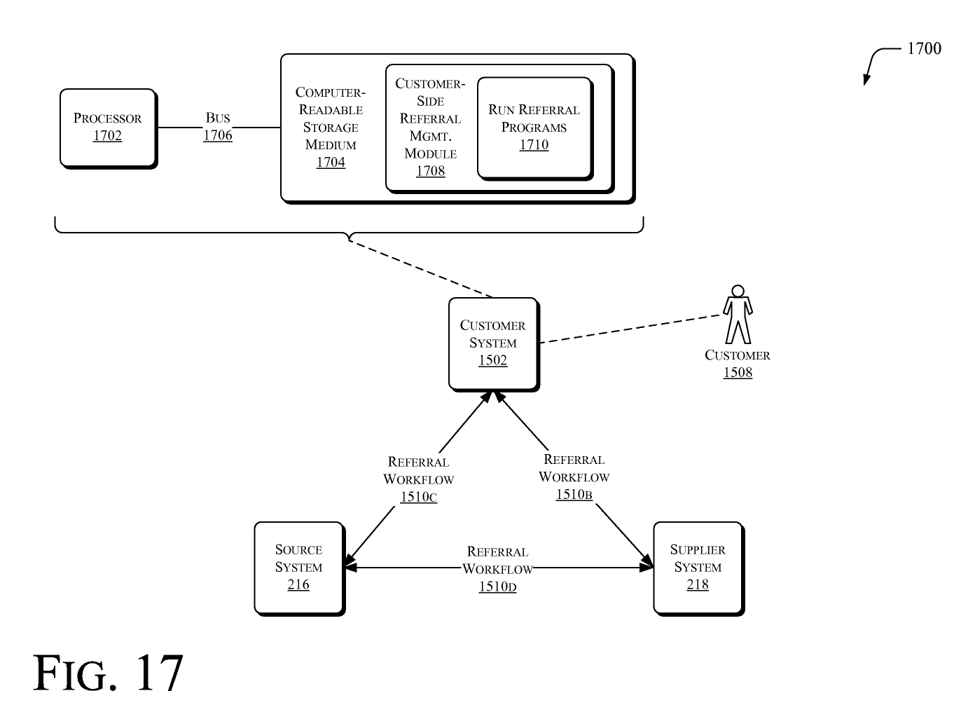

FIGS. 17-19 show examples of components that customer systems, source systems, and supplier systems may include. Previous drawings and discussions have described aspects of building the referral networks; FIGS. 17-19 provide components for operating the referral networks once they are built. For convenience of description, but not to limit possible implementations, FIGS. 17-19 may carry forward some items described previously, and may denote them by similar reference signs. For example, FIGS. 17-19 carry forward examples of customer systems 1502, examples of source systems 216, and examples of supplier systems 218.

FIG. 17 illustrates example components 1700 of the customer systems 1502. The customer systems 1502 may include one or more processors 1702, which may be of any suitable type or architecture. The above description of the processors 208 may apply equally to the processors 1702, although the processors 1702 and the processors 208 may be of different types or architectures.

The customer systems 1502 may include one or more instances of computer-readable storage media 1704, with the processors 1702 communicating with the media 1704 via one or more busses 1706. The busses 1706 be compatible with the processors 1702, and thus may vary in type and architecture according to that chosen for the processors 1702.

The computer-readable media 1704 may include one or more instances of a customer-side referral management module 1708. This module 1708 may include programs of software instructions that, when loaded into the processors 1704 and executed, cause the customer systems to perform any of the functions ascribed herein to the customer systems. For example, assuming a web-based implementation, the referral management module 1708 may be implemented as a browser running on the customer system 1502, with the browser being responsive to input from a customer (e.g., 1508) to display messages from the referral management system 202, the supplier system, 218 and/or the source system 216. The referral management module 1708 may also enable the customer to check the status of any referrals involving the customer 1508.

In some instances, the referral management module 1708 may include one or more sub-modules, such as a module 1710 for running referral programs. The referral management system may provide specialized components, such as the referral management modules 1708 and/or the modules 1710, to the customer systems for installation, so that the customer systems may participate in the referral management techniques described herein.

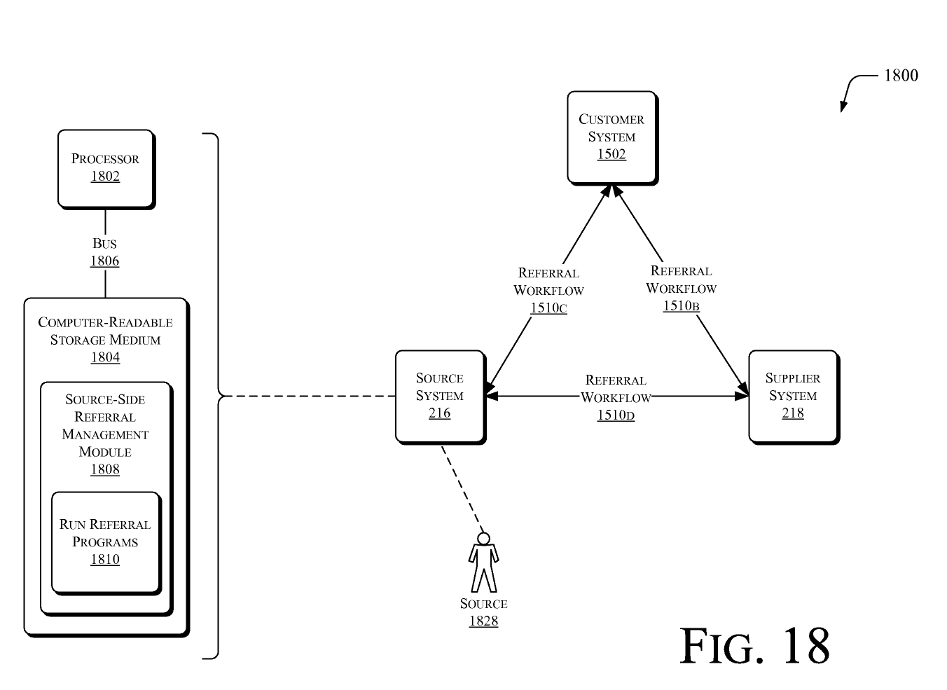

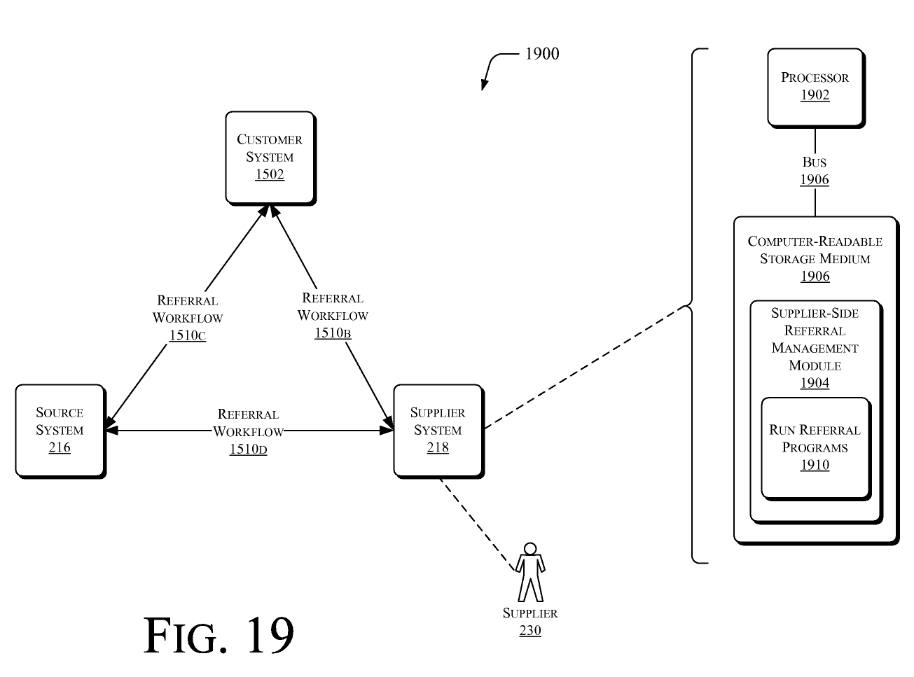

FIG. 18 shows components 1800 of a source system, suitable for enabling the source system 216 to operate or run referral networks. The customer system 1502, the source system 216, and the supplier system 218 are carried forward for convenience, with FIG. 18 elaborating on example components of the source system 216, while FIG. 19 elaborates further on example components of the supplier system 218. FIG. 19 carries forward the example referral workflows 1510b, 1510c, and 1510d for ease of reference, but not limitation.

Source system 216 may include one or more processors 1802, which may be of any suitable type or architecture. The above description of the processors 208 may apply equally to the processors 1802, although the processors 1802 and the processors 208 may be of different types or architectures.

The source system 216 may further include one or more instances of computer-readable storage media 1804, with the processors 1802 communicating with the media 1804 via one or more busses 1806. The busses 1806 be compatible with the processors 1802, and thus may vary in type and architecture according to that chosen for the processors 1802.

The computer-readable media 1804 may include one or more instances of a source-side referral management module 1808. This module 1808 may include programs of software instructions that, when loaded into the processors 1804 and executed, cause the source system 216 to perform any of the functions ascribed herein to the source system 216. For example, assuming a web-based implementation, the referral management module 1808 may be implemented as a browser running on the source system 216, with the browser being responsive to input from source personnel (e.g., 228) to display messages from the referral management system 202, the supplier system 218, and/or the customer system 1502. The referral management module 1808 may also enable the source personnel 228 to check the status of any referrals involving the source system 216.

In some instances, the referral management module 1808 may include one or more sub-modules, such as a module 1810 for running referral programs. The referral management system may provide specialized components, such as the referral management modules 1808 and/or the modules 1810, to the source systems for installation, so that the source systems may participate in the referral management techniques described herein.

FIG. 19 shows components 1900 of a supplier system 218, suitable for enabling the supplier system 218 to operate or run referral networks. The customer system 1502, the source system 216, and the supplier system 218 are carried forward for convenience, with FIG. 19 elaborating on example components of the supplier system. FIG. 19 carries forward the example referral workflows 1510b, 1510c, and 1510d for ease of reference, but not limitation.

Supplier system 218 may include one or more processors 1902, which may be of any suitable type or architecture. The above description of the processors 108 may apply equally to the processors 1902, although the processors 1902 and the processors 208 may be of different types or architectures.

The supplier system 218 may include one or more instances of computer-readable storage media 1904, with the processors 1902 communicating with the media 1904 via one or more busses 1906. The busses 1906 may be compatible with the processors 1902, and thus may vary in type and architecture according to that chosen for the processors 1902.

The computer-readable media 1904 may include one or more instances of a supplier-side referral management module 1908. This module 1908 may include programs of software instructions that, when loaded into the processors 1904 and executed, cause the supplier systems to perform any of the functions ascribed herein to the supplier systems. For example, assuming a web-based implementation, the referral management module 1908 may be implemented as a browser running on the supplier system, with the browser being responsive to input from supplier personnel (e.g., 230) to display messages from the referral management system, the source system, and/or the customer systems. The referral management module 1808 may also enable the supplier personnel to check the status of any referrals involving the supplier system.

In some instances, the referral management module 1908 may include one or more sub-modules, such as a module 1910 for running referral programs. The referral management system may provide specialized components, such as the referral management modules 1908 and/or the modules 1910, to the supplier system for installation, so that the supplier system may participate in the referral management techniques described herein.

### Operating Referral Programs

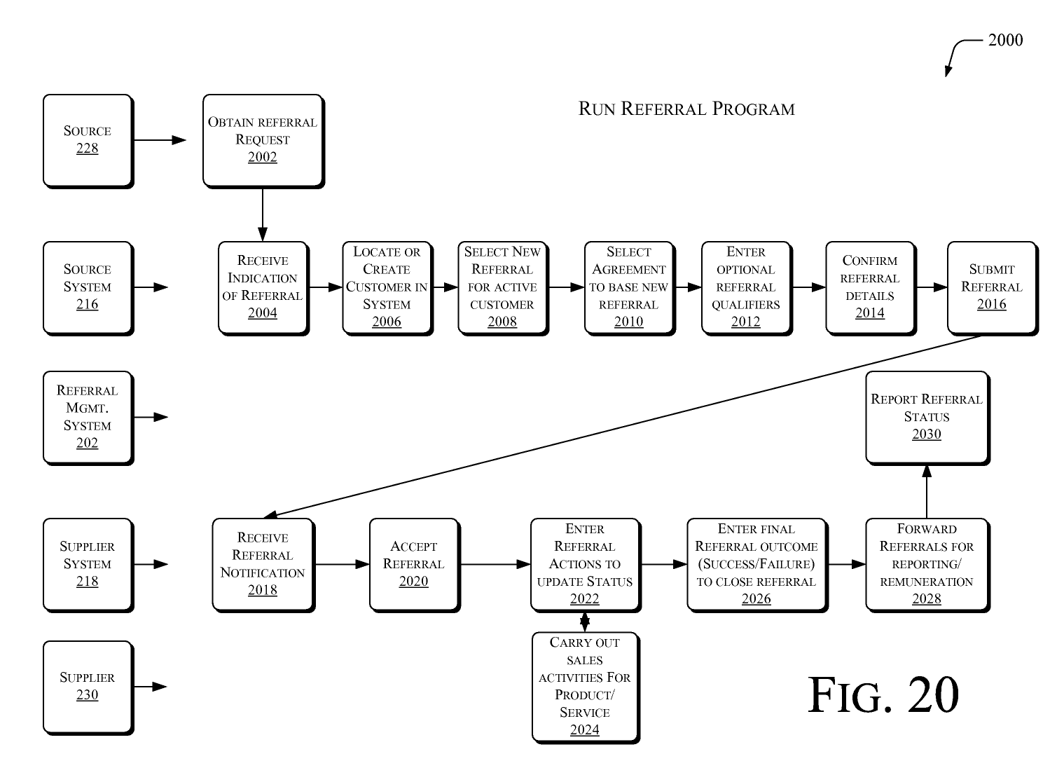

FIG. 20 shows process flows 2000 for operating or running referral programs as described herein. For convenience of description, but not to limit possible implementations, FIG. 20 may carry forward some items described previously, as shown by similar reference signs. For example, FIG. 20 carries forward example source personnel 228, an example source system 216, example supplier personnel 230, and an example supplier system 218.

Block 2002 represents obtaining a referral request from a customer of a source system. Block 2002 may include enabling the source personnel to interact or otherwise communicate with the customer.

Block 2004 represents receiving an indication of the referral request obtained in block 2002. Block 2004 may include the source system 216 receiving the indication of the referral request.

Block 2006 represents searching a referral management system 202 for any records associated with the customer to whom the referral request pertains. If the referral management system 202 contains any existing records for the customer, block 2006 may include accessing these records and extracting information relating to the customer. However, if the referral management system 202 contains no records for the given customer, then block 2006 may include creating one or more new records for the customer, and populating these records with referral information relating to the customer.

Block 2008 represents selecting to create a new referral for an active customer. Block 2008 may include selecting to create one or more supplier systems to which the source system may refer the customer. For example, block 2008 may include receiving user input or responses to a UI. Recalling the previous discussion of establishing referral agreements between source systems and supplier systems, block 2008 may include selecting the supplier systems based on the terms of one or more such referral agreements.

Block 2010 represents selecting an agreement on which to base the new referral. Referrals may be performed based on agreements between customers and sources (“customer agreements”, as that term appears herein), and on agreements between sources and suppliers (“referral agreements” as that term appears herein). These agreements may be organized in any convenient manner to facilitate search, retrieval, and access. For example, referral agreements may be organized by source system 216 and/or supplier system 218, or may be organized by subject matter, customer type or profile, or the like. Customer agreements may be organized by customer name, or any other suitable key.

Block 2012 represents entering any optional referral qualifiers germane to the given referral request. More specifically, block 2012 may include storing the referral qualifiers into the offer template, with the referral qualifiers being chosen as appropriate for particular verticals. For example, for referring residents to particular apartment complexes, the referral qualifiers may include the characteristics of the apartments, such as:

a. number of bedrooms in different models of apartments in the complex,

b. number of residents in the complex,

c. price range of different units,

d. available move-in dates,

e. additional contact information for the complex, and/or

f. additional comments.

In another example, for recommending particular apartments to potential residents, the referral qualifiers may include the characteristics of the apartments sought by the potential residents, such as:

a. number of bedrooms desired,

b. number of residents in the complex,

c. price range,

d. miles willing to drive from the location of the complex,

e. expected move-in date,

f. additional contact information for the resident, and/or

g. additional comments.

In another example, for referring potential home purchaser, the referral qualifiers might include a price range sought by the purchasers, an expected move date, a desired home location, and/or any additional comments.

Block 2014 represents confirming details relating to the referral request. Block 2014 may include confirming optional referral qualifiers, as well as default parameters.

Block 2016 represents submitting the referral request. As shown in FIG. 20, the source system may submit the referral request to the supplier system.

Block 2018, at the supplier system 218, represents receiving the referral request that was sent in block 2016. Block 2018 may include receiving a notification that the source system has sent a referral request.

Block 2020 represents accepting the referral request sent in block 2016. Block 2020 may include enabling the supplier to validate that the information in the referral is valid (e.g., no missing fields), and may also include determine whether the referral qualifiers indicate that the referred customer or prospect is a good match for the supplier. Block 2020 may also include assigning the referral to a particular group or user who is in charge of updating and answering questions on this referral. Block 2020 may include entering any additional comments, and then accepting the referral, as bound by the terms of the referral agreement established between the source and the supplier.

Block 2022 represents entering the referral request into a database or other data structure, to facilitate tracking status of the referral request. Additionally, block 2022 may include mapping or associating the referral request into one or more intermediate follow-up actions. Block 2022 may include instantiating identifiers for these follow-up actions, as well as storing these identifiers in the database to facilitate tracking and reporting status of the follow-up actions. The actual intermediate referral actions may vary, depending on the details of particular implementations. For example, different implementations may involve medical referrals, apartment referrals, commercial building services, or the like. In a scenario involving residential apartment referrals, a set of example intermediate workflow actions and related statuses may include contacting the referral prospect, providing the prospect with a tour of the complex, sending the prospect a lease or contract, having the prospect sign the lease or contract. In addition to the above interim actions/statuses, block 2022 may represent initial and close action statuses as well (e.g., Send, Accept, Closed—Move-In, Closed—No Sale, Close-unable to contact).

Block 2024 represents enabling supplier personnel (e.g., 230) to carry out activities to the customer referenced in the referral received in block 2018. More specifically, block 2024 may include enabling supplier personnel to direct sales efforts to the customer for particular products, goods, and/or services (collectively, “items”) offered by or through the supplier system 218.

Block 2026 represents storing or reporting a final outcome of the sales efforts conducted in block 2024. For example, if the customer accepted or purchased the proffered items, then block 2026 may include storing or reporting a successful outcome. If the customer rejected the proffered items, then block 2026 may include storing or reporting a failure outcome. If the customer did not immediately accept the proffered items, but expressed some interest in doing so in the future, then block 2026 may include reporting some intermediate outcome. Other outcomes are possible in different implementations, in addition to or instead of the examples provided herein.

Block 2028 represents forwarding status or outcome information for the referral for reporting and/or remuneration. For example, block 2028 may include reporting the outcome of the referral to the referral management system 202, to the source system 216, or to any other system or entity. Depending on the terms of the referral agreement established between the source system 216, the supplier system 218, and/or the referral management system 202, block 2028 may include compensating one or more of these parties depending on the outcome of the referral. For example, the supplier system 218 may pay the source system 216 and/or the referral management system 202 for each referred customer, whether the customer consummates a transaction with the supplier system 218 or not. In another example, the supplier system 216 may pay the source system 216 and/or the referral management system 202 only for referrals that result in consummated transactions.

Block 2030 represents reporting status on particular referrals upon request. For example, block 2030 may include the referral management system 202 reporting status of a particular request in response to a query entered by source personnel. In this manner, block 2030 may enable the source personnel to determine how satisfied their customers are with the items offered by the supplier system 218. The level of customer satisfaction achieved by the supplier system 218 may be reflected in sales conversion statistics, feedback or survey data provided by the customers, or other records. This level of satisfaction information may factor into negotiations between the source system and the supplier system regarding any referral agreements between these two parties.

### Graphic User Interface Descriptions

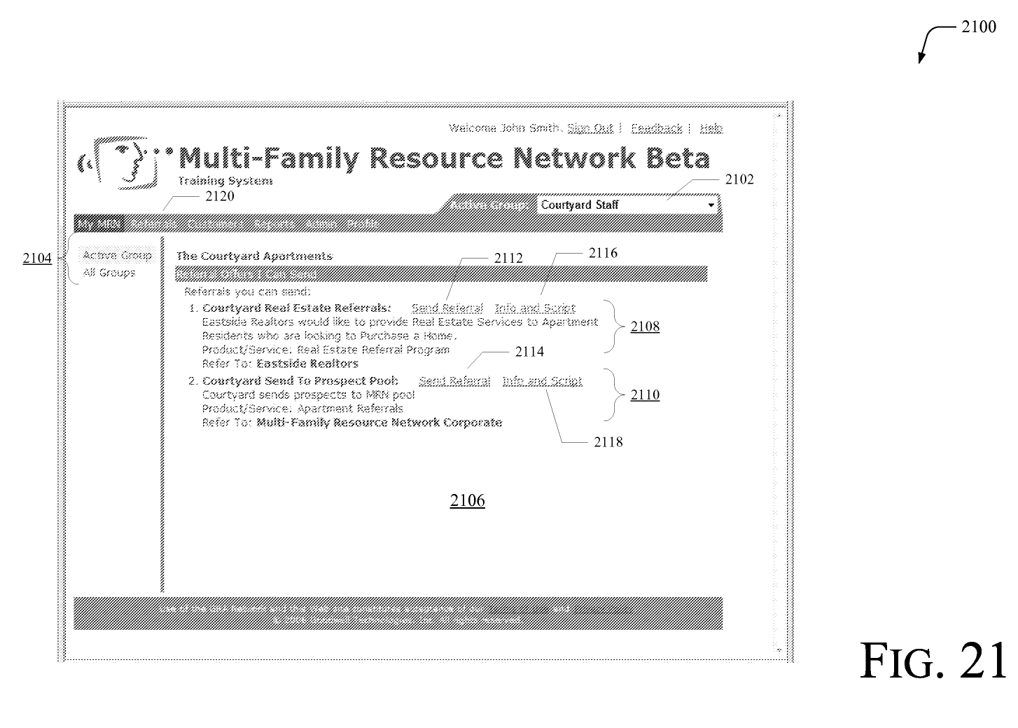

FIGS. 21-27 illustrate various non-limiting examples of graphic user interfaces (GUIs) that may be constructed in accordance with the foregoing description. In providing these illustrations of GUIs, it is noted that these illustrations provide examples only, but do not exclude other possible implementations. More specifically, variations from these examples are possible, without departing from the scope and spirit of the description herein. For example, different layouts, formats, and arrangements of the GUI elements may be appropriate in different implementations. Further, different implementations may include some or all of the elements shown herein, or may include other elements not shown herein.

FIG. 21 shows example GUI 2100. GUI 2100 provides a summary page that may be presented to, for example, source personnel 228 via a computing system 216 associated with the source. GUI 2100 may be responsive to user input to perform any of the functions described herein for executing referrals.

GUI 2100 may present a tool 2102 that is responsive to user input to present a drop-down or other suitable list of various groups of which the source is a member. The example shown in FIG. 21 relates to source in the form of an apartment rental property, with a group named “Central Park East Apartments” arranged for the apartment rental property. In some instances, a given source may be a member of more than one group. By activating the tool 2102, the user may select one of the groups for further action. For example, the user may select or activate one of the groups, and consider sending referrals as a member of the selected group.

FIG. 21 further shows a tool 2104 that is responsive to user input to alter the display of items in the area 2106. For example, the user may select to activate a particular group, and display information pertaining only to that group in the area 2106. Alternatively, the user may select to display information pertaining to all groups of which the organization is a member. In the example shown in FIG. 21, the user has selected the former scenario, as indicated by the highlight of the text “Active Group” at 2104.

Area 2106 may present one or more candidate referral opportunities available to the source. Recalling the discussion of building referral networks and related referral agreements presented in FIGS. 1-14, the area 2106 may be populated based on the referral agreements to which the source is a party.

In the example of FIG. 21, the source apartment rental complex has established at least two referral agreements under which it may refer its tenants or residents to third parties. In one example referral agreement, shown at 2108, the source apartment complex may refer tenants to a real estate agency to, for example, search for a house to buy. In another example referral agreement, shown at 2110, the source apartment complex may refer tenants to a pool of prospects. The term “MRN” refers to an example referral network named the multi-family resource network.

With any of the referral agreements represented in the area 2106, GUI 2100 may provide tools responsive to user input to send referrals according to the referral agreement. For example, FIG. 21 shows tool 2112 that the user may activate to initiate a referral under the agreement 2108, and tool 2114 that the user may activate to initiate a referral under the agreement 2110. FIG. 21 also shows tools 2116 and 2118 that are responsive to user input to provide supplemental information related to referrals available under the agreement, as well as a script that the source may use in connection with referring customers under the agreement.

From GUI 2100, the user may activate a tool 2120 to access another GUI suitable for examining status of pending or current referrals, as now discussed in FIG. 22. In the example shown in the Figures herein, this tool 2120 is labeled “Referrals”.

FIG. 22 shows GUI 2200 for presenting a list of referrals related to the source entity discussed in FIG. 21. For ease of reference, but not to limit alternative embodiments, FIG. 22 may carry forward some elements shown in previous figures, with these elements being shown by the same reference numbers.

GUI 2200 may include tool 2202 that is responsive to user input to adjust the referral information shown in the area 2204. As shown in FIG. 22, the user may select to show those referrals that are pending or in progress, may select to create and send a new referral, may view sent referrals or received referrals, or may view items or customers that were referred to the source. In the example shown, the user has selected to view referrals “In Progress” as indicated by the highlighted text in the area 2202.

GUI 2200 may include tool 2206 that is responsive to user input to present a list or other mechanism for specifying a time period applicable to the referral information presented in the area 2204. In the example shown, a seven-day window is selected; however, any suitable time period may be chosen. GUI 2200 may include tool 2208 that is responsive to user input to initiate a process for sending a referral.

GUI 2200, within the area 2204, may present information related to referrals that have been sent, as shown at 2210. These referrals may be been sent or originated by the party associated with GUI 2200. In this example, this party may be a source system, and the area 2210 may include representations of customers referred by the source to suppliers. The area 2210 may provide information indicating a type of referral 2212. An area 2214 may provide names and other information relating to customers who were referred from a source to a supplier. An area 2216 may provide a current status of the referral.

Within the area 2204, GUI 2200 may further present related to referrals that have been received, as shown at 2218. In addition, the area 2218 may provide information relating to types of referrals received (area 2220), customer information pertaining to the received referrals (area 2222), and current status of the received referrals (area 2224).

The area 2204 may also include an area 2228 that provides information on any referrals in which the organization (e.g., the apartment complex) is itself a customer. In the example shown in FIG. 22, this area 2228 is empty, but scenarios are possible in which the apartment complex (and other organizations participating in the referral network) may assume the roles of source, customer, and supplier in different referrals. For example, the apartment complex may be a customer of another organization (e.g., a maintenance or janitorial company), with this other organization being a source for referring the apartment to a supplier (e.g., a plumbing or electrical contractor).

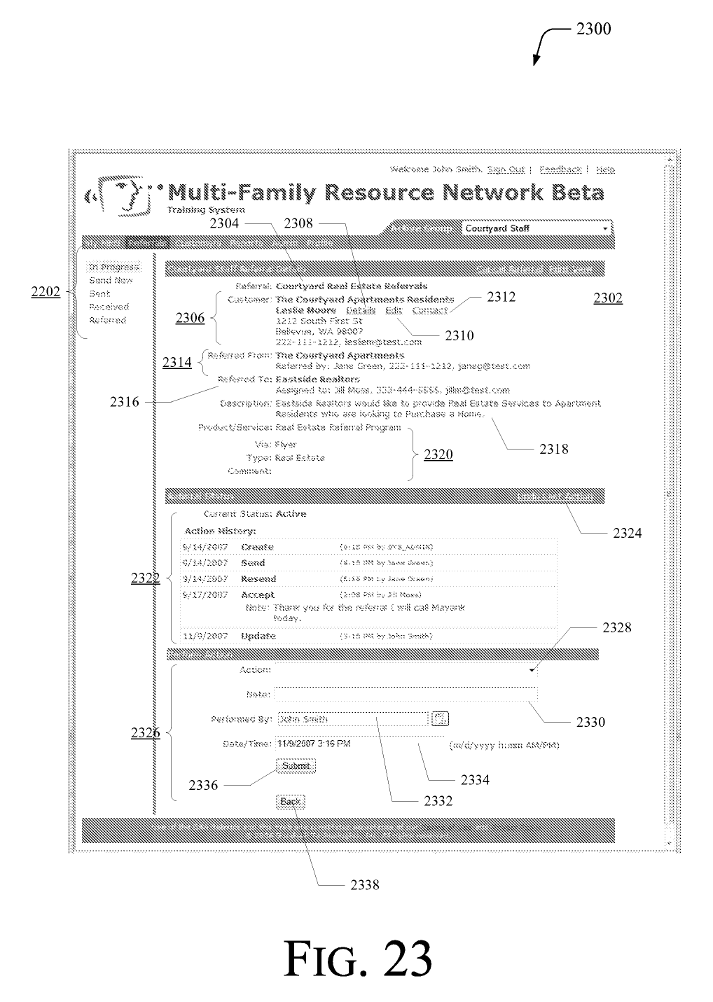

The areas or fields 2212 and 2220 may provide links that are responsive to user input to provide further information relating to a selected referral. FIG. 22 shows such an example link at 2226. In response to the user activating the link 2226, GUI 2200 may transition to a GUI that presents more detailed information relating to the referral, as now discussed with FIG. 23.

FIG. 23 shows GUI 2300 for providing further information relating to a selected referral. For ease of reference, but not to limit possible implementations, FIG. 23 may carry forward some elements shown in previous figures, with these elements being shown by the same reference numbers. For example, GUI 2300 may be presented in response to a user requesting more information about a given referral (e.g., by clicking a link such as 2226 in FIG. 22).

GUI 2300 may include an area 2302 that provides additional details relating to the selected referral. For example, as shown at 2304, GUI 2300 may indicate a name or other identifier for the referral. As shown at 2306, GUI 2300 may provide detailed information relating to the customer who was referred from a source to a supplier. Within the area 2306, a tool (e.g., a link) 2308 may respond to user activation to provide further information relating to the customer featured in the area 2306. A tool 2310 may respond to user activation to present another GUI that enables the user to edit information related to the customer. A tool 2312 may respond to user activation to present another GUI that enables the user to contact the customer.

An area 2314 may indicate who referred the customer, or from where the customer was referred. That is, given a referral involving a customer, area 2314 indicates the source of that referral.

An area 2316 may indicate to whom the customer was referred. More specifically, the area 2316 may indicate the supplier to whom the source referred the customer. As shown in the example of FIG. 23, the area 2316 may identify a point of contact, within or acting on behalf of the supplier organization, who has responsibility for performing or handling any follow-up actions related to the referral.

An area 2318 may provide a description of the subject matter pertaining to the referral. In the example shown in FIG. 23, the description 2318 relates to providing real estate services to apartment residents.

An area 2320 may provide a high-level synopsis of the product/service for which the customers are being referred (e.g., “real estate referral program”), may describe what types of information is provided to the customers to effectuate the referral (e.g., “flyer”), and may indicate a general category or type that characterizes the subject matter of the referral (e.g., “real estate”).

An area 2322 may provide current status of a given referral, and may list the various actions that have occurred in connection with the given referral. FIG. 23 shows an example sequence of three actions (e.g., Create referral, Send the referral to a supplier, and Accept the referral). The area 2322 may indicate when these actions occurred, and who performed these actions.

The area 2322 may provide a tool 2324 that is responsive to user input to undo a last action performed in connection with the given referral. For example, if an error has occurred at some point in handling the referral, a user may “undo” one or more actions to reach the point where the error occurred, so that the referral process may be repeated to correct the error.

An area 2326 may include a variety of tools that are responsive to user input to perform one or more actions related to the given referral. For example, a tool 2328 may provide a drop-down list of actions available for the given referral, and may be responsive to user input to select one of the available actions for execution. A fill-in field 2330 may enable a user to provide any notes related to the action(s). A fill-in field 2332 may indicate who performed or will perform the action(s). In turn, names entered into the field 2332 may populate a names area in the area 2322 when the action is completed.

An area 2334 may indicate a date/time when the action is initiated, and a tool 2336 may be responsive to user input to submit the action for further processing. The exact nature of the processing may depend on the role played by the device on which GUI 2300 is presented, and/or the role played by the user who is interacting with the GUI. For example, if GUI 2300 is presented on a source system, this next action might include submitting the referral to a supplier system. If GUI 2300 is presented on a supplier system, this next action might include forwarding the referral to a responsible party within the supplier organization. Other scenarios are possible, with the foregoing examples being provided only for purposes of illustration.

A tool 2338 may respond to user input to return GUI 2300 to a previous GUI in a history of navigations. For example, assuming implementations based on web browsers or similar applications, the tool 2338 may provide a “back” button allowing the user to navigate backward through a navigation history.

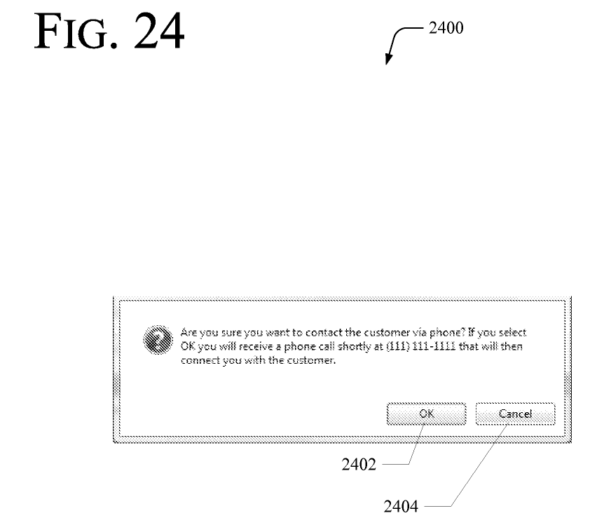

FIG. 24 shows GUI 2400 for enabling a user to contact a given customer. In the example shown, GUI 2400 may enable the user to contact a referral customer by telephone, extracting the relevant contact information from a record associated with a given referral. For example, GUI 2400 may be presented in response to a user activating a tool to initiate contacting a customer (e.g., the tool 2312 shown in FIG. 23). Once presented with GUI 2400, the user may activate a tool 2402 to initiate the communication, or may activate a tool 2404 to cancel out of the GUI 2400. In example implementations, a referral management system (e.g., 202 in FIG. 2) may facilitate the communication using telecommunications infrastructure.

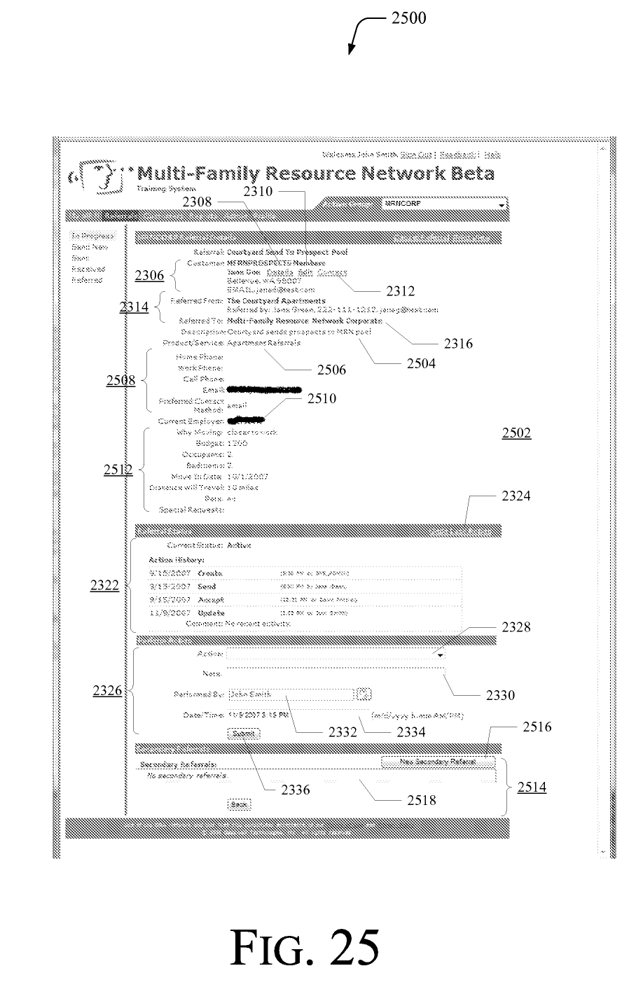

Figure shows GUI 2500 for presenting details relating to a given referral. For ease of reference, but not to limit possible implementations, FIG. 25 may carry forward some elements shown in previous figures, with these elements being shown by the same reference numbers.

In example implementations, GUI 2500 may be presented in response to a user requesting more information about a given referral (e.g., by clicking a link such as 2226 in FIG. 22).

Within GUI 2500, an area 2502 may provide details relating to a referral involving a given customer under a given referral program, with the sub-areas 2306, 2308, 2310, 2312, 2314, and 2316 carried forward as non-limiting examples. The area 2502 may provide additional details regarding the supplier to whom the customer is referred. For example, the field 2504 may provide a description of the referral program. A field 2506 may indicate a product/service to which the referral program pertains. An area 2508 may provide contact information for the customer currently being referred. A field 2510 may provide employment status for the customer, and an area 2512 may provide additional information pertaining to the customer.

In a referral example pertaining to real estate brokerage services, the area 2512 may indicate why a given customer is seeking to move, an estimated budget with which the customer is comfortable, occupant capacity/bedrooms sought by the customer in a new residence, a targeted move-in date, a distance parameter, whether the customer owns pets, any special requests from the customer, and the like. These examples are provided for illustration only, and may vary depending on the industry in which this description is implemented. More specifically, implementations of this description may include areas and fields other than those shown in FIG. 25 without departing from the scope and spirit of the description herein.

In the example shown, GUI 2500 may also provide information related to secondary referrals, and may enable a user to request that one or more secondary referrals be initiated. For example, a secondary referral may describe a scenario in which, during a first referral, a given source refers a customer to a first given supplier. Afterwards, in a second referral, the first supplier refers the customer to another supplier for additional good/services. In this second referral, the first supplier assumes the role of a source. This example illustrates the general proposition that the tools and techniques described herein enable any of the three parties described herein (customer, source, and supplier) to assume different roles at different times.

GUI 2500 may include an area 2514 that includes tools related to initiating and tracking secondary referrals. For example, the area 2514 may include a tool (e.g., button) 2516 that is responsive to user input to initiate a secondary referral.

The area 2514 may also include one or more fields 2518 that provide information relating to active secondary referrals. In the example shown in FIG. 25, no secondary referrals are active, but if the entity or system displaying GUI 2500 were included in a chain of referrals, the area 2518 may report information relating to any secondary referrals involving this entity or system.

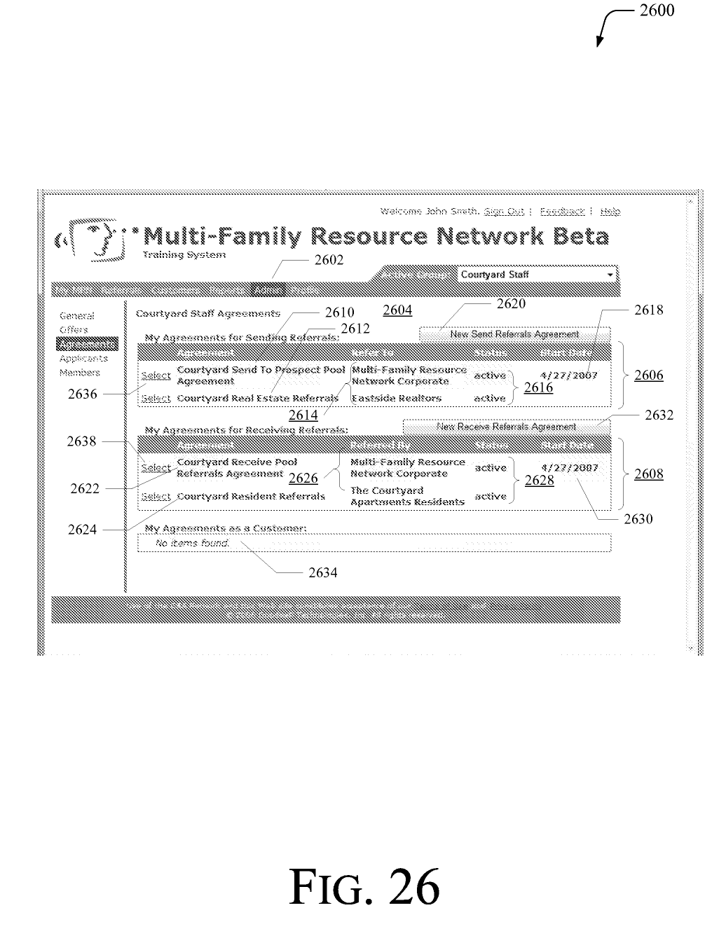

FIG. 26 shows GUI 2600 for presenting information relating to one or more agreements established for a given participant in the referral networks described herein. For ease of reference, but not to limit possible implementations, FIG. 26 may carry forward some elements shown in previous figures, with these elements being shown by the same reference numbers.

In the example shown in FIG. 26, GUI 2600 may include a tool 2602 that is responsive to user input to display an area 2604 for presenting information pertaining to the various agreements. In the example shown in FIG. 26, the area 2604 may include an area 2606 for displaying information relating to agreements under which referrals may be sent, and an area 2608 for displaying information relating to agreements under which referrals may be sent.

Area 2606 may include a list of one or more referral agreements under which the party displaying the GUI 2600 may refer customers. FIG. 26 shows two examples of such referral agreements at 2610 and 2612, but the area 2606 may depict zero or more such referral agreements in possible implementations. More specifically, under these referral agreements, the party displaying the GUI 2600 may assume the role of a source that refers customers to one or more suppliers. FIG. 26 shows examples of candidate suppliers at 2614, and provides examples of agreement status at 2616. Over time, different referral agreements may be activated, deactivated, and/or reactivated as business goals indicate. Also, GUI 2600 may indicate respective start or effective dates for the various referral agreements, with an example shown at 2618.

The area 2606 may further include a tool 2620 that is responsive to user input to initiate a process for creating new referral agreements. More specifically, the tool 2620 may initiate a process for creating referral agreements in which the entity or system displaying the GUI 2600 may be a source of referrals.

Area 2608 may include a list of one or more referral agreements under which the party displaying GUI 2600 may receive customers who are referred by another party. FIG. 26 shows two examples of such referral agreements at 2622 and 2624, but the area 2606 may depict zero or more such referral agreements in possible implementations. More specifically, under these referral agreements, the party displaying GUI 2600 may assume the role of a supplier that receives customers referred by one or more sources. FIG. 26 shows examples of candidate sources at 2626, and provides examples of agreement status at 2628. Over time, different referral agreements may be activated, deactivated, and/or reactivated as business goals indicate. Also, the GUI 2600 may indicate respective start or effective dates for the various referral agreements, with an example shown at 2630.

Area 2608 may further include a tool 2632 that is responsive to user input to initiate a process for creating new referral agreements. More specifically, the tool 2632 may initiate a process for creating referral agreements in which the entity or system displaying the GUI 2600 may be a supplier that receives referrals.

GUI 2600 may also include a field 2634 that provides information relating to referral agreements under which the entity or system displaying GUI 2600 may act as a customer. In the example shown in FIG. 26, no referral agreements are shown, but implementations may support zero or more referral agreements in which the entity displaying GUI 2600 may be referred as a customer from a source to a supplier. This scenario provides further examples of how the tools and techniques provided herein may enable parties to the referral agreements to assume multiple different roles (e.g., customer, source, and supplier) in different scenarios.

Areas 2608 and 2608 may further include tools that are responsive to user input to present GUIs that provide additional information about particular referral agreements selected by a user. FIG. 26 shows examples of such tools at 2636 and 2638. In these examples, the tools 2636 and 2638 may include hyperlinks labeled “Select” or as otherwise appropriate in a given implementation.

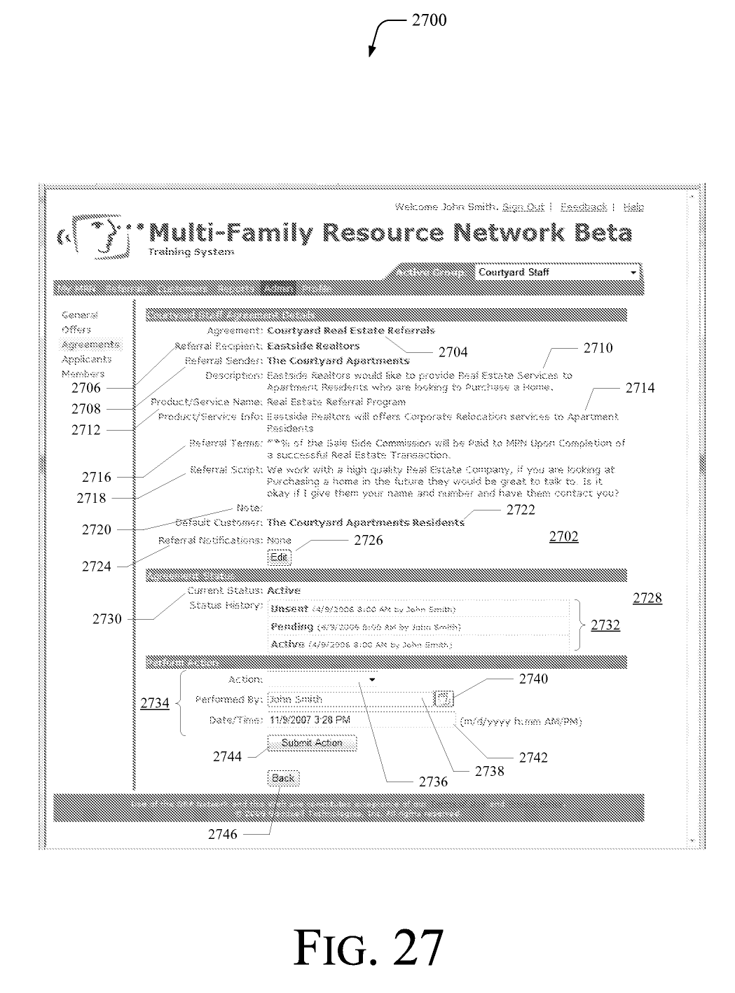

FIG. 27 shows GUI 2700 for presenting additional details relating to a given referral agreement. For ease of reference, but not to limit alternative embodiments, FIG. 27 may carry forward some elements shown in previous figures, with these elements being shown by the same reference numbers. For the purposes of discussion, this description assumes that the contents of GUI 2700 are presented in response to the user activating a tool such as that shown at 2636 in FIG. 26. However, it is noted that GUI 2700 may be presented in any manner appropriate in different implementations.

GUI 2700 may include an area 2702 for displaying details related to a selected referral agreement. Within this area 2702, the GUI 2700 may indicate a name of the referral agreement, as shown at 2704. GUI 2700 may also indicate a source and a supplier specified by the referral agreement, as shown respectively at 2706 and 2708. Additionally, GUI 2700 may provide a description of the subject matter of the agreement (e.g., 2710), a product/service name for the referral agreement (e.g., 2712), product/service information (e.g., 2714), and the like. GUI 2700 may also include a field 2716 that provides the terms under which the referral may occur, and may include a field 2718 that presents an example script that source personnel may relate to customers when offering to refer the customers to the supplier. A field 2720 may provide any additional notes relevant to a particular referral agreement. A field 2722 may indicate a group of default customers for the particular referral agreement. A field 2724 may indicate whether notifications are to be sent when referrals occur under the agreement. These notifications may be sent to suppliers, sources, customers, and/or referral management systems, chosen as appropriate in different implementations.

GUI 2700 may include a tool 2726 that is responsive to user input to enable the user to edit any of the fields 2704-2724 as appropriate. Typically, appropriate security and authentication measures may be instituted to allow only authorized administrative personnel to access the GUI 2700 or the tool 2726.

The specific content of fields 2704-2724 may vary in different referral scenarios. Thus, the examples provided in FIG. 27 are understood to be illustrative in nature, and do not necessarily limit the features included in possible implementations of this description.

GUI 2700 may include an area 2728 that provides status of the referral agreement. For example, if all parties to an agreement are actively participating in the agreement at a given time, then the agreement is active at that time. However, if one or more of the parties has closed or suspended the agreement, the status of the agreement may so reflect. More specifically, the area 2728 may include a field 2730 that provides a current status of the agreement (e.g., active, pending, unsent, closed, on hold, and the like). One or more fields 2732 may provide a status history of the referral agreement, and may indicate when (e.g., dates and/or times) the status of the agreement changed states. The fields 2732 may also indicate personnel associated with the changes in status. As referrals performed under these agreements proceed through a number of different transactions, the contents of the field 2728 may be updated accordingly. The data used to populate the field 2728 may be stored in one or more suitable data bases, which are updated as these transactions and referrals occur over time.

GUI 2700 may include an area 2734 that includes one or more tools that are responsive to user input to perform various actions on a given referral agreement. More specifically, these tools within the area 2734 may enable a user to request that these actions be performed under a referral agreement whose information is displayed in GUI 2700. The area 2734 may provide a tool 2736 that is responsive to user input to provide, for example, a drop-down list of available actions to perform at a given time. The contents of the drop-down list may vary as appropriate, depending on the state of a given referral at a given time, and as indicated by the object models described below.

The area 2734 may include a field 2738 indicating who performed a given action. For example, if the user wishes to perform a given action on a given referral, he or she may activate the pull-down list 2736 to select the given action, and then enter his or her name in the field 2738.

The area 2734 may include a tool 2740 that is responsive to user input to popup a picker tool that allows the user to search for group members within the supplier group as the person who performed the action. Generally, in the UI drawings herein, icons similar to the tool 2740 are responsive to user input to popup a picker tool that allows the end user to pick either a group or group member, depending on the context of the parent field.

The area 2734 may include a date/time field 2742 indicating when the action was performed. Additionally, a tool 2744 may be responsive to user input to submit the action selected at 2736 for further processing.

A tool 2746 may be responsive to user input to dismiss the GUI 2700 and return control to a GUI shown previously. In this manner, the tool 2746 may perform as a “Back” button to return to a previous stage in a browser-like navigation.

Having described the above examples of GUIs, the discussion now proceeds to a description of secondary and chain referrals, now presented with reference to FIGS. 28-29.

### Chain/Secondary Referrals

FIGS. 28-29 illustrate various non-limiting examples of secondary and chain referrals, with FIG. 28 illustrating secondary referrals and FIG. 29 illustrating chain referrals. For ease of reference, but not to limit possible implementations, FIGS. 28 and 29 may carry forward some elements shown in previous figures, with these elements being shown by the same reference numbers.

FIG. 28 shows scenario 2800 involving one or more secondary referrals. Beginning with an initial referral “A”, shown at 2802, a given source “A”, shown at 216a, refers a given customer to a supplier “A”, shown at 218a. FIG. 28 shows information associated with the referred customer at 1508A.

In turn, the supplier “A” 218a may initiate one or more secondary referrals, with FIG. 28 denoting two examples of secondary referrals at 2804 and 2806. A secondary referral is where an initial referral causes and is linked to one or more subsequent (secondary) referrals. In this example, the source A initiates the initial referral 2802 that is sent to supplier A. When the supplier A initiates the secondary referrals, the supplier A becomes the source (shown at 216B and 216N) of these secondary referrals. FIG. 28 represents this relationship by arranging the blocks 218a, 216b, and 216n in a vertical column, indicating that the party in the supplier role 218a may assume the source roles 216b and 216n.

Regarding the secondary referral 2804, a supplier B (218b) may receive this secondary referral. FIG. 28 shows information pertaining to this secondary referral at 2808, and shows customer information relayed as part of this referral at 1508b.

Regarding the secondary referral 2806, a supplier N (218n) may receive this secondary referral. FIG. 28 shows information pertaining to this secondary referral at 2810, and shows customer information relayed as part of this referral at 1508n.

As a non-limiting example of the foregoing, the initial referral 2802 may result from a customer's expressed interest in purchasing a new vehicle. The source 216a, with whom the customer has an existing business relationship, may refer the customer to a supplier A 218a. In turn, the supplier A 218a may act as a clearing house for this initial referral, and send out one or more subsequent (secondary) referrals (e.g., 2804 and 2806) to several automobile dealerships and brokers, who become respective suppliers as to these secondary referrals. In turn, these secondary suppliers may engage the customer, and attempt to sell a vehicle to the customer.

Generalizing from these examples, a given parent or initial referral may spawn or result in any number of secondary referrals, which may have the same source. For example, a person (i.e., a customer) may contact a given apartment complex looking for an available apartment. If the complex is full, it may refer the customer to a centralized pool serving a plurality of different apartment complexes. In this example, the first complex is a source, and the pool is a supplier. In one or more secondary referrals, the centralized pool may refer the customer to one or more complexes who are members of this pool. In these secondary referrals, the centralized pool transitions roles from a supplier to a source, and may refer the customer to any number of local apartment complexes as secondary referrals from the original pool referral.

Having described the secondary referrals in FIG. 28, the discussion now turns to a description of chain referrals, now presented in FIG. 29.

Turning to FIG. 29, this drawing illustrates several chain referral scenarios, shown at 2900. An initial referral A (2902) may include a source A (216a) referring information related to a customer 1508a to a supplier A (218a). In turn, the supplier A may initiate a chain referral B, as shown at 2904, with the supplier A becoming a source B (216b) in this chain referral B. The source B (216b) would then refer customer information (1508b) to a supplier B (218b) within this chain referral B. FIG. 29 shows this chain referral B at 2906.

Having received the chain referral 2906, the supplier B (218b) may initiate a second chain referral C, as shown at 2908. In this chain referral C, the supplier B becomes a source C (216c), and refers information related to the customer (1508c) to a supplier C (218c). FIG. 29 shows this chain referral C at 2910.

Generalizing, implementations of the scenarios 2900 may include any number of chained referrals. In the example shown, the supplier C spawning a new chain referral D at 2912 and becoming a source in this new referral, as shown at 216d. FIG. 29 shows this chain referral D at 2914.

As understood from the foregoing descriptions, two referrals that follow a given initial referral may be termed secondary referrals or chain referrals. Referring briefly back to FIG. 28, this drawing illustrates two secondary referrals A and N, shown respectively at 2804 and 2806. These two secondary referrals share the same originating supplier A (218a), with this supplier becoming the source of both secondary referrals. Returning to FIG. 29, this drawing illustrates two examples of chain referrals B and C, shown respectively at 2906 and 2910. These two chain referrals B and C are linked by the supplier B (218b), in the sense that the supplier B received the referral B and initiated the referral C. However, these two chain referrals B and C do not share the same originating supplier.

In an example of a chain referral scenario, a first physician may refer a given patient to a second physician. However, if the second physician isn't taking patients, then the second physician may refer the patient to a third physician. If the third physician turns out to be too far from the patient, then the third physician may refer the patient to a fourth physician who is closer to the patient, with the first, second, and third physicians no longer involved in the referrals. If the patient doesn't like the fourth physician's credentials, the fourth physician may refer the patient to a fifth physician, and so on.

In some, but not necessarily all, scenarios, secondary referrals may occur with chain referrals. For example, as shown in FIG. 29, the supplier A (218a) may initiate a secondary referral N (2916), along with initiating the chain referral 2904. In turn, the supplier A may become a source N (216n) as to this secondary referral. The source N may refer customer information 1508n to a supplier N (218n), with FIG. 29 denoting the secondary referral N at 2918.

In facilitating these secondary and chain referrals, referred to collectively as “child referrals”, the referral management system may define rules that control the behavior of the child referrals. For example, the referral management system may mark child referrals as competitive with one another. In a competitive child scenario, the first supplier to complete a transaction with the customer would win, and the remaining child referrals would be closed. In another example, the referral management system may mark the child referrals as standard or non-competitive. In this latter scenario, the child referrals may complete successfully, independent of and regardless to the status of the other children.

### Object Models

Having described the above scenarios for performing secondary referrals, the discussion now proceeds to a description of models for various objects that may provide for automated building and maintenance of referral networks and performing related referrals, as described herein.

Turning to these extensible object models in more detail, the referral management systems may instantiate and maintain a variety of objects, and may implement mechanisms for regulating access to those objects. FIG. 30 provides an example of a mechanism for regulating access to objects, shown at 3000. One or more objects appear at 3002a and 3002n (collectively, objects 3002). These objects may include respective extensible XML documents, in example implementations. These objects 3002 may specify one or more tokens to access the objects, with FIG. 30 denoting these access tokens respectively at 3004a and 3004n (collectively, access tokens 3004).

The referral management system may include a process that performs the role of controlling or regulating access to a given object, as represented at 3006. The access control role 3006 may populate an access control list 3008 with representations of various objects 3002 and related access tokens 3004. More specifically, the access control list 3008 may include any number of access control entries (e.g., 3010a and 3010n) that store representations of these objects and access tokens.

FIG. 30 shows an example of a requesting process at 3012, and shows a request for a given object at 3014. The request 3014 may reference a given object, as indicated at 3016, and may provide one or more input access tokens as indicated at 3018. The access control process 3006 may then access the input access tokens in the access control list entry for the given object, and compare them with the tokens 3018 submitted by the requesting process.

FIG. 30 represents dispositioning the access request by the line 3020. More specifically, the access control process 3006 may allow or deny access to the object, based on whether or not the input tokens 3018 matches the token 3004 as located in the access control list 308.

The referral management platform provides tools and techniques that allow extensible XML objects, object sections/elements, to be linked to access control entries, which allow the access control entries to be grouped by roles that are defined within the referral management platform. Thus, in effect, innumerable permutations of extensible of such objects, or group objects, may be conceived by the platform. In addition, the access control entries may enumerate the list of actions that can be taken with respect to a particular object. In turn, users may be granted or denied access to a particular object based on a matching algorithm that compares the object list of control entries with the user's list of tokens.

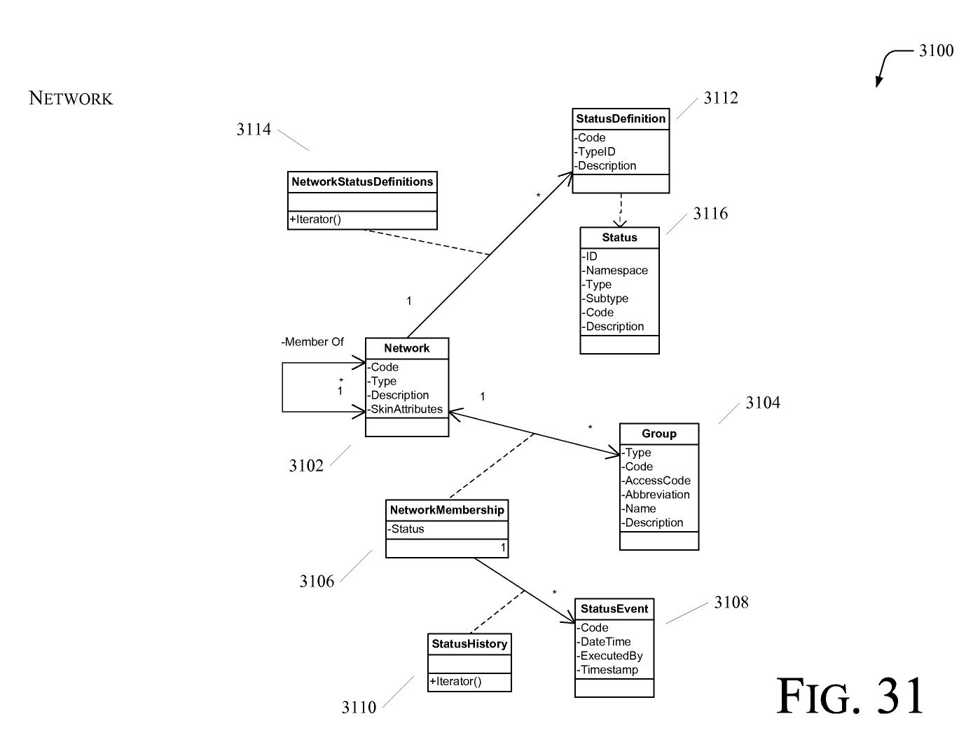

FIG. 31 shows relationships 3100 between network objects, status objects, and group objects. Example Network Object 3102 may represent a referral network, and may define one or more convenient attributes, with those shown in block 3102 provided as non-limiting examples. A network object may include any number of member Networks or Groups. A given Network or Group can be a member of multiple Networks. FIG. 31 shows an example group object at 3104, with an example set of attributes. A network membership, represented in FIG. 31 by a link 3106, may define the relationship between the network object and the group object. The network membership object 3106 may indicate a status of the membership of the group in the network. In turn, this network membership object 3106 may relate to a status event object 3108 (with related attributes), as indicated by a link 3110. The term “iterator” refers to an object that controls access to members of a collection (e.g., first, last, next, insert, delete, etc.).

The network object 3102 may also be associated with one or more status definition objects 3112. FIG. 31 provides example attributes or properties for the status definition object. A link 3114 represents a relationship between the network object and the status definition of the network.

In turn, the status definition object 3112 may be associated with a status object 3116, as indicated by the dashed line connecting blocks 3112 and 3116 in FIG. 31. The status object 3116 may include the example properties or attributes shown in FIG. 31.

FIG. 31 is presented from the Network perspective, in the sense that a group may be a member of multiple networks, but a given network know only about its own groups. The objects shown in FIG. 31 may enable a Network to define statuses to be associated with its membership. For example, a Group may be an “active” or “inactive” member of the Network. A Network can keep track of a member Group's status history. Networks can be related to other Networks in a hierarchical structure.

The data and relationships conceptually depicted in FIG. 31 may be implemented by extensible XML documents provided with the referral management system. Examples of such XML documents may include: Network, Group, Status, and Action, as now described in the next several drawings.

The referral management platform provides tools and techniques that may link activity within the system to a particular referral network. This capability allows the system to make value determinations regarding a particular network. In addition, networks may define and manage their members, and may set visibility levels available to members within the group. In this manner, the network may specify which other members a given member may see, or which other members may see the given member. The networks may also control a group's access to one or more other groups. Networks may be nested or linked to other networks in any form of hierarchical structure, and groups may be associated with one or more networks. Thus, in effect, innumerable permutations of extensible of such objects, or group objects, may be conceived by the platform.

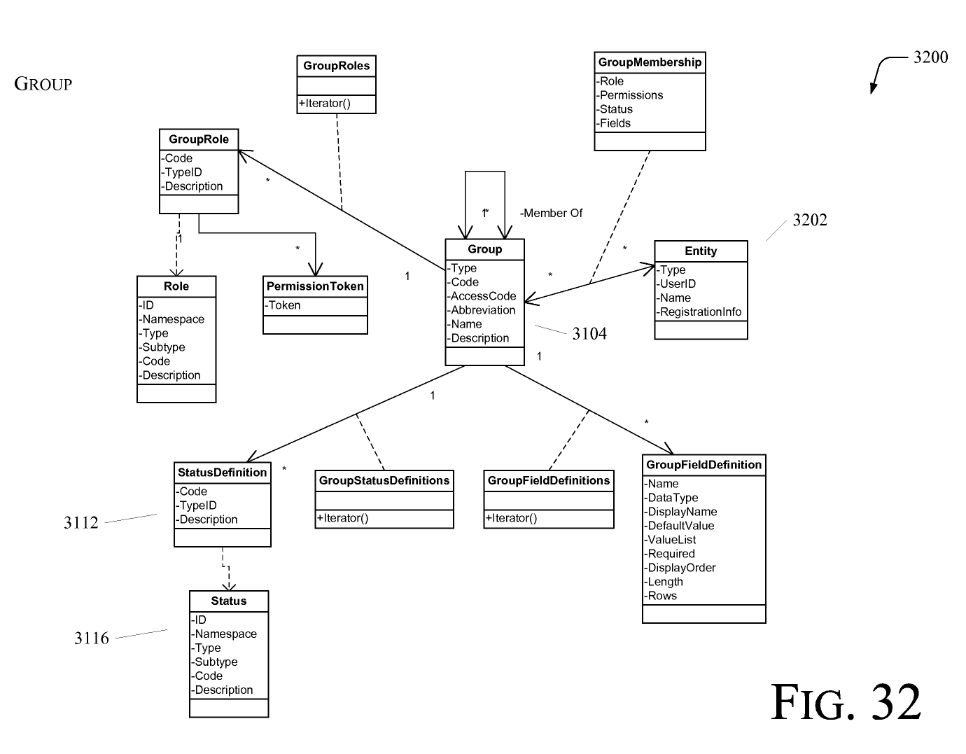

FIG. 32 shows further aspects of a Group object, with FIG. 32 carrying forward an example of a group object at 3104 for ease of reference, but not to limit possible implementations. The group object may define a collection of member Group or Entity objects, with FIG. 32 providing an example of an entity object at 3202. The Group object may define the roles, permissions, membership statuses, and fields that relate to an individual member of the Group. The Group may represent various entities participating in the referral networks, for example, companies, individuals, organizations, associations, or the like.

The referral management platform provides tools and techniques that allow an individual person to be a group, and to function as a group within the referral management system. An individual may be the root administrator of his or her own personal Group. Groups may define roles and security parameters for the groups, and for their members individually. Groups may extend invitations for membership in the group, and may define and manage the membership process. Particular groups to be nested or linked to other groups in hierarchical structures; that is, the groups may be extensible. Different groups may define themselves as they wish, e.g., as for-profit enterprises, non-profits, clubs, associations, or the like.

The data and relationships conceptually depicted in FIG. 32 may be implemented within the extensible XML documents: Group, Entity, Role, Status, and Action, as now described in the next few Figures.

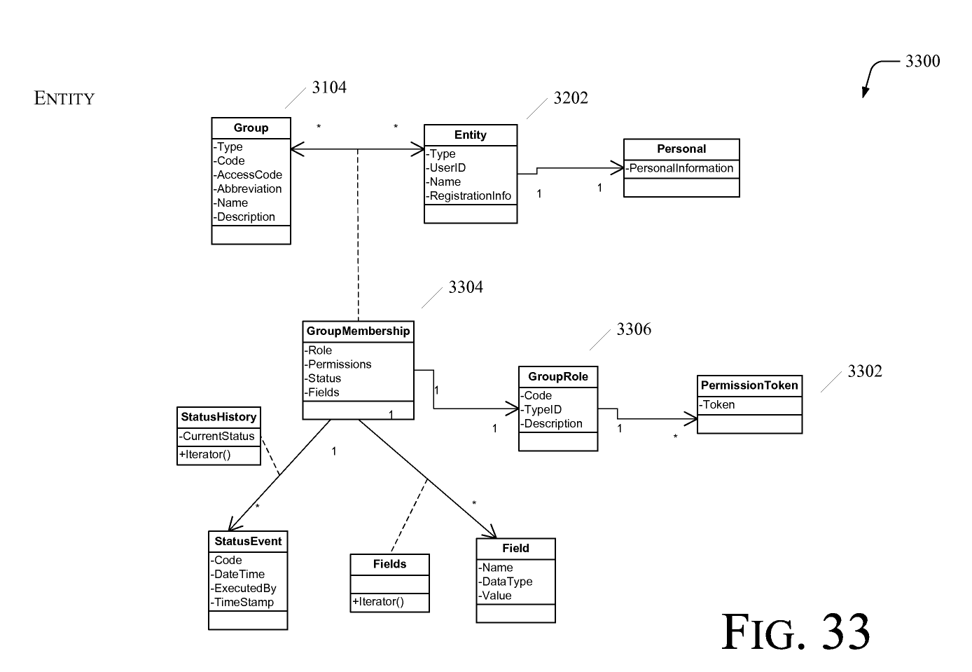

FIG. 33 shows further aspects of relationships 3300 between entities objects and other objects. FIG. 33 carries forward an example entity object at 3202, without limitation. An Entity within the referral management platform can represent an individual person, an organization, a company, to other suitable entity. An Entity object may have a relationship with one or more Groups, with FIG. 33 carrying forward an example group object at 3104. The Entity object 3202 may obtain its permission tokens (e.g., 3302) from the combination of its Group Membership (e.g., 3304) and Role (e.g., 3306) within the Group. The permission tokens for an Entity are attached to the process supporting the Entity, and allow the referral management platform to control the Entity's access to objects within the referral management system.

The data and relationships conceptually depicted in FIG. 33 may be implemented within the referral management platform XML documents: Group, Entity, Personal, Role, Status, and Action.

The referral management platform provides tools and techniques that provide representations of entities within the system, with examples of entities including individuals, organizations, machines or computer-based systems, companies or other business enterprises, government entities, and the like. An Entity may maintain a Personal store of information and to decide who, what, where, when, why and how pieces of that information can be accessed

Entities may use their corresponding Entity object representations to assume multiple roles or personae throughout the referral management system. For example, a given entity may adopt the persona of an individual in some groups or networks, but can also take the role of a corporate executive in other groups or networks. The referral management system may enable this entity to act in all these different roles through a single login name (e.g., as entity “Bob”).

An Entity's interaction in various roles may be discrete, as defined or described by the particular Group/Role combination under which an action is performed. An Entity's value may be ascertained by the particular Groups and Networks to which that Entity belongs. Thus, an Entity may increase its value within the system, and the system may provide data by which the entity may prove its value.

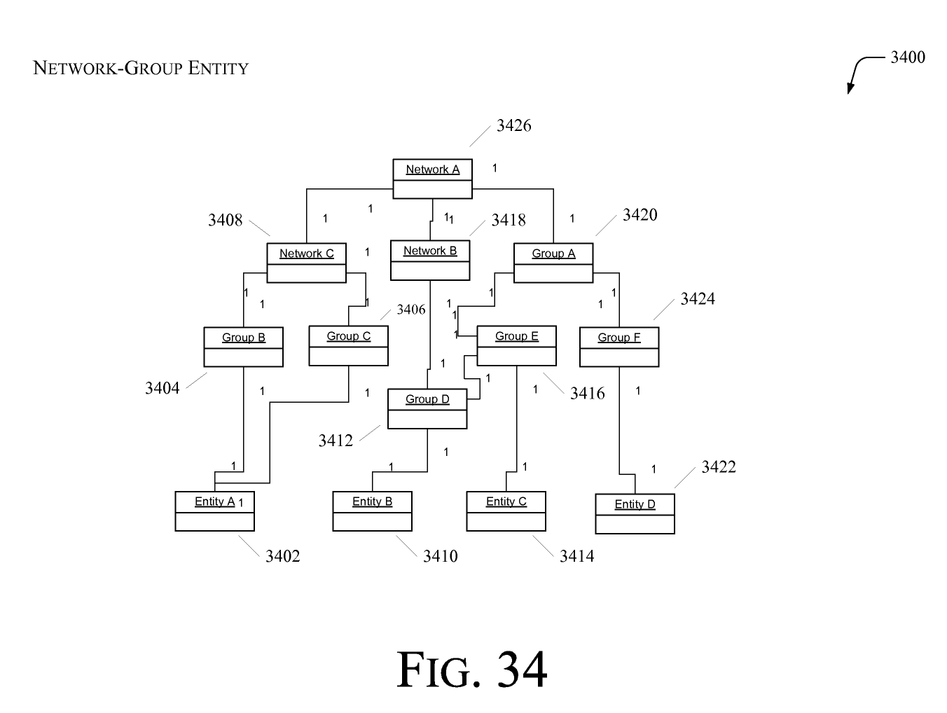

FIG. 34 shows examples of possible relationships 3400 between and among the Network, Group, and Entity objects. More specifically, FIG. 34 shows combinations and hierarchical relationships among Network, Group, and Entity objects. For example, an entity 3402 may be a member of two or more different groups, corresponding to group objects 3404 and 3406. These two group objects 3404 and 3406 may be members of a network 3408. An entity 3410 may be a member of a group 3412, while an entity 3414 may be a member of a group 3416. As shown in FIG. 34, the group 3412 may be a member of a network 3418, as well as the group 3416. The group 3416 may be a member of the group 3420. The entity 3422 may be a member of a group 3424, with the latter being a member of the group 3420, along with the members of the group 3416. Finally, the networks 3408 and 3418 and the group 3420 may all be members of a group 3426.

Within the hierarchal structure shown in FIG. 34, particular events and actions permitted to or between given entities may depend on a particular chain of relationships between those entities.

The referral management platform provides tools and techniques that allow combinations and hierarchal relationships between and among object representations of networks, groups, and entities. In addition, events and actions may be tied to particular chains of relationships.

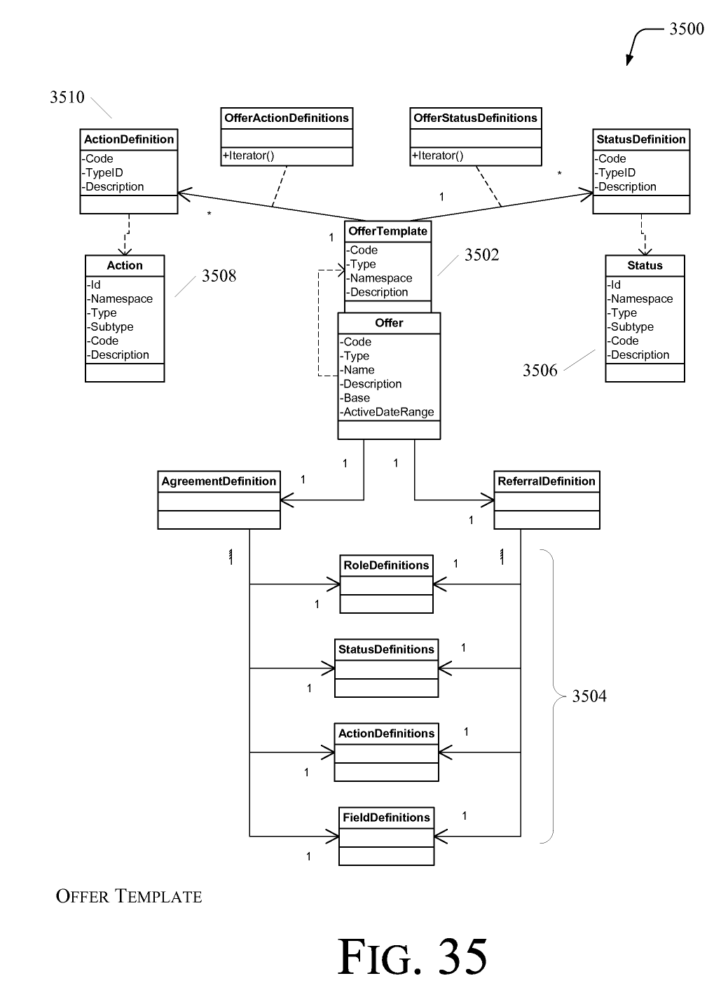

FIG. 35 shows object models 3500 for implementing Offer Templates as described herein. These offer templates within the referral management platform enable or facilitate Groups to create new referral offers that contain terms, workflows, etc. that are specific to a particular transaction type within their vertical industry. For example, an Offer Template may be created that would allow physician's offices to create specialist referral offers, based on related specialized templates. In turn, other physician's offices may then quickly use the Specialist Referral Offer Template as a basis for creating a referral relationship with a specialist. In some cases, if a given office created a specialized referral template, the referral management system may enable one office to create and present this specialized template to other offices for consideration and possible use. If these other offices choose to use the specialized template, the referral management system may enable the creating office to charge and collect a royalty or other fee for using the specialized template. This example may be generalized to other vertical industries, with physicians' offices given here as a non-limiting example.

The data and relationships shown in FIG. 35 may be implemented within the referral management platform with XML documents corresponding to an OfferTemplate (shown at 3502), Role definitions (shown at 3504, with any number of definitions possible in different implementations), Status objects (e.g., 3506), and Action objects (e.g., 3508).

The referral management platform provides tools and techniques that allow the creation of offer templates that contain valuable (and potentially proprietary) industry specific knowledge, as created by participants in the referral management system. The referral management platform may enable creation of agreement and referral related workflows to emulate real-life scenarios in different industries. In implementations, the platform may enable rapid, or viral, growth of referral networks, due to the ease with which groups can implement workflows that match their current industry practices. That is, these groups may continue using previously-developed practices, and need not redesign or reinvent their practices to participate in the referral management system.

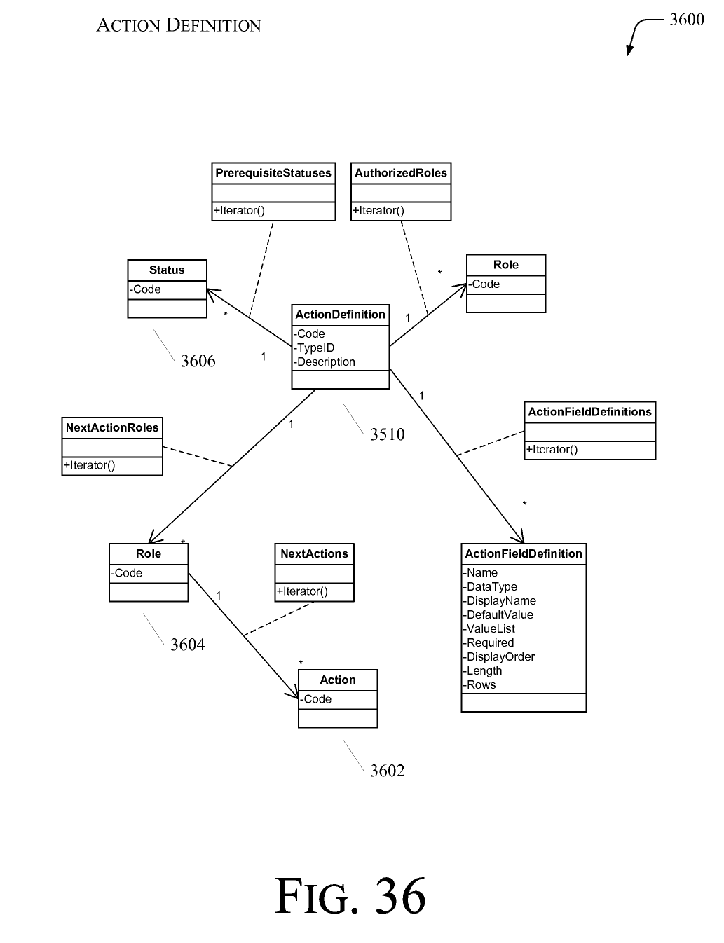

FIG. 35 shows an example of an Action Definition object at 3510. FIG. 36 provides additional details on these Action Definition objects.

FIG. 36 shows object arrangements 3600 for implementing action definitions. For convenience, but not limitation, FIG. 36 carries forward an example Action Definition 3510 from FIG. 35, and FIG. 36 provides further details relating to the Action Definition 3510. An Action Definition may be implemented within many types of objects in the referral management platform. For example, Groups, Offers, Relationship Templates, and other object types may contain sections where related Actions are defined. FIG. 36 illustrates how Actions may be implemented and interpreted by the referral management platform (e.g., by one or more software components operating as a workflow engine).

The data and relationships conceptually depicted in the Action Definition diagram may be implemented within suitable XML documents, with examples including: Action (e.g., 3602), Role (e.g., 3604), Status (e.g., 3606), and the particular object containing the Action Definition. This particular object may be, for example, an OfferTemplate, a RelationshipTemplate, Agreement, Offer, or the like.

The referral management platform provides tools and techniques for creating user definable actions, and for embedding these actions within object representations. These actions may be associated with rules that control who, what, when, and how given actions can be executed

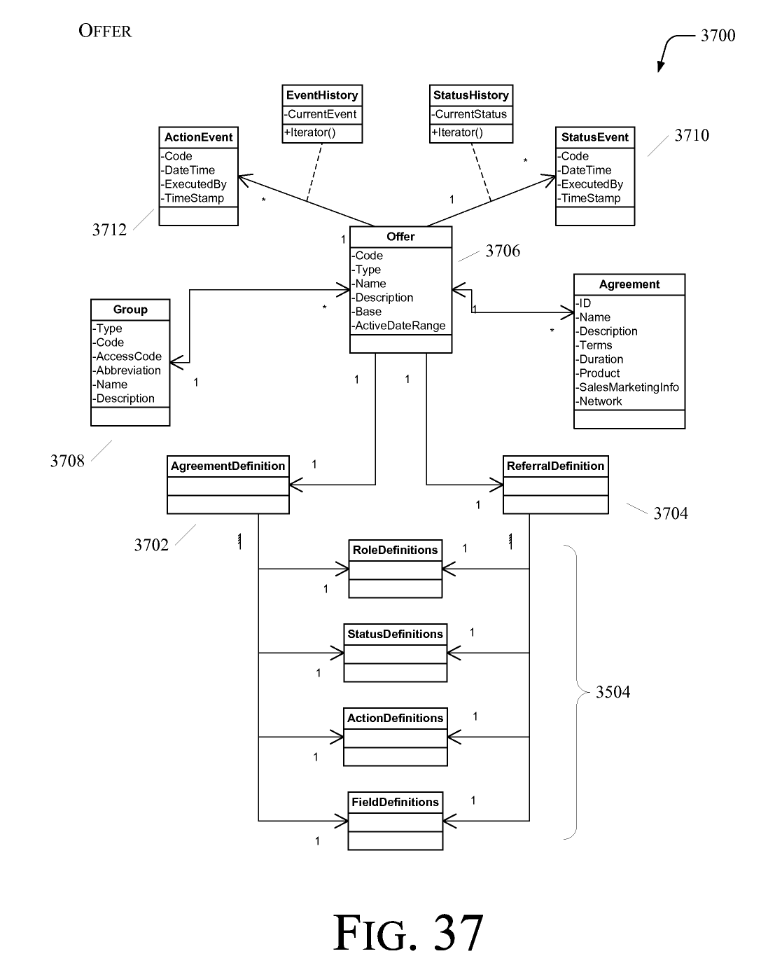

FIG. 37 shows aspects 3700 relating to object definitions for an offer, as distinguished from the offer template definitions shown in FIG. 35. An Offer within the referral management platform may enable a Group to create referral agreements, and then to manage referrals performed under these agreements with their customers and associates. Offers are created from supplied Offer Templates, and thus relate to the Offer Template from which they originated. In the example shown in FIG. 37, an Offer may include two main definition sections. An Agreement Definition section 3702 contains the elements for creating referral agreements with associates. A Referral Definition section 3704 contains the elements for creating and managing referrals. In example implementations, a given Offer (e.g., 3706) is owned and maintained by only one Group (e.g., 3708).

The data and relationships depicted in FIG. 37 may be implemented within the referral management platform as respective XML documents. For example, XML documents may implement one or more the following: an Offer (e.g., 3706), an Offer Template (as illustrated in FIG. 35), a Group (e.g., 3708), Role definitions (e.g., 3504), Status Events (e.g., 3710), and Action Events (e.g., 3712).

The referral management platform provides tools and techniques for cloning an existing offer template so that it meets specific guidelines set for individual groups. Groups may maintain and publish a set offers related to their ability to be customers, provide customers as sources, and/or provide products or services as suppliers. In addition, the groups may change offers over time, for example, to include different terms, workflows, compliance matters, or the like. Groups may also withdraw offer as they see fit.

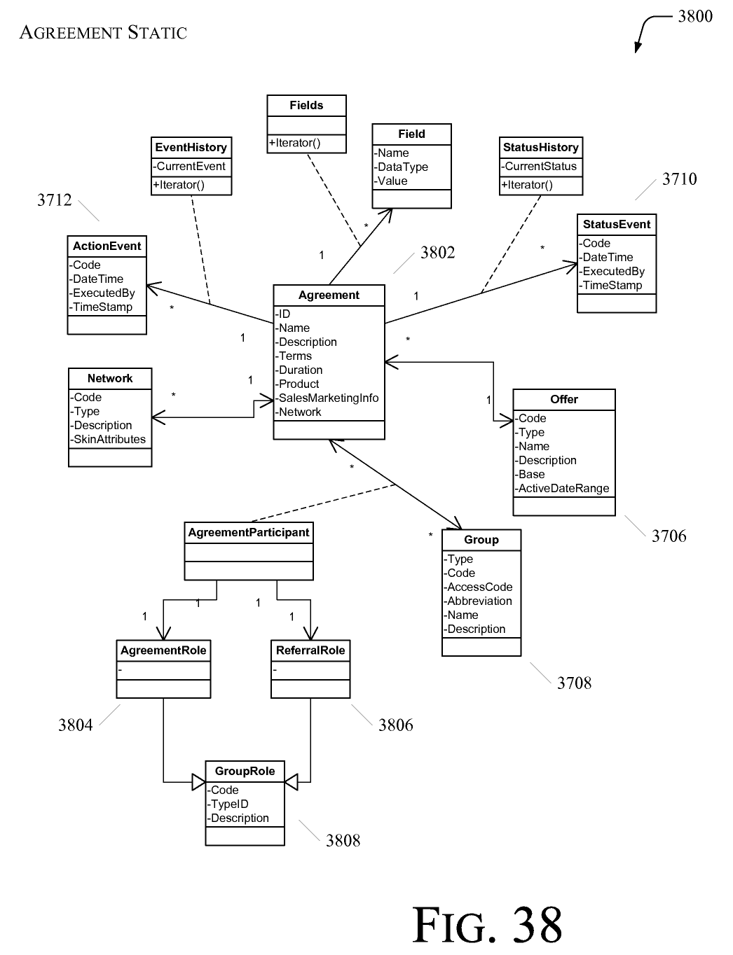

FIG. 38 illustrates aspects, shown at 3800, for an agreement static as described herein. The term “static” in the description refers to a class definition, as opposed to an object instance based on the class. A referral Agreement within the referral management platform represents an Agreement between two or more parties governing the issuance of a Referral, according to the terms contained in the associated Offer and Agreement. An Agreement may involve any two or more parties in the Referral triangle (i.e., Customer, Source, and Supplier). In some instances, groups may form Agreements with other Groups, as facilitated by the referral management system. Members of a Group may participate in an Agreement according to their roles within the Group. An Agreement is typically related to a single Offer.

The data and relationships conceptually depicted in FIG. 38 may be implemented within the referral management platform as XML documents. Examples may include at least one or more of an Agreement 3802, an Offer underlying the agreement (carried forward at 3706), a Group construct (carried forward at 3708), one or more Role elements (with examples including an agreement role 3804, a referral role 3806, and/or a role within a group 3808), Status events (carried forward at 3710), Action events (carried forward at 3712).

The referral management platform provides tools and techniques that provide for maintaining and negotiating agreements online with customers, sources, and suppliers. The platform may enable participants to generate Agreements based on combinations of predefined Offers and Offer Templates. The platform may further enable users to define their own participation roles within agreements, and tie these roles to the appropriate Agreements. The ease with which a Group may generate, edit, offer, and negotiate Agreements may contribute to rapid or viral growth of networks, in some implementations. In turn, the platform may tie or associate particular agreements to networks, and may tie or associate agreements to terms, product/service information, and sales/marketing information.

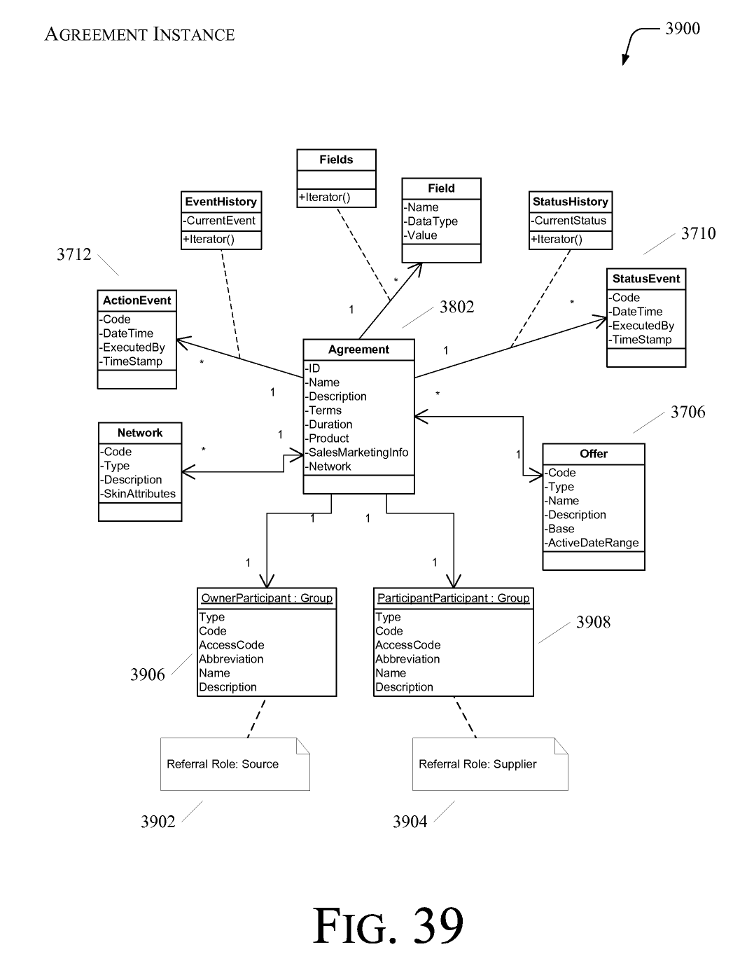

FIG. 39 shows object model 3900, which is an instance of an agreement, as described herein. FIG. 39 carries forward some reference numbers from previous drawings, in the interests of conciseness, but not to limit possible implementations. FIG. 39 depicts an example instance where an Agreement has been established between a Referral source (e.g., 3902) and a Referral supplier (3904). In this case, the party who originated the Agreement is considered to own the Agreement (as shown at 3906), and to act in the Referral source role (e.g., 3902). FIG. 39 shows other participants in the referral agreement at 3908, acting in a supplier role.

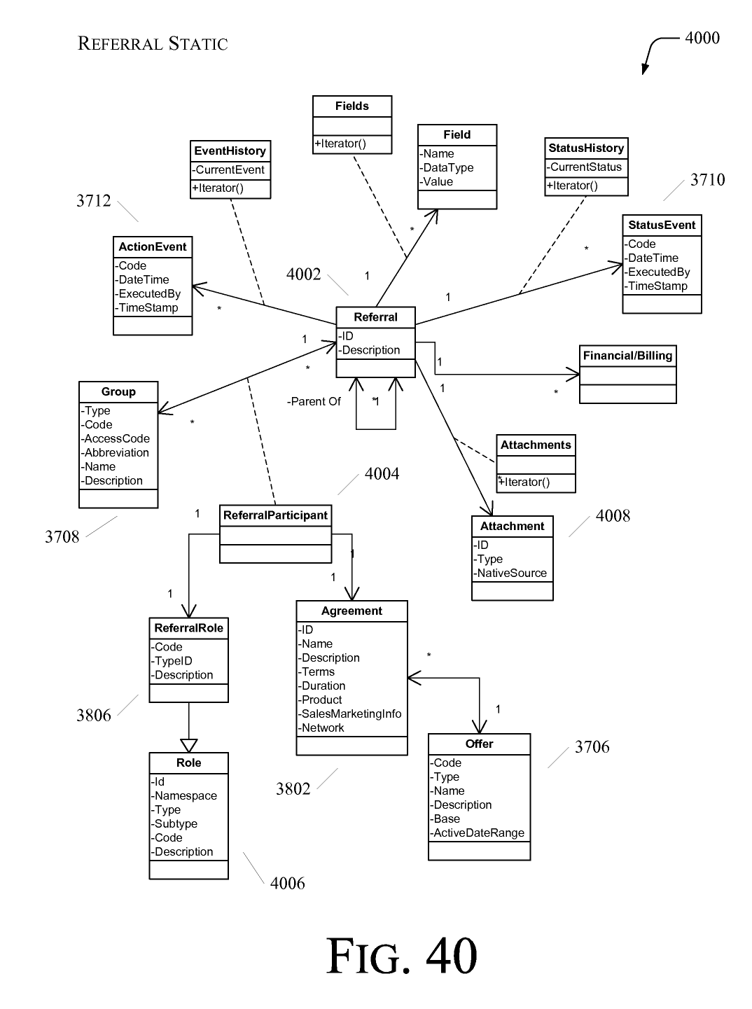

FIG. 40 shows object model 4000 of a referral static, which may provide a class definition for instantiating referral objects. A referral object 4002 may be associated with a group object (e.g., 3708), one or more status events (e.g., 3710), one or more action events (e.g., 3712), or any of the other example objects shown in FIG. 40.

The referral object 4002 may be associated with a referral participant object 4004, which represents a participant involved in the referral shown by the object 4002. The participant object may include a referral role object (e.g., 3806), an agreement object (e.g., 3802), and an offer object (e.g., 3706). In turn, the referral role object 3806 may include a role object 4006.

The referral object 4002 may be associated with one or more attachment objects 4008, which may be, for example, documents or other items associated with a referral scenario. These documents may be in any suitable native format.

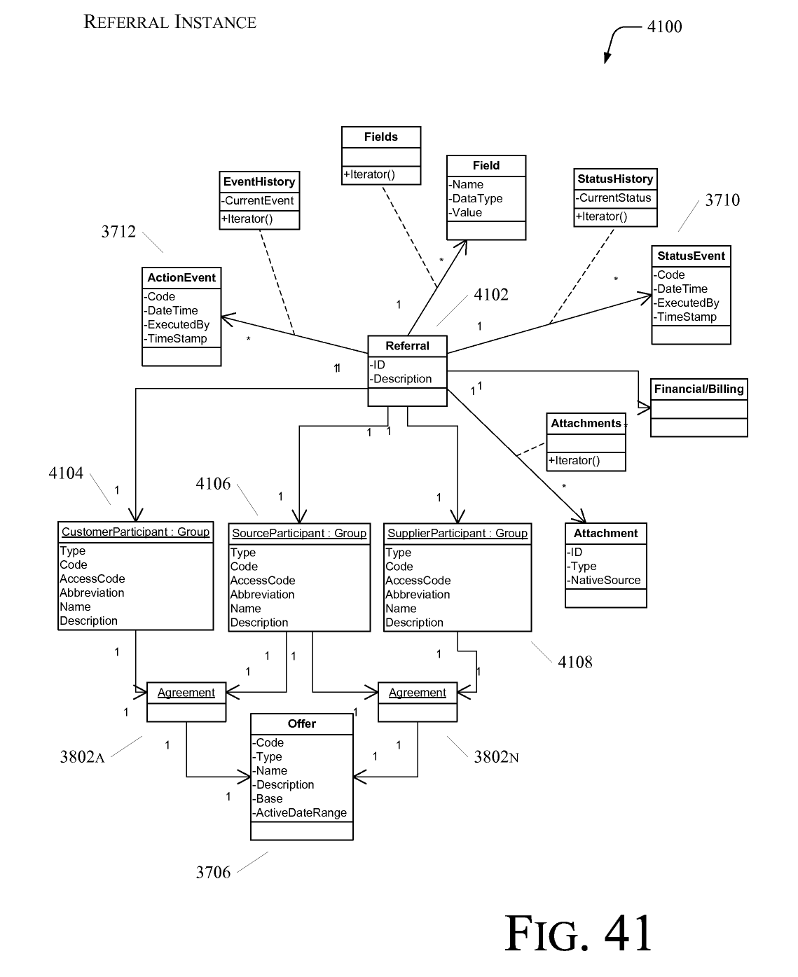

FIG. 41 an object model 4100 of an instance of a referral, as described herein. An example Referral (shown at 4102) in the referral management system may be created and managed based on the Agreements established among the Referral participants. FIG. 41 carries forward example agreement objects at 3802a and 3802n. FIG. 41 also shows at 4104 an example object corresponding to a customer participant in a given group, shows at 4106 a source participant in the given group, and shows at 4108 a supplier participant in the given group. In the example shown, the Agreements linked to a given Referral are based on a single Offer. Generally, a Referral may be linked to at least two Agreements. One agreement 3802a is between the Source and the Customer, referenced herein as a customer agreement or a source-customer agreement. Another agreement 3802n is between the Source and the Supplier, referenced herein as a referral agreement or a source-supplier agreement. The Referrals permission model, workflow, statuses, and related fields may all be based on the associated Offer object (e.g., 3706) and its related description and definition sections.

The data and relationships shown in FIG. 41 may be implemented within the referral management platform as XML documents, with example documents defining objects for Referrals (e.g., 4102), Agreements (e.g., 3802a and 3802n), Offers (e.g., 3706), Groups (e.g., 3708 in preceding drawings), Roles (e.g., 4006 in FIG. 40), Status (e.g., events 3710), and Actions (e.g., events 3712).

The referral management platform provides tools and techniques for linking referrals to agreements and offers, and for linking referrals to entities, groups, and networks. The platform may also maintain action and status history for particular referrals, and may chain referrals together in a tree or other hierarchical structure. The platform may link referrals to attachments that are stored in native format, and to link referrals to financial/billing information regarding the economic impact or result of the referral. Finally, the platform may link financial/billing information through the agreement to individual participants in the referral.

FIG. 41 shows an example instance of a Referral. The Offer associated with the referral defines who can do what with the Referral. For example, the Source role may “send” the Referral to the Supplier. The Supplier role may “reject” the Referral. The Customer role may be able to look at the Referral status, but not execute any Referral actions.

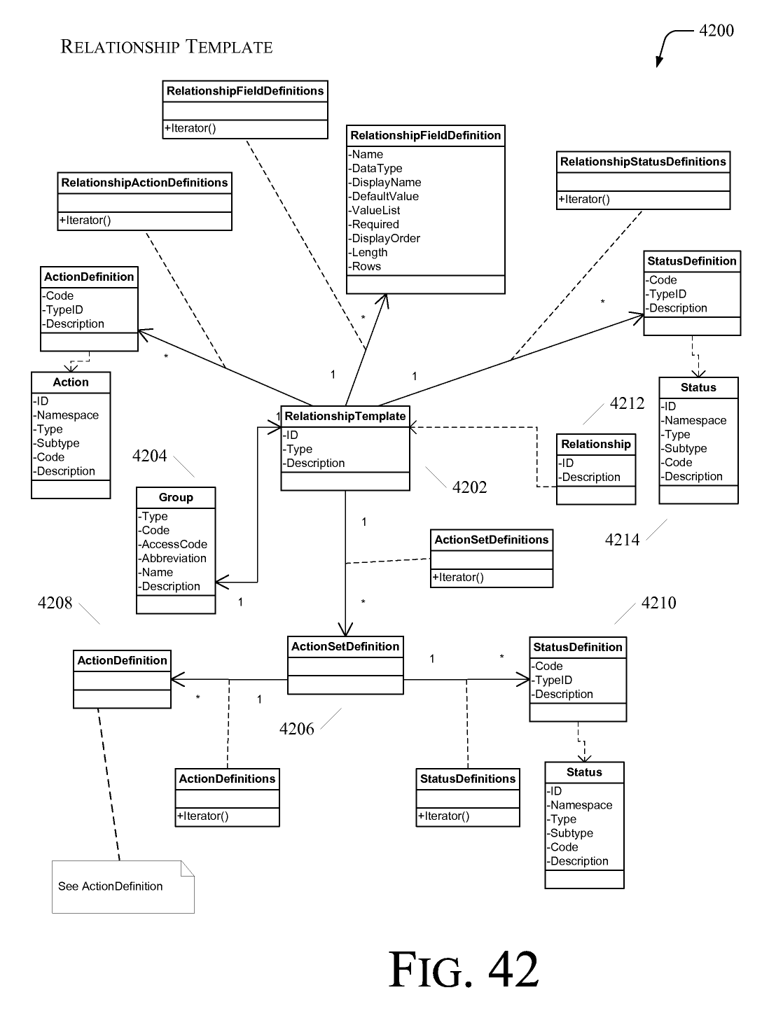

FIG. 42 shows object models 4200 related to a Relationship Template. FIG. 42 illustrates an example object for the relationship template at 4202. The relationship template within the referral management platform enables Groups to create and manage Relationships with customers and associates. For example, a given Group (e.g., 4204) may access a Relationship Template to help form Relationships with other parties in the same group, or in other groups. The Relationship Template may define the information and workflow that one Group seeks to maintain concerning its Relationship with another Group. In an example, assume that a Group A has a customer Group B, and that before Group A can do business with a member of Group B, the Group B member is to execute a non-disclosure agreement (NDA). In this example, the Relationship Template can be setup to help Group A track where each member of Group B is in the process of completing the NDA. The Relationship Template may use the concept of an Action Set 4206 to facilitate processes, such as the preceding NDA example. The Action set 4206 may include one or more objects that define actions, with FIG. 42 providing an example at 4208. Status definition objects 4210 may provide status of various actions.

The data and relationships conceptually depicted in FIG. 42 may be implemented within the referral management platform as XML documents, with examples including the RelationshipTemplate 4202, a Relationship object 4212, the Group object 4204, Role (which, as illustrated, may be embedded in the action and action set definitions), Status object 4214, Action definitions (e.g., 4206), and the like.

The referral management platform provides tools and techniques for creating relationship templates that contain valuable (and potentially proprietary) industry specific knowledge relevant to particular verticals. The relationship templates may define the data elements and workflow that are pertinent to a particular relationship (e.g., between customers, sources, or suppliers). The relationship templates may also define a security model for collecting and redistributing data, and may provide the ability to change over time the data that is collected. Additionally, the workflows used to collect this data may change over time.

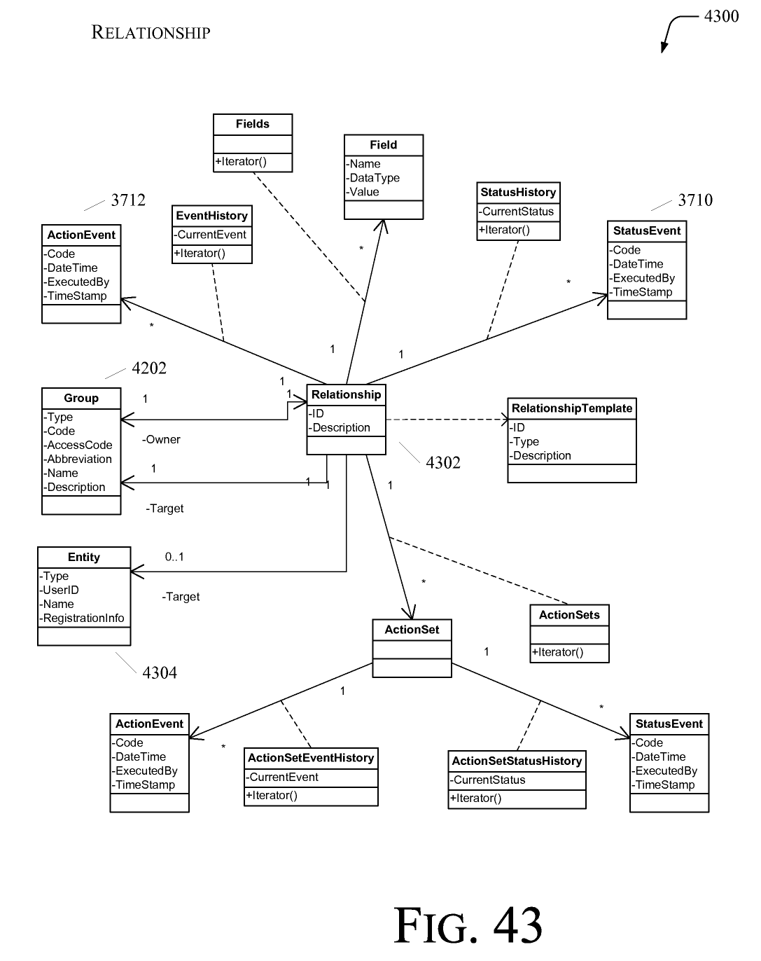

FIG. 43 shows object models 4300 for an instance of a relationship established between two or more parties, as supported by the referral management system described herein. A Relationship object, shown at 4302, within the referral management system may represent the characteristics that one Group considers important in their Relationship with another Group. So a first Group A (e.g., an auto repair shop) may have a Relationship with a member of another Group B, and under this relationship, may keep track of that member's auto make and model, mileage at last repair, and birth date. The Relationship object 4302 in the referral management system may facilitate managing the collection and maintenance of this information. In some cases, this Relationship data may be subject to privacy requirements, and in such cases, the referral management platform may meet and manage compliance with these requirements. For example, the first member of Group A may need authorization from the second member of Group B before release the make and model of the second member's auto to a 3rd party.

An Entity relationship in FIG. 43, as shown at 4304 may be included in at least some implementations, to represent scenarios in which a Relationship can be established between two Groups, or between a Group and individual members of another Group.

The data and relationships depicted in FIG. 43 may be implemented within the referral management platform as XML documents. Examples of such documents may implement the Relationship Template (carried forward at 4202), the Relationship 4302, a Group 4202, the Entity 4304, Role (which, as illustrated, may be embedded in the action and action set definitions), Status events (e.g., 3710), and Action events (e.g., 3712).

The referral management platform provides tools and techniques for creating relationships that contain valuable (and potentially proprietary) industry specific knowledge. Participants in the system may then use the collected information in a strategic manner. For example a source may collect some information from a customer about his preferences pertaining to a particular product, and be able to pass this information on to a potential supplier. Relationship data that is released to a third party may be tracked.

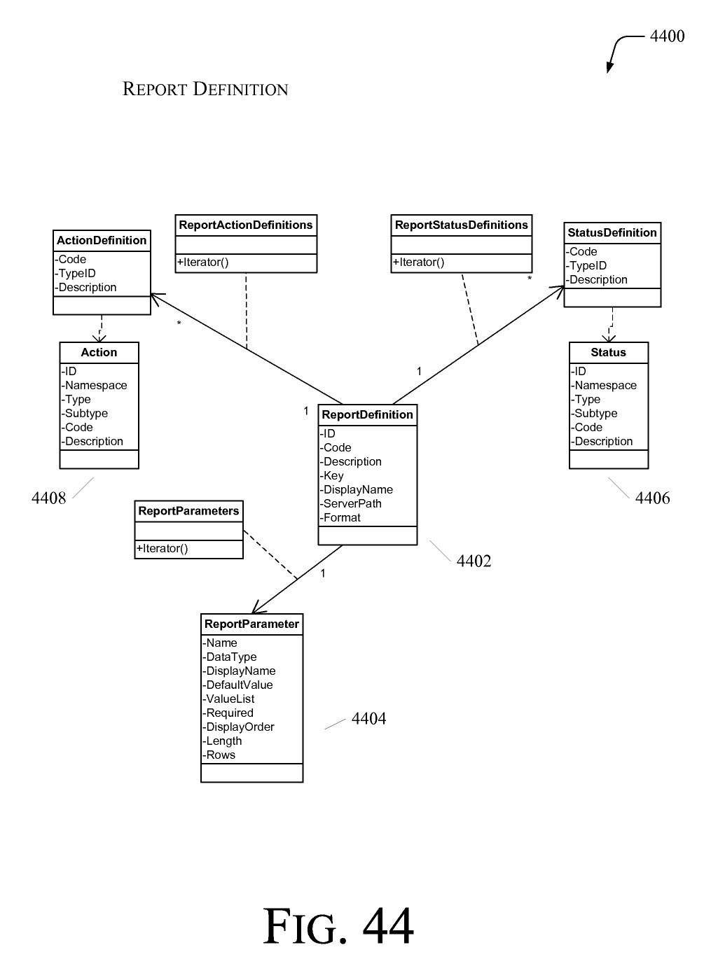

FIG. 44 shows aspects 4400 of report definition objects, with an example of such shown at 4402. A Report Definition in the referral management system describes a predefined report that is available to link to a Group. The Report Definition object 4402 may provide information to the referral management platform about where to find the report, how to execute it, and the parameters (e.g., 4404) for generating the report.

The data and relationships conceptually depicted in FIG. 44 may be implemented within the referral management platform as appropriate XML documents, with examples of such documents including, for example, the ReportDefinition object 4402, Status elements (e.g., 4406), Action elements (e.g., 4408), and the like.

The referral management platform provides tools and techniques for creating Generic Report Definitions. The platform may also enable users to define Report Actions, Report Parameters, and Status.

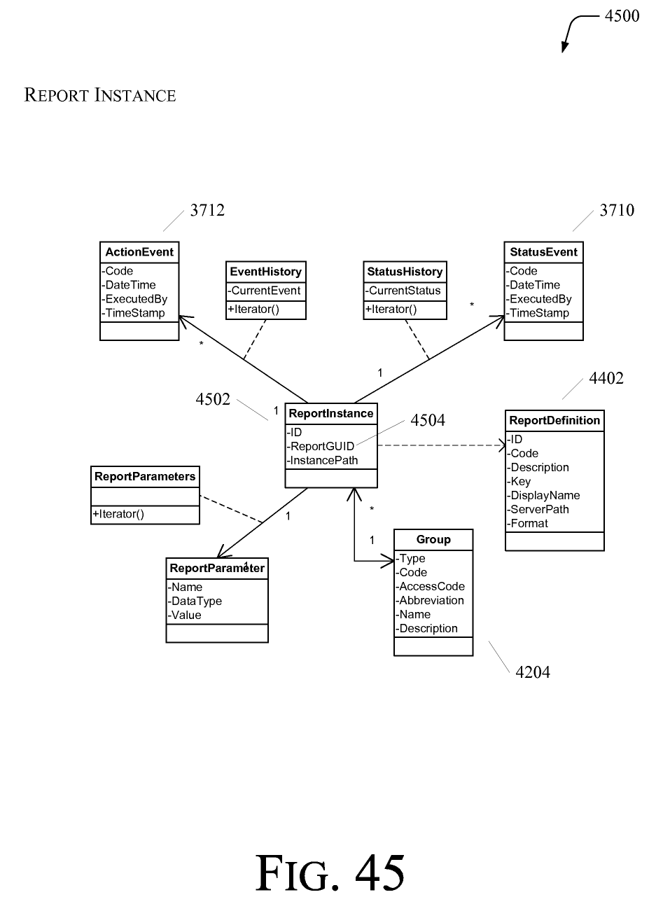

FIG. 45 shows aspects 4500 of object implementations of a report instance. FIG. 45 shows an example report instance at 4502. A Report Instance in the referral management system described herein may link a particular Report Definition (carried forward as 4402) to a Group (carried forward as 4204), and may define any security and access control constraints regarding that Group's ability to see referral management data. For example, a first Group

A may be allowed to view data related to a second Group B. The Report Instance may also maintain a report viewing history, arranged—for example—by date and user.

The Report Instance may define a reportGUID attribute 4504 that is used by a Report Generation Engine or service provided by the referral management system as an authorization check before allowing the Report Instance object 4502 to be generated. The Report Generation service may attempt a table join to match a report instance GUID with a GUID passed into the report generation service by a user attempting to generate a report. The service will not generate a report unless the join is successful.

The ability to acquire a Report Instance object may be controlled by a Universal Access Control Subsystem provided by the referral management platform. Once a Report Instance has been obtained, it is issued to the Engine, and the Engine validates the reportGUID. Depending on the validity of the reportGUID, the Engine either allows or denies Report execution.

The data and relationships depicted in FIG. 45 may be implemented within the referral management platform by suitable XML documents. Examples of such documents may include implementations of the ReportInstance object 5402, the ReportDefinition object 4402, the Group object 4204, Status events 3710, Action events 3712, and/or the like.

The referral management platform provides tools and techniques that tightly control access to referral and transaction data according to parameters defined by the owners of the data, and that facilitate tracking of accesses to such data.

### Business Method Aspects

The foregoing tools may enable the operation of various methods of performing business-related techniques. For example, the referral management platforms described herein may facilitate business methods that include establishing single respective agreements with different participants in the referral network, with these agreements enabling the participants to assume different roles in different referral scenarios (e.g., customer, supplier, source).

A given source may define a plurality of different groups for different types of customers. For example, the source may define respective groups for internal staff, outside vendors, prospective customers, current customers, or the like.

Participants in referrals may define themselves differently in different referral networks, based on the roles that they assume in these different networks. For example, a participant may be a customer in one scenario, a source in another scenario, and a supplier in yet another. In these examples, the way a participant defines itself as a customer (e.g., purchasing terms, buying requirements, or the like) may be fundamentally different than the way the participant defines itself as a supplier (e.g., marketing model, pricing, benefits, or the like). In addition, individuals may assume different roles in different scenarios, depending on the role played by their organizations in these scenarios. For example, a president might be a sales representative in a supplier relationship, but may also be an economic decision-maker in a customer relationship.

The platform may enable users to define their own roles with respect to referral workflow processes. For example, roles in a referral workflow process might include “Primary Contact,” “Account Manager,” or the like. In addition, the users may customize referral models based on actual data scenarios. In some cases, trained analysts or other non-technical users, rather than programmers, may configure the platform, modifying underlying structures of agreements, referrals, user information, or the like.

The platform may present different appearance profiles, based on the marketing focus of the referral network. For instance, color, user interface designs, marketing materials, and/or other visual display elements may mirror the particular market within which the network exists.

The platform may store and manage artifacts to be attached to one or more workflow processes. For example, a referral process may specify that a consent form is to accompany the referral. The platform may allow a process designer to create an XML document definition, so that the actual consent form can be stored in native format with the associated referral.

The platform may enable users to enter a referral in at most four actions, with these actions including choosing a referral agreement, specifying the customer to be referred, indicating the person making the referral, and adding qualifying data to the referral. The platform may support entry of referral-related data via manual input, voice input via Interactive Voice Response (IVR) systems, or via a cell phone or Personal Digital Assistant (PDA).

In some implementations, the platform may emulate the legal workflows performed by a participant in a referral scenario. This process may include forwarding the Agreement to outside legal counsel for approval, or internal staff. In addition, the Agreement may contain standard language approved by the Participant's company, such as standard agreement forms or terms that the online Agreement follows. The platform may enable notification of referral status using different methods, such as Instant Messaging (IM), phone calls, emails, automatic phone outdialing, “one-click” conference calling, or the like. The platform may also provide secure mechanisms that enable the other participants to respond to these notifications.

The platform may provide automated processes to closeout referrals, based on various criteria applicable to the referral. Examples of such criteria may include such as number of days pending, various status codes, likelihood of successful completion, or the like.

The referral management platform may provide a set of pre-configured connectors that facilitate communications with different existing data and software systems. The ability for both the referral management platform and other providers to develop these “connectors” allows users of these systems to cross boundaries between themselves and their business partners seamlessly.

The platform may enable participants in referral networks to act as sponsors, and may enable such sponsors to advertise items within the referral system for viewing and interaction by other participants. In some instances, the sponsors may pay a fixed or variable fee in exchange for acting as sponsors, and may receive compensation in terms of new business, a share of network service fees, or other consideration. Generally, the terms compensation or value may refer to pecuniary or non-pecuniary subject matter. Network sponsors may view performance characteristics of the referral networks as feedback, consistently with confidentiality provisions in terms of use agreement applicable to the referral networks.

The platform may provide automated mechanisms that enable the sponsors to identify and recruit new participants for referral networks associated with the sponsors, enabling the sponsors to send initial materials to the recruits. The platform may also manage workflows associated with bringing the recruits into the sponsor's referral network.

The platform may perform billing services integrated across multiple participants in a variety of different referral networks. The billing services may invoice, manage, and collect funds for the referral networks. The billing services may provide cross-network transaction capability that enables participants to owe, or be owed, referral fees to, or from, other participants in multiple referral networks.

The platform may enable the participants to manage tax reporting relating to transactions performed with the referral networks. The platform may also provide mechanisms that enable the participants to comply with laws or regulations applicable to transactions performed with the referral networks. For example, the platform may track enforce mandates, such as possessing a valid broker's license to collect fees associated with a real estate transaction.

The platform may enable development of relationship accounts that store information about customer participation in referral networks and related transactions. The platform may enable owners of the relationship accounts to designate at least part of the relationship accounts as private information that is not shared with anyone besides the owners. The platform may also enable the owners of the relationship accounts to designate at least part of the relationship accounts as public information that may be shared beyond the owners.

The platform may provide mechanisms by which participants in the referral networks may designate referral workflows as proprietary, and by which the participants may collect a fee from other participants in exchange for permitting the other participants to use the proprietary workflows. These fees may provide a type of royalty, within the context of the referral management platform.

The platform may enable administrator participants to define multiple other users within and outside a given organization in bulk as new participants, and may provide mechanisms for automatically contacting the other users for sign-up operations and for training.

The platform may provide automated mechanisms to manage agreements established within the referral networks, and may notify respective administrators associated with the agreements of upcoming action items related to the agreements.

The platform may enable development of referral agreements that include standard legal language governing relationships between the parties to the agreements. The platform may enable incorporation into the referral agreements of standard agreement terms provided by participant organizations. The referral management platform may provide mechanisms for emulating the approval processes that govern formation of agreements within participant organizations. For example, if under company policy a given agreement is to be approved by a vice president, then the referral management platform may define a workflow that routes the agreement to an appropriate vice president.

The platform enables referral agreements to be established in a first language, and allows a translation of the referral agreement into a second language to be posted for use by participants who operate in the second language.

### CONCLUSION

Although the systems and methods have been described in language specific to structural features and/or methodological acts, it is to be understood that the system and method defined in the appended claims is not necessarily limited to the specific features or acts described. Rather, the specific features and acts are disclosed as exemplary forms of implementing the claimed system and method.

In addition, regarding certain data and process flow diagrams described and illustrated herein, it is noted that the processes and sub-processes depicted therein may be performed in orders other than those illustrated without departing from the spirit and scope of the description herein. Also, while these data and process flows are described in connection with certain components herein, it is noted that these data and process flows could be performed with other components without departing from the spirit and scope of the description herein.

What is claimed:

1. An online referral management system, comprising:
a repository to store offer templates and active agreements;
a offer creator to:
select one of the offer templates from the repository,
select a recipient for the selected offer template,
customize the selected offer template in accordance with a business rationale, and
transmit the customized offer template; and
an offer recipient to:
receive the customized offer template,
negotiate terms relevant to the customized offer template with the offer creator, and
transmit an approved version of the offer template for storage as one of the active agreements in the repository.

2. An online referral management system according to claim 1, wherein the offer creator is a supplier of services and the offer recipient is a source of referred customers for the supplier.

3. An online referral management system according to claim 1, wherein the offer creator is a source of customers and the offer recipient is a supplier of products.

4. An online referral management system according to claim 1, wherein the repository is to store at least one offer template that is linked to one of the active agreements.

5. An online referral management system according to claim 1, wherein the offer creator is to select the recipient for the selected offer template from among subscribers to the referral management system.

6. An online referral management system according to claim 1, wherein the offer creator and the offer recipient belong to separate referral networks.

7. An online referral management system according to claim 1, wherein the offer creator is to further:
privately store the approved version of the offer template as an active agreement,
access the active agreement for a subsequent referral agreement with the offer recipient, wherein the active agreement is linked to any one of the offer templates stored in the repository.

8. A computer-readable medium to store instructions that, when executed, cause one or more processors to:
access a draft referral agreement from a repository;
select a recipient for the draft referral agreement;
customize the draft referral agreement to the selected recipient;
transmit the draft referral agreement;
revise the draft referral agreement based on feedback thereto;
implement the referral agreement upon receiving approval of a finalized version of the referral agreement; and
link the implemented referral agreement to the draft referral agreement in the repository.

9. A computer-readable medium according to claim 8, wherein the stored instructions, when executed, are run on top of a referral management system platform.

10. A computer-readable medium according to claim 8, wherein the instructions to access the draft referral agreement cause the one or more processors to access an offer template that may be applied generally to a line of business.

11. A computer-readable medium according to claim 8, wherein the instructions to customize the draft agreement include further instructions that, when executed, cause the one more processors to customize the draft referral agreement accessed from the repository to reflect specific business needs of the selected recipient.

12. A computer-readable medium according to claim 8, wherein the instructions to implement the referral agreement cause the one or more processors to store the finalized version of the referral agreement in the repository.

13. A computer-readable medium according to claim 8, wherein the instructions to implement the referral agreement cause the one or more processors to store the finalized version of the referral agreement privately.

14. A computer-readable medium according to claim 8, wherein the recipient for the draft referral agreement is a source of referred customers for a supplier of services.

15. A computer-readable medium according to claim 8, wherein the recipient for the draft referral agreement is a supplier of products for a source of customers.

16. A computer-readable medium to store instructions that, when executed, cause one or more processors to:
receive an indication of a referral request;
associate a requestor of the referral request to a referral management system;
customize a requestor-appropriate referral agreement; and
transmit the requestor-appropriate referral agreement to a referred-to-entity.

17. A computer-readable medium according to claim 16, wherein the stored instructions, when executed, are run on top of a referral management system platform.

18. A computer-readable medium according to claim 16, wherein the instructions to associate the requestor of the referral request to the referral management system, when executed, further cause the one or more processors to search a database of known partners within a known referral network based on the referral request.

19. A computer-readable medium according to claim 16, wherein the instructions to associate the requestor of the referral request to the referral management system, when executed, further cause the one or more processors to search a database of potential partners that participate in a different referral network.

20. A computer-readable medium according to claim 16, wherein the requestor-appropriate referral agreement is at least a second referral agreement stemming from an original referral offer.
